(19) United States
(12) Patent Application Publication
(10) Pub. No.: US 2010/0035753 A1
(43) Pub. Date: Feb. 11, 2010

(54) Fungicidal Mixtures Comprising Substituted 1-methylpyrazol-4-ylcarboxanilides

(75) Inventors: Jochen Dietz, Karlsruhe (DE); Siegfried Strathmann, Limburgerhof (DE); Michael Vonend, Bad Durkheim (DE); Egon Haden, Ludwigshafen (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/525,591

(22) PCT Filed: Feb. 4, 2008
(86) PCT No.: PCT/EP2008/051331

§ 371 Date: Aug. 3, 2009

(30) Foreign Application Priority Data
Feb. 5, 2007 (EP) 07101758.6

(51) Int. Cl. A01N 25/26; A01N 43/653; A01N 43/40; A01P 3/00

(52) U.S. Cl. 504/100; 514/383; 514/317; 514/315

(57) ABSTRACT

Fungicidal mixtures, comprising as active components: 1) at least one 1-methylpyrazol-4-ylcarboxanilide of the formula (I) where X=hydrogen or fluorine, R¹=C₁-C₄-alkyl or C₁-C₄-haloalkyl, R²=hydrogen or halogen, R³=hydrogen, cyano, nitro, halogen, C₁-C₄-alkyl, C₁-C₄-haloalkyl, C₁-C₄-alkoxy, C₁-C₄-haloalkoxy or C₁-C₄-alkylthio, R⁴ and R⁵=independently of one another hydrogen, cyano, nitro, halogen, C₁-C₄-alkyl, C₁-C₄-haloalkyl, C₁-C₄-alkoxy, C₁-C₄-haloalkoxy, C₁-C₄-alkylthio, —CH═N—OR⁶ or —C(CH₃)═N—OR⁶, where R⁶ is hydrogen, methyl or ethyl; and 2) at least one active compound II, selected from the active compound groups A) to G): A) azoles; B) strobilurins; C) carboxamides; D) heterocyclic compounds; E) carbamates; F) other fungicides; G) plant growth regulators; in a synergistically effective amount, methods for controlling harmful fungi using mixtures of at least one compound I and at least one active compound II, the use of a compound I or compounds I with active compounds II for preparing such mixtures, and also compositions and seed comprising such mixtures.

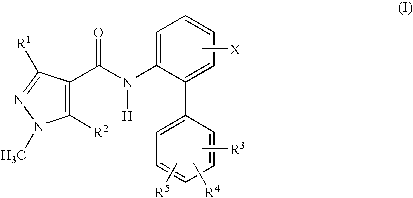

The present invention relates to fungicidal mixtures comprising, as active components,
1) at least one 1-methylpyrazol-4-ylcarboxanilides of the formula I

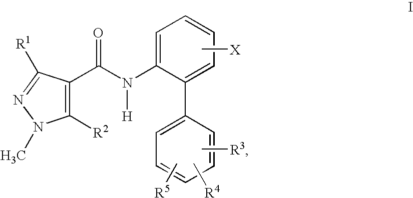

in which the substituents are as defined below:
X is hydrogen or fluorine;
R¹ is C₁-C₄-alkyl or C₁-C₄-haloalkyl;
R² is hydrogen or halogen;
R³ is hydrogen, cyano, nitro, halogen, C₁-C₄-alkyl, C₁-C₄-haloalkyl, C₁-C₄-alkoxy, C₁-C₄-haloalkoxy or C₁-C₄-alkylthio;
R⁴ and R⁵ independently of one another are hydrogen, cyano, nitro, halogen, C₁-C₄-alkyl, C₁-C₄-haloalkyl, C₁-C₄-alkoxy, C₁-C₄-haloalkoxy, C₁-C₄-alkylthio, —CH═N—OR⁶ or —C(CH₃)═N—OR⁶, where R⁶ is hydrogen, methyl or ethyl;
and
2) at least one active compound II, selected from the active compound groups A) to G):
   A) azoles selected from the group consisting of azaconazole, diniconazole-M, oxpoconazol, paclobutrazol, uniconazol, 1-(4-chloro-phenyl)-2-([1,2,4]triazol-1-yl)-cycloheptanol and imazalil-sulfphate;
   B) strobilurins selected from the group consisting of 2-(2-(6-(3-chloro-2-methyl-phenoxy)-5-fluoro-pyrimid in-4-yloxy)-phenyl)-2-methoxyimino-N-methyl-acetamide and 3-methoxy-2-(2-(N-(4-methoxy-phenyl)-cyclopropane-carboximidoylsulfanylmethyl)-phenyl)-acrylic acid methyl ester;
   C) carboxamides selected from the group consisting of benalaxyl-M, 2-amino-4-methyl-thiazole-5-carboxylic acid anilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxylic acid amide, N-(4′-chloro-3′,5-difluoro-biphenyl-2-yl)-3-difluoromethyl-1-methyl-1H-pyrazole-4-carboxylic acid amide, N-(4′-chloro-3′,5-difluoro-biphenyl-2-yl)-3-trifluoromethyl-1-methyl-1H-pyrazole-4-carboxylic acid amide, N-(3′,4′-dichloro-5-fluoro-biphenyl-2-yl)-3-trifluoromethyl-1-methyl-1H-pyrazole-4-carboxylic acid amide, N-(3′,5-difluoro-4′-methyl-biphenyl-2-yl)-3-difluoromethyl-1-methyl-1H-pyrazole-4-carboxylic acid amide, N-(3′,5-difluoro-4′-methyl-biphenyl-2-yl)-3-trifluoromethyl-1-methyl-1H-pyrazole-4-carboxylic acid amide, N-(cis-2-bicyclopropyl-2-yl-phenyl)-3-di-fluoromethyl-1-methyl-1H-pyrazole-4-carboxylic acid amide, N-(trans-2-bi-cyclopropyl-2-yl-phenyl)-3-difluoromethyl-1-methyl-1H-pyrazole-4-carboxylic acid amide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxylic acid amide, isotianil and 3-(difluoromethyl)-1-methyl-N-[1,2,3,4-tetrahydro-9-(1-methylethyl)-1,4-methano-naphthalen-5-yl]-1H-pyrazole-4-carboxamide of the following formula:

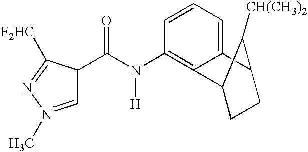

D) heterocyclic compounds selected from the group consisting of 2,3,5,6-tetra-chloro-4-methanesulfonyl-pyridine, 3,4,5-trichloropyridine-2,6-di-carbonitrile, N-(1-(5-bromo-3-chloro-pyridin-2-yl)-ethyl)-2,4-dichloronicotinamide, N-[(5-bromo-3-chloro-pyridin-2-yl)-methyl]-2,4-dichloro-nicotinamide, diflumetorim, nitrapyrin, dodemorph-acetate, fluoroimid, blasticidin-S, chinomethionat, de-bacarb, difenzoquat, difenzoquat-methylsulphat, oxolinic acid, piperalin, 3-[5-(4-chloro-phenyl)-2,3-dimethyl-isoxazolidin-3-yl]-pyridine

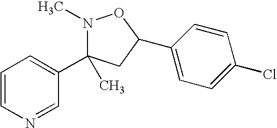

and 5-amino-2-iso-propyl-4-ortho-tolyl-pyrazol-3-on-1-thiocarboxylic acid allyl ester

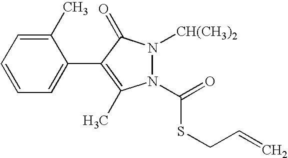

E) carbamates selected from the group consisting of methasulphocarb, pyriben-carb and propamocarb hydrochlorid;
F) other fungicides selected from the group consisting of dodine free base, guazatine-acetate, iminoctadine-triacetate, iminoctadine-tris(albesilate), kasugamycin-hydrochlorid-hydrat, dichlorophen, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxin-copper, N-(cyclopropyl-methoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamid ine, N′-(2-methyl-5-trifluormethyl-4-(3-trimethylsilanyl-propoxy)-phenyl)-N-ethyl-N-methyl formamidine and N′-(5-difluormethyl-2-methyl-4-(3-trimethylsilanyl-propoxy)-phenyl)-N-ethyl-N-methyl formamidine;
G) plant growth regulators selected from the group consisting of clofibric acid, 4-CPA (4-chlorophenoxyacetic acid), 2,4-D, 2,4-DB, 2,4-DEP, dichlorprop, fenoprop, IAA (indole-3-acetic acid), IBA (4-indol-3-ylbutyric acid), naphthaleneacetamide, α-naphthaleneacetic acid, 1-naphthol, naphthoxyacetic acid, potassium naphthenate, sodium naphthenate, 2,4,5-T, 2iP (N-(3-methylbut-2-enyl)-1H-purin-6-amine), 6-benzylaminopurine (6-BA), 2,6-dimethylpuridine (N-oxide-2,6-lultidine), benzyladenine, kinetin, zeatin, calcium cyanamide, dimethipin, endothal, ethephon, merphos, metoxuron, pentachlorophenol and its salts, thidiazuron, tribufos, aviglycine, 1-methylcyclopropene, ACC (1-aminocyclopropanecarboxylic acid), etacelasil, ethephon, glyoxime, gibberellins, gibberellic acid, abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham, 2,3,5-tri-iodobenzoic acid, chlorfluren, chlorflurenol, dichlorflurenol, flurenol, chlormequat, daminozide, flurprimidol, mefluidide, paclobutrazol, tetcyclacis, uniconazole, brassinolide, forchlorfenuron, hymexazol, amidochlor, benzofluor, buminafos, carvone, ciobutide, clofencet, cloxyfonac, cyanamide, cyclanilide, cycloheximide, cyprosulfamide, epocholeone, ethychlozate, ethylene, fenridazon, fluprimidol, heptopargil, holosulf, inabenfide, karetazan, lead arsenate, methasulfocarb, prohexadione (prohexadione calcium), pydanon, sintofen, triapenthenol and trinexapac (trinexapac-ethyl);
   in a synergistically effective amount.

Moreover, the invention relates to a method for controlling harmful fungi using a mixture of at least one compound I and at least one of the active compounds II, to the use of the compound(s) I with active compound(s) II for preparing such mixtures, and also to compositions and seed comprising such mixtures.

The 1-methylpyrazol-4-ylcarboxanilides of the formula I, referred to above as component 1), their preparation and their action against harmful fungi are known from the literature (cf., for example, EP-A 545 099, EP-A 589 301, WO 99/09013 and WO 2003/70705), or they can be prepared in the manner described therein.

However, the known 1-methylpyrazol-4-ylcarboxanilides of the formula I are, in particular at low application rates, not entirely satisfactory.

The active compounds II mentioned above as component 2), their preparation and their action against harmful fungi are generally known (cf., for example, http://www.alanwood.net/pesticides/index_cn_frame.html); they are commercially available.

It is an object of the present invention, with a view to reducing the application rates and broadening the activity spectrum of the active compounds I and II, to provide mixtures which, at a reduced total amount of active compounds applied, have improved activity against harmful fungi, in particular for certain indications.

We have accordingly found that this object is achieved by the mixtures, defined at the outset, of the active compounds I and II. Moreover, we have found that simultaneous, that is joint or separate, application of at least one compound I and at least one of the active compounds II or successive application of the compound(s) I and at least one of the active compounds II allows better control of harmful fungi than is possible with the individual compounds alone (synergistic mixtures).

The compounds I can be used as synergists for a large number of different active compounds II. By simultaneous, that is joint or separate, application of compound(s) I with at least one active compound II, the fungicidal activity is increased in a superadditive manner.

The compounds I can be present in different crystal modifications, which may differ in biological activity.

In the formula I, halogen is fluorine, chlorine, bromine or iodine, preferably fluorine or chlorine;

C₁-C₄-alkyl is methyl, ethyl, n-propyl, 1-methylethyl, n-butyl, 1-methylpropyl, 2-methylpropyl or 1,1-dimethylethyl, preferably methyl or ethyl;

C₁-C₄-haloalkyl is a partially or fully halogenated C₁-C₄-alkyl radical, where the halogen atom(s) is/are in particular fluorine, chlorine and/or bromine, i.e., for example, chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, heptafluoropropyl or nonafluorobutyl, in particular halomethyl, with particular preference CH₂—Cl, CH(Cl)₂, CH₂—F, CHF₂, CF₃, CHFCl, CF₂Cl or CF(Cl)₂, in particular CHF₂ or CF₃;

C₁-C₄-alkoxy is OCH₃, OC₂H₅, OCH₂—C₂H₅, OCH(CH₃)₂, n-butoxy, OCH(CH₃)—C₂H₅, OCH₂—CH(CH₃)₂ or OC(CH₃)₃, preferably OCH₃ or OC₂H₅;

C₁-C₄-haloalkoxy is a partially or fully halogenated C₁-C₄-alkoxy radical, where the halogen atom(s) is/are in particular fluorine, chlorine and/or bromine, i.e., for example, chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, heptafluoropropoxy or nonafluorobutoxy, in particular halomethoxy, particularly preferably OCH₂-Cl, OCH(Cl)₂, OCH₂—F, OCH(F)₂, OCF₃, OCHFCl, OCF₂Cl or OCF(Cl)₂;

C₁-C₄-alkylthio is SCH₃, SC₂H₅, SCH₂—C₂H₅, SCH(CH₃)₂, n-butylthio, SCH(CH₃)—C₂H₅, SCH₂—CH(CH₃)₂ or SC(CH₃)₃, preferably SCH₃ or SC₂H₅.

Preferred 1-methylpyrazol-4-ylcarboxanilides I are, on the one hand, those in which X is hydrogen.

On the other hand, preferred compounds I are those in which X is fluorine.

For the mixtures according to the invention, preference is given to compounds of the formula I in which R¹ is methyl or halomethyl, in particular CH₃, CHF₂, CH₂F, CF₃, CHFCl or CF₂Cl.

Preference is furthermore given to compounds I in which R² is hydrogen, fluorine or chlorine, in particular hydrogen.

Preference is furthermore given to those compounds I in which X is hydrogen and R³ is halogen, C₁-C₄-alkyl, C₁-C₄-haloalkyl, C₁-C₄-alkoxy, C₁-C₄-haloalkoxy or C₁-C₄-alkylthio, preferably halogen, methyl, halomethyl, methoxy, halomethoxy or methylthio, in particular F, Cl, CH₃, CF₃, OCH₃, OCHF₂, OCF₃ or SCH₃, particularly preferably fluorine.

Preference is furthermore given to those compounds I in which X is fluorine and R³ is hydrogen.

Moreover, preference is given to those compounds I in which R⁴ is halogen, in particular fluorine.

Preference is furthermore given to those compounds I in which R⁵ is halogen, in particular fluorine.

Particular preference is given to the compounds I, listed in Table 1 below, in which X is hydrogen.

TABLE 1

| Compound | R¹ | R² | R³ | R⁴ | R⁵ |
|---|---|---|---|---|---|
| No. 1 | CH₃ | H | 2-F | 3-F | 4-F |
| No. 2 | CH₃ | H | 2-F | 3-F | 5-F |
| No. 3 | CH₃ | H | 2-F | 4-F | 5-F |
| No. 4 | CH₃ | H | 2-F | 4-F | 6-F |
| No. 5 | CH₃ | H | 3-F | 4-F | 5-F |
| No. 6 | CH₃ | H | 3-F | 5-F | 6-F |
| No. 7 | CH₂F | H | 2-F | 3-F | 4-F |
| No. 8 | CH₂F | H | 2-F | 3-F | 5-F |
| No. 9 | CH₂F | H | 2-F | 4-F | 5-F |
| No. 10 | CH₂F | H | 2-F | 4-F | 6-F |
| No. 11 | CH₂F | H | 3-F | 4-F | 5-F |
| No. 12 | CH₂F | H | 3-F | 5-F | 6-F |
| No. 13 | CHF₂ | H | 2-F | 3-F | 4-F |
| No. 14 | CHF₂ | H | 2-F | 3-F | 5-F |
| No. 15 | CHF₂ | H | 2-F | 4-F | 5-F |
| No. 16 | CHF₂ | H | 2-F | 4-F | 6-F |
| No. 17 | CHF₂ | H | 3-F | 4-F | 5-F |
| No. 18 | CHF₂ | H | 3-F | 5-F | 6-F |
| No. 19 | CF₃ | H | 2-F | 3-F | 4-F |
| No. 20 | CF₃ | H | 2-F | 3-F | 5-F |
| No. 21 | CF₃ | H | 2-F | 4-F | 5-F |
| No. 22 | CF₃ | H | 2-F | 4-F | 6-F |
| No. 23 | CF₃ | H | 3-F | 4-F | 5-F |
| No. 24 | CF₃ | H | 3-F | 5-F | 6-F |
| No. 25 | CHFCl | H | 2-F | 3-F | 4-F |
| No. 26 | CHFCl | H | 2-F | 3-F | 5-F |
| No. 27 | CHFCl | H | 2-F | 4-F | 5-F |
| No. 28 | CHFCl | H | 2-F | 4-F | 6-F |
| No. 29 | CHFCl | H | 3-F | 4-F | 5-F |
| No. 30 | CHFCl | H | 3-F | 5-F | 6-F |
| No. 31 | CF₂Cl | H | 2-F | 3-F | 4-F |
| No. 32 | CF₂Cl | H | 2-F | 3-F | 5-F |
| No. 33 | CF₂Cl | H | 2-F | 4-F | 5-F |
| No. 34 | CF₂Cl | H | 2-F | 4-F | 6-F |
| No. 35 | CF₂Cl | H | 3-F | 4-F | 5-F |
| No. 36 | CF₂Cl | H | 3-F | 5-F | 6-F |
| No. 37 | CH₃ | F | 2-F | 3-F | 4-F |
| No. 38 | CH₃ | F | 2-F | 3-F | 5-F |
| No. 39 | CH₃ | F | 2-F | 4-F | 5-F |
| No. 40 | CH₃ | F | 2-F | 4-F | 6-F |
| No. 41 | CH₃ | F | 3-F | 4-F | 5-F |
| No. 42 | CH₃ | F | 3-F | 5-F | 6-F |
| No. 43 | CH₂F | F | 2-F | 3-F | 4-F |
| No. 44 | CH₂F | F | 2-F | 3-F | 5-F |
| No. 45 | CH₂F | F | 2-F | 4-F | 5-F |
| No. 46 | CH₂F | F | 2-F | 4-F | 6-F |
| No. 47 | CH₂F | F | 3-F | 4-F | 5-F |
| No. 48 | CH₂F | F | 3-F | 5-F | 6-F |
| No. 49 | CHF₂ | F | 2-F | 3-F | 4-F |
| No. 50 | CHF₂ | F | 2-F | 3-F | 5-F |
| No. 51 | CHF₂ | F | 2-F | 4-F | 5-F |
| No. 52 | CHF₂ | F | 2-F | 4-F | 6-F |
| No. 53 | CHF₂ | F | 3-F | 4-F | 5-F |
| No. 54 | CHF₂ | F | 3-F | 5-F | 6-F |
| No. 55 | CF₃ | F | 2-F | 3-F | 4-F |
| No. 56 | CF₃ | F | 2-F | 3-F | 5-F |
| No. 57 | CF₃ | F | 2-F | 4-F | 5-F |
| No. 58 | CF₃ | F | 2-F | 4-F | 6-F |
| No. 59 | CF₃ | F | 3-F | 4-F | 5-F |
| No. 60 | CF₃ | F | 3-F | 5-F | 6-F |
| No. 61 | CHFCl | F | 2-F | 3-F | 4-F |
| No. 62 | CHFCl | F | 2-F | 3-F | 5-F |
| No. 63 | CHFCl | F | 2-F | 4-F | 5-F |
| No. 64 | CHFCl | F | 2-F | 4-F | 6-F |
| No. 65 | CHFCl | F | 3-F | 4-F | 5-F |
| No. 66 | CHFCl | F | 3-F | 5-F | 6-F |
| No. 67 | CF₂Cl | F | 2-F | 3-F | 4-F |
| No. 68 | CF₂Cl | F | 2-F | 3-F | 5-F |
| No. 69 | CF₂Cl | F | 2-F | 4-F | 5-F |
| No. 70 | CF₂Cl | F | 2-F | 4-F | 6-F |
| No. 71 | CF₂Cl | F | 3-F | 4-F | 5-F |
| No. 72 | CF₂Cl | F | 3-F | 5-F | 6-F |
| No. 73 | CH₃ | Cl | 2-F | 3-F | 4-F |
| No. 74 | CH₃ | Cl | 2-F | 3-F | 5-F |
| No. 75 | CH₃ | Cl | 2-F | 4-F | 5-F |
| No. 76 | CH₃ | Cl | 2-F | 4-F | 6-F |
| No. 77 | CH₃ | Cl | 3-F | 4-F | 5-F |
| No. 78 | CH₃ | Cl | 3-F | 5-F | 6-F |
| No. 79 | CH₂F | Cl | 2-F | 3-F | 4-F |
| No. 80 | CH₂F | Cl | 2-F | 3-F | 5-F |
| No. 81 | CH₂F | Cl | 2-F | 4-F | 5-F |
| No. 82 | CH₂F | Cl | 2-F | 4-F | 6-F |
| No. 83 | CH₂F | Cl | 3-F | 4-F | 5-F |
| No. 84 | CH₂F | Cl | 3-F | 5-F | 6-F |
| No. 85 | CHF₂ | Cl | 2-F | 3-F | 4-F |
| No. 86 | CHF₂ | Cl | 2-F | 3-F | 5-F |
| No. 87 | CHF₂ | Cl | 2-F | 4-F | 5-F |
| No. 88 | CHF₂ | Cl | 2-F | 4-F | 6-F |
| No. 89 | CHF₂ | Cl | 3-F | 4-F | 5-F |
| No. 90 | CHF₂ | Cl | 3-F | 5-F | 6-F |
| No. 91 | CF₃ | Cl | 2-F | 3-F | 4-F |
| No. 92 | CF₃ | Cl | 2-F | 3-F | 5-F |
| No. 93 | CF₃ | Cl | 2-F | 4-F | 5-F |
| No. 94 | CF₃ | Cl | 2-F | 4-F | 6-F |
| No. 95 | CF₃ | Cl | 3-F | 4-F | 5-F |
| No. 96 | CF₃ | Cl | 3-F | 5-F | 6-F |
| No. 97 | CHFCl | Cl | 2-F | 3-F | 4-F |
| No. 98 | CHFCl | Cl | 2-F | 3-F | 5-F |
| No. 99 | CHFCl | Cl | 2-F | 4-F | 5-F |
| No. 100 | CHFCl | Cl | 2-F | 4-F | 6-F |
| No. 101 | CHFCl | Cl | 3-F | 4-F | 5-F |
| No. 102 | CHFCl | Cl | 3-F | 5-F | 6-F |
| No. 103 | CF₂Cl | Cl | 2-F | 3-F | 4-F |
| No. 104 | CF₂Cl | Cl | 2-F | 3-F | 5-F |
| No. 105 | CF₂Cl | Cl | 2-F | 4-F | 5-F |
| No. 106 | CF₂Cl | Cl | 2-F | 4-F | 6-F |
| No. 107 | CF₂Cl | Cl | 3-F | 4-F | 5-F |
| No. 108 | CF₂Cl | Cl | 3-F | 5-F | 6-F |

Particular preference is furthermore given to 1-methylpyrazol-4-ylcarboxanilides of the formula Ia (I where X═H, R¹═CF₃ and R²═H)

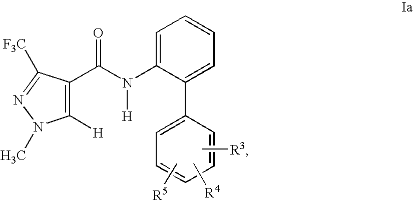

in particular to the compounds Ia.1 to Ia.1010 listed in Table 2 below:

TABLE 2

| Compound No. | R¹ | R² | R³ | R⁴ | R⁵ |
|---|---|---|---|---|---|
| Ia.1 | CF₃ | H | 2-fluoro | 3-fluoro | 4-fluoro |
| Ia.2 | CF₃ | H | 2-fluoro | 3-chloro | 4-fluoro |
| Ia.3 | CF₃ | H | 2-fluoro | 3-CN | 4-fluoro |
| Ia.4 | CF₃ | H | 2-fluoro | 3-methyl | 4-fluoro |
| Ia.5 | CF₃ | H | 2-fluoro | 3-CF₃ | 4-fluoro |
| Ia.6 | CF₃ | H | 2-fluoro | 3-OCH₃ | 4-fluoro |
| Ia.7 | CF₃ | H | 2-fluoro | 3-OCF₃ | 4-fluoro |
| Ia.8 | CF₃ | H | 2-chloro | 3-fluoro | 4-fluoro |
| Ia.9 | CF₃ | H | 2-chloro | 3-chloro | 4-fluoro |
| Ia.10 | CF₃ | H | 2-chloro | 3-CN | 4-fluoro |
| Ia.11 | CF₃ | H | 2-chloro | 3-methyl | 4-fluoro |
| Ia.12 | CF₃ | H | 2-chloro | 3-CF₃ | 4-fluoro |
| Ia.13 | CF₃ | H | 2-chloro | 3-OCH₃ | 4-fluoro |
| Ia.14 | CF₃ | H | 2-chloro | 3-OCF₃ | 4-fluoro |
| Ia.15 | CF₃ | H | 2-CN | 3-fluoro | 4-fluoro |
| Ia.16 | CF₃ | H | 2-CN | 3-chloro | 4-fluoro |
| Ia.17 | CF₃ | H | 2-CN | 3-CN | 4-fluoro |
| Ia.18 | CF₃ | H | 2-CN | 3-methyl | 4-fluoro |
| Ia.19 | CF₃ | H | 2-CN | 3-CF₃ | 4-fluoro |
| Ia.20 | CF₃ | H | 2-CN | 3-OCH₃ | 4-fluoro |
| Ia.21 | CF₃ | H | 2-CN | 3-OCF₃ | 4-fluoro |
| Ia.22 | CF₃ | H | 2-methyl | 3-fluoro | 4-fluoro |
| Ia.23 | CF₃ | H | 2-methyl | 3-chloro | 4-fluoro |
| Ia.24 | CF₃ | H | 2-methyl | 3-CN | 4-fluoro |
| Ia.25 | CF₃ | H | 2-methyl | 3-methyl | 4-fluoro |
| Ia.26 | CF₃ | H | 2-methyl | 3-CF₃ | 4-fluoro |
| Ia.27 | CF₃ | H | 2-methyl | 3-OCH₃ | 4-fluoro |
| Ia.28 | CF₃ | H | 2-methyl | 3-OCF₃ | 4-fluoro |
| Ia.29 | CF₃ | H | 2-CF₃ | 3-fluoro | 4-fluoro |
| Ia.30 | CF₃ | H | 2-CF₃ | 3-chloro | 4-fluoro |
| Ia.31 | CF₃ | H | 2-CF₃ | 3-CN | 4-fluoro |
| Ia.32 | CF₃ | H | 2-CF₃ | 3-methyl | 4-fluoro |
| Ia.33 | CF₃ | H | 2-CF₃ | 3-CF₃ | 4-fluoro |
| Ia.34 | CF₃ | H | 2-CF₃ | 3-OCH₃ | 4-fluoro |
| Ia.35 | CF₃ | H | 2-CF₃ | 3-OCF₃ | 4-fluoro |
| Ia.36 | CF₃ | H | 2-OCH₃ | 3-fluoro | 4-fluoro |
| Ia.37 | CF₃ | H | 2-OCH₃ | 3-chloro | 4-fluoro |
| Ia.38 | CF₃ | H | 2-OCH₃ | 3-CN | 4-fluoro |
| Ia.39 | CF₃ | H | 2-OCH₃ | 3-methyl | 4-fluoro |
| Ia.40 | CF₃ | H | 2-OCH₃ | 3-CF₃ | 4-fluoro |
| Ia.41 | CF₃ | H | 2-OCH₃ | 3-OCH₃ | 4-fluoro |
| Ia.42 | CF₃ | H | 2-OCH₃ | 3-OCF₃ | 4-fluoro |
| Ia.43 | CF₃ | H | 2-OCF₃ | 3-fluoro | 4-fluoro |
| Ia.44 | CF₃ | H | 2-OCF₃ | 3-chloro | 4-fluoro |
| Ia.45 | CF₃ | H | 2-OCF₃ | 3-CN | 4-fluoro |
| Ia.46 | CF₃ | H | 2-OCF₃ | 3-methyl | 4-fluoro |
| Ia.47 | CF₃ | H | 2-OCF₃ | 3-CF₃ | 4-fluoro |
| Ia.48 | CF₃ | H | 2-OCF₃ | 3-OCH₃ | 4-fluoro |
| Ia.49 | CF₃ | H | 2-OCF₃ | 3-OCF₃ | 4-fluoro |
| Ia.50 | CF₃ | H | 2-fluoro | 3-fluoro | 4-chloro |
| Ia.51 | CF₃ | H | 2-fluoro | 3-chloro | 4-chloro |
| Ia.52 | CF₃ | H | 2-fluoro | 3-CN | 4-chloro |
| Ia.53 | CF₃ | H | 2-fluoro | 3-methyl | 4-chloro |
| Ia.54 | CF₃ | H | 2-fluoro | 3-CF₃ | 4-chloro |
| Ia.55 | CF₃ | H | 2-fluoro | 3-OCH₃ | 4-chloro |
| Ia.56 | CF₃ | H | 2-fluoro | 3-OCF₃ | 4-chloro |
| Ia.57 | CF₃ | H | 2-chloro | 3-fluoro | 4-chloro |
| Ia.58 | CF₃ | H | 2-chloro | 3-chloro | 4-chloro |
| Ia.59 | CF₃ | H | 2-chloro | 3-CN | 4-chloro |
| Ia.60 | CF₃ | H | 2-chloro | 3-methyl | 4-chloro |
| Ia.61 | CF₃ | H | 2-chloro | 3-CF₃ | 4-chloro |
| Ia.62 | CF₃ | H | 2-chloro | 3-OCH₃ | 4-chloro |
| Ia.63 | CF₃ | H | 2-chloro | 3-OCF₃ | 4-chloro |
| Ia.64 | CF₃ | H | 2-CN | 3-fluoro | 4-chloro |
| Ia.65 | CF₃ | H | 2-CN | 3-chloro | 4-chloro |
| Ia.66 | CF₃ | H | 2-CN | 3-CN | 4-chloro |
| Ia.67 | CF₃ | H | 2-CN | 3-methyl | 4-chloro |
| Ia.68 | CF₃ | H | 2-CN | 3-CF₃ | 4-chloro |
| Ia.69 | CF₃ | H | 2-CN | 3-OCH₃ | 4-chloro |
| Ia.70 | CF₃ | H | 2-CN | 3-OCF₃ | 4-chloro |
| Ia.71 | CF₃ | H | 2-methyl | 3-fluoro | 4-chloro |
| Ia.72 | CF₃ | H | 2-methyl | 3-chloro | 4-chloro |
| Ia.73 | CF₃ | H | 2-methyl | 3-CN | 4-chloro |
| Ia.74 | CF₃ | H | 2-methyl | 3-methyl | 4-chloro |
| Ia.75 | CF₃ | H | 2-methyl | 3-CF₃ | 4-chloro |
| Ia.76 | CF₃ | H | 2-methyl | 3-OCH₃ | 4-chloro |
| Ia.77 | CF₃ | H | 2-methyl | 3-OCF₃ | 4-chloro |
| Ia.78 | CF₃ | H | 2-CF₃ | 3-fluoro | 4-chloro |
| Ia.79 | CF₃ | H | 2-CF₃ | 3-chloro | 4-chloro |
| Ia.80 | CF₃ | H | 2-CF₃ | 3-CN | 4-chloro |
| Ia.81 | CF₃ | H | 2-CF₃ | 3-methyl | 4-chloro |
| Ia.82 | CF₃ | H | 2-CF₃ | 3-CF₃ | 4-chloro |
| Ia.83 | CF₃ | H | 2-CF₃ | 3-OCH₃ | 4-chloro |
| Ia.84 | CF₃ | H | 2-CF₃ | 3-OCF₃ | 4-chloro |
| Ia.85 | CF₃ | H | 2-OCH₃ | 3-fluoro | 4-chloro |
| Ia.86 | CF₃ | H | 2-OCH₃ | 3-chloro | 4-chloro |
| Ia.87 | CF₃ | H | 2-OCH₃ | 3-CN | 4-chloro |
| Ia.88 | CF₃ | H | 2-OCH₃ | 3-methyl | 4-chloro |
| Ia.89 | CF₃ | H | 2-OCH₃ | 3-CF₃ | 4-chloro |
| Ia.90 | CF₃ | H | 2-OCH₃ | 3-OCH₃ | 4-chloro |
| Ia.91 | CF₃ | H | 2-OCH₃ | 3-OCF₃ | 4-chloro |
| Ia.92 | CF₃ | H | 2-OCF₃ | 3-fluoro | 4-chloro |
| Ia.93 | CF₃ | H | 2-OCF₃ | 3-chloro | 4-chloro |
| Ia.94 | CF₃ | H | 2-OCF₃ | 3-CN | 4-chloro |
| Ia.95 | CF₃ | H | 2-OCF₃ | 3-methyl | 4-chloro |
| Ia.96 | CF₃ | H | 2-OCF₃ | 3-CF₃ | 4-chloro |
| Ia.97 | CF₃ | H | 2-OCF₃ | 3-OCH₃ | 4-chloro |
| Ia.98 | CF₃ | H | 2-OCF₃ | 3-OCF₃ | 4-chloro |
| Ia.99 | CF₃ | H | 2-fluoro | 3-fluoro | 4-CN |
| Ia.100 | CF₃ | H | 2-fluoro | 3-chloro | 4-CN |
| Ia.101 | CF₃ | H | 2-fluoro | 3-CN | 4-CN |
| Ia.102 | CF₃ | H | 2-fluoro | 3-methyl | 4-CN |
| Ia.103 | CF₃ | H | 2-fluoro | 3-CF₃ | 4-CN |
| Ia.104 | CF₃ | H | 2-fluoro | 3-OCH₃ | 4-CN |
| Ia.105 | CF₃ | H | 2-fluoro | 3-OCF₃ | 4-CN |
| Ia.106 | CF₃ | H | 2-chloro | 3-fluoro | 4-CN |
| Ia.107 | CF₃ | H | 2-chloro | 3-chloro | 4-CN |
| Ia.108 | CF₃ | H | 2-chloro | 3-CN | 4-CN |
| Ia.109 | CF₃ | H | 2-chloro | 3-methyl | 4-CN |
| Ia.110 | CF₃ | H | 2-chloro | 3-CF₃ | 4-CN |
| Ia.111 | CF₃ | H | 2-chloro | 3-OCH₃ | 4-CN |
| Ia.112 | CF₃ | H | 2-chloro | 3-OCF₃ | 4-CN |
| Ia.113 | CF₃ | H | 2-CN | 3-fluoro | 4-CN |
| Ia.114 | CF₃ | H | 2-CN | 3-chloro | 4-CN |
| Ia.115 | CF₃ | H | 2-CN | 3-CN | 4-CN |
| Ia.116 | CF₃ | H | 2-CN | 3-methyl | 4-CN |
| Ia.117 | CF₃ | H | 2-CN | 3-CF₃ | 4-CN |
| Ia.118 | CF₃ | H | 2-CN | 3-OCH₃ | 4-CN |
| Ia.119 | CF₃ | H | 2-CN | 3-OCF₃ | 4-CN |
| Ia.120 | CF₃ | H | 2-methyl | 3-fluoro | 4-CN |
| Ia.121 | CF₃ | H | 2-methyl | 3-chloro | 4-CN |
| Ia.122 | CF₃ | H | 2-methyl | 3-CN | 4-CN |
| Ia.123 | CF₃ | H | 2-methyl | 3-methyl | 4-CN |
| Ia.124 | CF₃ | H | 2-methyl | 3-CF₃ | 4-CN |
| Ia.125 | CF₃ | H | 2-methyl | 3-OCH₃ | 4-CN |
| Ia.126 | CF₃ | H | 2-methyl | 3-OCF₃ | 4-CN |
| Ia.127 | CF₃ | H | 2-CF₃ | 3-fluoro | 4-CN |
| Ia.128 | CF₃ | H | 2-CF₃ | 3-chloro | 4-CN |
| Ia.129 | CF₃ | H | 2-CF₃ | 3-CN | 4-CN |
| Ia.130 | CF₃ | H | 2-CF₃ | 3-methyl | 4-CN |
| Ia.131 | CF₃ | H | 2-CF₃ | 3-CF₃ | 4-CN |
| Ia.132 | CF₃ | H | 2-CF₃ | 3-OCH₃ | 4-CN |
| Ia.133 | CF₃ | H | 2-CF₃ | 3-OCF₃ | 4-CN |
| Ia.134 | CF₃ | H | 2-OCH₃ | 3-fluoro | 4-CN |
| Ia.135 | CF₃ | H | 2-OCH₃ | 3-chloro | 4-CN |
| Ia.136 | CF₃ | H | 2-OCH₃ | 3-CN | 4-CN |
| Ia.137 | CF₃ | H | 2-OCH₃ | 3-methyl | 4-CN |
| Ia.138 | CF₃ | H | 2-OCH₃ | 3-CF₃ | 4-CN |
| Ia.139 | CF₃ | H | 2-OCH₃ | 3-OCH₃ | 4-CN |
| Ia.140 | CF₃ | H | 2-OCH₃ | 3-OCF₃ | 4-CN |
| Ia.141 | CF₃ | H | 2-OCF₃ | 3-fluoro | 4-CN |
| Ia.142 | CF₃ | H | 2-OCF₃ | 3-chloro | 4-CN |
| Ia.143 | CF₃ | H | 2-OCF₃ | 3-CN | 4-CN |
| Ia.144 | CF₃ | H | 2-OCF₃ | 3-methyl | 4-CN |
| Ia.145 | CF₃ | H | 2-OCF₃ | 3-CF₃ | 4-CN |
| Ia.146 | CF₃ | H | 2-OCF₃ | 3-OCH₃ | 4-CN |
| Ia.147 | CF₃ | H | 2-OCF₃ | 3-OCF₃ | 4-CN |
| Ia.148 | CF₃ | H | 2-fluoro | 3-fluoro | 4-methyl |
| Ia.149 | CF₃ | H | 2-fluoro | 3-chloro | 4-methyl |
| Ia.150 | CF₃ | H | 2-fluoro | 3-CN | 4-methyl |
| Ia.151 | CF₃ | H | 2-fluoro | 3-methyl | 4-methyl |
| Ia.152 | CF₃ | H | 2-fluoro | 3-CF₃ | 4-methyl |
| Ia.153 | CF₃ | H | 2-fluoro | 3-OCH₃ | 4-methyl |
| Ia.154 | CF₃ | H | 2-fluoro | 3-OCF₃ | 4-methyl |
| Ia.155 | CF₃ | H | 2-chloro | 3-fluoro | 4-methyl |
| Ia.156 | CF₃ | H | 2-chloro | 3-chloro | 4-methyl |
| Ia.157 | CF₃ | H | 2-chloro | 3-CN | 4-methyl |
| Ia.158 | CF₃ | H | 2-chloro | 3-methyl | 4-methyl |
| Ia.159 | CF₃ | H | 2-chloro | 3-CF₃ | 4-methyl |
| Ia.160 | CF₃ | H | 2-chloro | 3-OCH₃ | 4-methyl |
| Ia.161 | CF₃ | H | 2-chloro | 3-OCF₃ | 4-methyl |
| Ia.162 | CF₃ | H | 2-CN | 3-fluoro | 4-methyl |
| Ia.163 | CF₃ | H | 2-CN | 3-chloro | 4-methyl |
| Ia.164 | CF₃ | H | 2-CN | 3-CN | 4-methyl |
| Ia.165 | CF₃ | H | 2-CN | 3-methyl | 4-methyl |
| Ia.166 | CF₃ | H | 2-CN | 3-CF₃ | 4-methyl |
| Ia.167 | CF₃ | H | 2-CN | 3-OCH₃ | 4-methyl |
| Ia.168 | CF₃ | H | 2-CN | 3-OCF₃ | 4-methyl |
| Ia.169 | CF₃ | H | 2-methyl | 3-fluoro | 4-methyl |
| Ia.170 | CF₃ | H | 2-methyl | 3-chloro | 4-methyl |
| Ia.171 | CF₃ | H | 2-methyl | 3-CN | 4-methyl |
| Ia.172 | CF₃ | H | 2-methyl | 3-methyl | 4-methyl |
| Ia.173 | CF₃ | H | 2-methyl | 3-CF₃ | 4-methyl |
| Ia.174 | CF₃ | H | 2-methyl | 3-OCH₃ | 4-methyl |
| Ia.175 | CF₃ | H | 2-methyl | 3-OCF₃ | 4-methyl |
| Ia.176 | CF₃ | H | 2-CF₃ | 3-fluoro | 4-methyl |
| Ia.177 | CF₃ | H | 2-CF₃ | 3-chloro | 4-methyl |
| Ia.178 | CF₃ | H | 2-CF₃ | 3-CN | 4-methyl |
| Ia.179 | CF₃ | H | 2-CF₃ | 3-methyl | 4-methyl |
| Ia.180 | CF₃ | H | 2-CF₃ | 3-CF₃ | 4-methyl |
| Ia.181 | CF₃ | H | 2-CF₃ | 3-OCH₃ | 4-methyl |
| Ia.182 | CF₃ | H | 2-CF₃ | 3-OCF₃ | 4-methyl |
| Ia.183 | CF₃ | H | 2-OCH₃ | 3-fluoro | 4-methyl |
| Ia.184 | CF₃ | H | 2-OCH₃ | 3-chloro | 4-methyl |
| Ia.185 | CF₃ | H | 2-OCH₃ | 3-CN | 4-methyl |
| Ia.186 | CF₃ | H | 2-OCH₃ | 3-methyl | 4-methyl |
| Ia.187 | CF₃ | H | 2-OCH₃ | 3-CF₃ | 4-methyl |
| Ia.188 | CF₃ | H | 2-OCH₃ | 3-OCH₃ | 4-methyl |
| Ia.189 | CF₃ | H | 2-OCH₃ | 3-OCF₃ | 4-methyl |
| Ia.190 | CF₃ | H | 2-OCF₃ | 3-fluoro | 4-methyl |
| Ia.191 | CF₃ | H | 2-OCF₃ | 3-chloro | 4-methyl |
| Ia.192 | CF₃ | H | 2-OCF₃ | 3-CN | 4-methyl |
| Ia.193 | CF₃ | H | 2-OCF₃ | 3-methyl | 4-methyl |
| Ia.194 | CF₃ | H | 2-OCF₃ | 3-CF₃ | 4-methyl |
| Ia.195 | CF₃ | H | 2-OCF₃ | 3-OCH₃ | 4-methyl |
| Ia.196 | CF₃ | H | 2-OCF₃ | 3-OCF₃ | 4-methyl |
| Ia.197 | CF₃ | H | 2-fluoro | 3-fluoro | 4-CF3 |
| Ia.198 | CF₃ | H | 2-fluoro | 3-chloro | 4-CF3 |
| Ia.199 | CF₃ | H | 2-fluoro | 3-CN | 4-CF3 |
| Ia.200 | CF₃ | H | 2-fluoro | 3-methyl | 4-CF3 |
| Ia.201 | CF₃ | H | 2-fluoro | 3-CF₃ | 4-CF3 |
| Ia.202 | CF₃ | H | 2-fluoro | 3-OCH₃ | 4-CF3 |
| Ia.203 | CF₃ | H | 2-fluoro | 3-OCF₃ | 4-CF3 |
| Ia.204 | CF₃ | H | 2-chloro | 3-fluoro | 4-CF₃ |
| Ia.205 | CF₃ | H | 2-chloro | 3-chloro | 4-CF₃ |
| Ia.206 | CF₃ | H | 2-chloro | 3-CN | 4-CF₃ |
| Ia.207 | CF₃ | H | 2-chloro | 3-methyl | 4-CF₃ |
| Ia.208 | CF₃ | H | 2-chloro | 3-CF₃ | 4-CF₃ |
| Ia.209 | CF₃ | H | 2-chloro | 3-OCH₃ | 4-CF₃ |
| Ia.210 | CF₃ | H | 2-chloro | 3-OCF₃ | 4-CF₃ |
| Ia.211 | CF₃ | H | 2-CN | 3-fluoro | 4-CF₃ |
| Ia.212 | CF₃ | H | 2-CN | 3-chloro | 4-CF₃ |
| Ia.213 | CF₃ | H | 2-CN | 3-CN | 4-CF₃ |
| Ia.214 | CF₃ | H | 2-CN | 3-methyl | 4-CF₃ |
| Ia.215 | CF₃ | H | 2-CN | 3-CF₃ | 4-CF₃ |
| Ia.216 | CF₃ | H | 2-CN | 3-OCH₃ | 4-CF₃ |
| Ia.217 | CF₃ | H | 2-CN | 3-OCF₃ | 4-CF₃ |
| Ia.218 | CF₃ | H | 2-methyl | 3-fluoro | 4-CF3 |
| Ia.219 | CF₃ | H | 2-methyl | 3-chloro | 4-CF3 |
| Ia.220 | CF₃ | H | 2-methyl | 3-CN | 4-CF3 |
| Ia.221 | CF₃ | H | 2-methyl | 3-methyl | 4-CF3 |
| Ia.222 | CF₃ | H | 2-methyl | 3-CF₃ | 4-CF3 |
| Ia.223 | CF₃ | H | 2-methyl | 3-OCH₃ | 4-CF3 |
| Ia.224 | CF₃ | H | 2-methyl | 3-OCF₃ | 4-CF3 |
| Ia.225 | CF₃ | H | 2-CF₃ | 3-fluoro | 4-CF3 |
| Ia.226 | CF₃ | H | 2-CF₃ | 3-chloro | 4-CF₃ |
| Ia.227 | CF₃ | H | 2-CF₃ | 3-CN | 4-CF3 |
| Ia.228 | CF₃ | H | 2-CF₃ | 3-methyl | 4-CF3 |
| Ia.229 | CF₃ | H | 2-CF₃ | 3-CF₃ | 4-CF3 |
| Ia.230 | CF₃ | H | 2-CF₃ | 3-OCH₃ | 4-CF3 |
| Ia.231 | CF₃ | H | 2-CF₃ | 3-OCF₃ | 4-CF3 |
| Ia.232 | CF₃ | H | 2-OCH₃ | 3-fluoro | 4-CF3 |
| Ia.233 | CF₃ | H | 2-OCH₃ | 3-chloro | 4-CF3 |
| Ia.234 | CF₃ | H | 2-OCH₃ | 3-CN | 4-CF3 |
| Ia.235 | CF₃ | H | 2-OCH₃ | 3-methyl | 4-CF3 |
| Ia.236 | CF₃ | H | 2-OCH₃ | 3-CF₃ | 4-CF3 |
| Ia.237 | CF₃ | H | 2-OCH₃ | 3-OCH₃ | 4-CF₃ |
| Ia.238 | CF₃ | H | 2-OCH₃ | 3-OCF₃ | 4-CF₃ |
| Ia.239 | CF₃ | H | 2-OCF₃ | 3-fluoro | 4-CF₃ |
| Ia.240 | CF₃ | H | 2-OCF₃ | 3-chloro | 4-CF₃ |
| Ia.241 | CF₃ | H | 2-OCF₃ | 3-CN | 4-CF₃ |
| Ia.242 | CF₃ | H | 2-OCF₃ | 3-methyl | 4-CF₃ |
| Ia.243 | CF₃ | H | 2-OCF₃ | 3-CF₃ | 4-CF₃ |
| Ia.244 | CF₃ | H | 2-OCF₃ | 3-OCH₃ | 4-CF₃ |
| Ia.245 | CF₃ | H | 2-OCF₃ | 3-OCF₃ | 4-CF₃ |
| Ia.246 | CF₃ | H | 2-fluoro | 3-fluoro | 4-OCH₃ |
| Ia.247 | CF₃ | H | 2-fluoro | 3-chloro | 4-OCH₃ |
| Ia.248 | CF₃ | H | 2-fluoro | 3-CN | 4-OCH₃ |
| Ia.249 | CF₃ | H | 2-fluoro | 3-methyl | 4-OCH₃ |
| Ia.250 | CF₃ | H | 2-fluoro | 3-CF₃ | 4-OCH₃ |
| Ia.251 | CF₃ | H | 2-fluoro | 3-OCH₃ | 4-OCH₃ |
| Ia.252 | CF₃ | H | 2-fluoro | 3-OCF₃ | 4-OCH₃ |
| Ia.253 | CF₃ | H | 2-chloro | 3-fluoro | 4-OCH₃ |
| Ia.254 | CF₃ | H | 2-chloro | 3-chloro | 4-OCH₃ |
| Ia.255 | CF₃ | H | 2-chloro | 3-CN | 4-OCH₃ |
| Ia.256 | CF₃ | H | 2-chloro | 3-methyl | 4-OCH₃ |
| Ia.257 | CF₃ | H | 2-chloro | 3-CF₃ | 4-OCH₃ |
| Ia.258 | CF₃ | H | 2-chloro | 3-OCH₃ | 4-OCH₃ |
| Ia.259 | CF₃ | H | 2-chloro | 3-OCF₃ | 4-OCH₃ |
| Ia.260 | CF₃ | H | 2-CN | 3-fluoro | 4-OCH₃ |
| Ia.261 | CF₃ | H | 2-CN | 3-chloro | 4-OCH₃ |
| Ia.262 | CF₃ | H | 2-CN | 3-CN | 4-OCH₃ |
| Ia.263 | CF₃ | H | 2-CN | 3-methyl | 4-OCH₃ |
| Ia.264 | CF₃ | H | 2-CN | 3-CF₃ | 4-OCH₃ |
| Ia.265 | CF₃ | H | 2-CN | 3-OCH₃ | 4-OCH₃ |
| Ia.266 | CF₃ | H | 2-CN | 3-OCF₃ | 4-OCH₃ |
| Ia.267 | CF₃ | H | 2-methyl | 3-fluoro | 4-OCH₃ |
| Ia.268 | CF₃ | H | 2-methyl | 3-chloro | 4-OCH₃ |
| Ia.269 | CF₃ | H | 2-methyl | 3-CN | 4-OCH₃ |
| Ia.270 | CF₃ | H | 2-methyl | 3-methyl | 4-OCH₃ |
| Ia.271 | CF₃ | H | 2-methyl | 3-CF₃ | 4-OCH₃ |
| Ia.272 | CF₃ | H | 2-methyl | 3-OCH₃ | 4-OCH₃ |
| Ia.273 | CF₃ | H | 2-methyl | 3-OCF₃ | 4-OCH₃ |
| Ia.274 | CF₃ | H | 2-CF₃ | 3-fluoro | 4-OCH₃ |
| Ia.275 | CF₃ | H | 2-CF₃ | 3-chloro | 4-OCH₃ |
| Ia.276 | CF₃ | H | 2-CF₃ | 3-CN | 4-OCH₃ |
| Ia.277 | CF₃ | H | 2-CF₃ | 3-methyl | 4-OCH₃ |
| Ia.278 | CF₃ | H | 2-CF₃ | 3-CF₃ | 4-OCH₃ |
| Ia.279 | CF₃ | H | 2-CF₃ | 3-OCH₃ | 4-OCH₃ |
| Ia.280 | CF₃ | H | 2-CF₃ | 3-OCF₃ | 4-OCH₃ |
| Ia.281 | CF₃ | H | 2-OCH₃ | 3-fluoro | 4-OCH₃ |
| Ia.282 | CF₃ | H | 2-OCH₃ | 3-chloro | 4-OCH₃ |
| Ia.283 | CF₃ | H | 2-OCH₃ | 3-CN | 4-OCH₃ |
| Ia.284 | CF₃ | H | 2-OCH₃ | 3-methyl | 4-OCH₃ |
| Ia.285 | CF₃ | H | 2-OCH₃ | 3-CF₃ | 4-OCH₃ |
| Ia.286 | CF₃ | H | 2-OCH₃ | 3-OCH₃ | 4-OCH₃ |
| Ia.287 | CF₃ | H | 2-OCH₃ | 3-OCF₃ | 4-OCH₃ |
| Ia.288 | CF₃ | H | 2-OCF₃ | 3-fluoro | 4-OCH₃ |
| Ia.289 | CF₃ | H | 2-OCF₃ | 3-chloro | 4-OCH₃ |
| Ia.290 | CF₃ | H | 2-OCF₃ | 3-CN | 4-OCH₃ |
| Ia.291 | CF₃ | H | 2-OCF₃ | 3-methyl | 4-OCH₃ |
| Ia.292 | CF₃ | H | 2-OCF₃ | 3-CF₃ | 4-OCH₃ |
| Ia.293 | CF₃ | H | 2-OCF₃ | 3-OCH₃ | 4-OCH₃ |
| Ia.294 | CF₃ | H | 2-OCF₃ | 3-OCF₃ | 4-OCH₃ |
| Ia.295 | CF₃ | H | 2-fluoro | 3-fluoro | 4-OCF₃ |
| Ia.296 | CF₃ | H | 2-fluoro | 3-chloro | 4-OCF₃ |
| Ia.297 | CF₃ | H | 2-fluoro | 3-CN | 4-OCF₃ |
| Ia.298 | CF₃ | H | 2-fluoro | 3-methyl | 4-OCF₃ |
| Ia.299 | CF₃ | H | 2-fluoro | 3-CF₃ | 4-OCF₃ |
| Ia.300 | CF₃ | H | 2-fluoro | 3-OCH₃ | 4-OCF₃ |
| Ia.301 | CF₃ | H | 2-fluoro | 3-OCF₃ | 4-OCF₃ |
| Ia.302 | CF₃ | H | 2-chloro | 3-fluoro | 4-OCF₃ |
| Ia.303 | CF₃ | H | 2-chloro | 3-chloro | 4-OCF₃ |
| Ia.304 | CF₃ | H | 2-chloro | 3-CN | 4-OCF₃ |
| Ia.305 | CF₃ | H | 2-chloro | 3-methyl | 4-OCF₃ |
| Ia.306 | CF₃ | H | 2-chloro | 3-CF₃ | 4-OCF₃ |
| Ia.307 | CF₃ | H | 2-chloro | 3-OCH₃ | 4-OCF₃ |
| Ia.308 | CF₃ | H | 2-chloro | 3-OCF₃ | 4-OCF₃ |
| Ia.309 | CF₃ | H | 2-CN | 3-fluoro | 4-OCF₃ |
| Ia.310 | CF₃ | H | 2-CN | 3-chloro | 4-OCF₃ |
| Ia.311 | CF₃ | H | 2-CN | 3-CN | 4-OCF₃ |
| Ia.312 | CF₃ | H | 2-CN | 3-methyl | 4-OCF₃ |
| Ia.313 | CF₃ | H | 2-CN | 3-CF₃ | 4-OCF₃ |
| Ia.314 | CF₃ | H | 2-CN | 3-OCH₃ | 4-OCF₃ |
| Ia.315 | CF₃ | H | 2-CN | 3-OCF₃ | 4-OCF₃ |
| Ia.316 | CF₃ | H | 2-methyl | 3-fluoro | 4-OCF₃ |
| Ia.317 | CF₃ | H | 2-methyl | 3-chloro | 4-OCF₃ |
| Ia.318 | CF₃ | H | 2-methyl | 3-CN | 4-OCF₃ |
| Ia.319 | CF₃ | H | 2-methyl | 3-methyl | 4-OCF₃ |
| Ia.320 | CF₃ | H | 2-methyl | 3-CF₃ | 4-OCF₃ |
| Ia.321 | CF₃ | H | 2-methyl | 3-OCH₃ | 4-OCF₃ |
| Ia.322 | CF₃ | H | 2-methyl | 3-OCF₃ | 4-OCF₃ |
| Ia.323 | CF₃ | H | 2-CF₃ | 3-fluoro | 4-OCF₃ |
| Ia.324 | CF₃ | H | 2-CF₃ | 3-chloro | 4-OCF₃ |
| Ia.325 | CF₃ | H | 2-CF₃ | 3-CN | 4-OCF₃ |
| Ia.326 | CF₃ | H | 2-CF₃ | 3-methyl | 4-OCF₃ |
| Ia.327 | CF₃ | H | 2-CF₃ | 3-CF₃ | 4-OCF₃ |
| Ia.328 | CF₃ | H | 2-CF₃ | 3-OCH₃ | 4-OCF₃ |
| Ia.329 | CF₃ | H | 2-CF₃ | 3-OCF₃ | 4-OCF₃ |
| Ia.330 | CF₃ | H | 2-OCH₃ | 3-fluoro | 4-OCF₃ |
| Ia.331 | CF₃ | H | 2-OCH₃ | 3-chloro | 4-OCF₃ |
| Ia.332 | CF₃ | H | 2-OCH₃ | 3-CN | 4-OCF₃ |
| Ia.333 | CF₃ | H | 2-OCH₃ | 3-methyl | 4-OCF₃ |
| Ia.334 | CF₃ | H | 2-OCH₃ | 3-CF₃ | 4-OCF₃ |
| Ia.335 | CF₃ | H | 2-OCH₃ | 3-OCH₃ | 4-OCF₃ |
| Ia.336 | CF₃ | H | 2-OCH₃ | 3-OCF₃ | 4-OCF₃ |
| Ia.337 | CF₃ | H | 2-OCF₃ | 3-fluoro | 4-OCF₃ |
| Ia.338 | CF₃ | H | 2-OCF₃ | 3-chloro | 4-OCF₃ |
| Ia.339 | CF₃ | H | 2-OCF₃ | 3-CN | 4-OCF₃ |
| Ia.340 | CF₃ | H | 2-OCF₃ | 3-methyl | 4-OCF₃ |
| Ia.341 | CF₃ | H | 2-OCF₃ | 3-CF₃ | 4-OCF₃ |
| Ia.342 | CF₃ | H | 2-OCF₃ | 3-OCH₃ | 4-OCF₃ |
| Ia.343 | CF₃ | H | 2-OCF₃ | 3-OCF₃ | 4-OCF₃ |
| Ia.344 | CF₃ | H | 3-fluoro | 4-fluoro | 5-fluoro |
| Ia.345 | CF₃ | H | 3-chloro | 4-fluoro | 5-fluoro |
| Ia.346 | CF₃ | H | 3-CN | 4-fluoro | 5-fluoro |
| Ia.347 | CF₃ | H | 3-CH₃ | 4-fluoro | 5-fluoro |
| Ia.348 | CF₃ | H | 3-CF₃ | 4-fluoro | 5-fluoro |
| Ia.349 | CF₃ | H | 3-OCH₃ | 4-fluoro | 5-fluoro |
| Ia.350 | CF₃ | H | 3-OCF₃ | 4-fluoro | 5-fluoro |
| Ia.351 | CF₃ | H | 3-fluoro | 4-fluoro | 5-chloro |
| Ia.352 | CF₃ | H | 3-chloro | 4-fluoro | 5-chloro |
| Ia.353 | CF₃ | H | 3-CN | 4-fluoro | 5-chloro |
| Ia.354 | CF₃ | H | 3-CH₃ | 4-fluoro | 5-chloro |
| Ia.355 | CF₃ | H | 3-CF₃ | 4-fluoro | 5-chloro |
| Ia.356 | CF₃ | H | 3-OCH₃ | 4-fluoro | 5-chloro |
| Ia.357 | CF₃ | H | 3-OCF₃ | 4-fluoro | 5-chloro |
| Ia.358 | CF₃ | H | 3-fluoro | 4-fluoro | 5-CN |
| Ia.359 | CF₃ | H | 3-chloro | 4-fluoro | 5-CN |
| Ia.360 | CF₃ | H | 3-CN | 4-fluoro | 5-CN |
| Ia.361 | CF₃ | H | 3-CH₃ | 4-fluoro | 5-CN |
| Ia.362 | CF₃ | H | 3-CF₃ | 4-fluoro | 5-CN |
| Ia.363 | CF₃ | H | 3-OCH₃ | 4-fluoro | 5-CN |
| Ia.364 | CF₃ | H | 3-OCF₃ | 4-fluoro | 5-CN |
| Ia.365 | CF₃ | H | 3-fluoro | 4-fluoro | 5-CH₃ |
| Ia.366 | CF₃ | H | 3-chloro | 4-fluoro | 5-CH₃ |
| Ia.367 | CF₃ | H | 3-CN | 4-fluoro | 5-CH₃ |
| Ia.368 | CF₃ | H | 3-CH₃ | 4-fluoro | 5-CH₃ |
| Ia.369 | CF₃ | H | 3-CF₃ | 4-fluoro | 5-CH₃ |
| Ia.370 | CF₃ | H | 3-OCH₃ | 4-fluoro | 5-CH₃ |
| Ia.371 | CF₃ | H | 3-OCF₃ | 4-fluoro | 5-CH₃ |
| Ia.372 | CF₃ | H | 3-fluoro | 4-fluoro | 5-CF₃ |
| Ia.373 | CF₃ | H | 3-chloro | 4-fluoro | 5-CF₃ |
| Ia.374 | CF₃ | H | 3-CN | 4-fluoro | 5-CF₃ |
| Ia.375 | CF₃ | H | 3-CH₃ | 4-fluoro | 5-CF₃ |
| Ia.376 | CF₃ | H | 3-CF₃ | 4-fluoro | 5-CF₃ |
| Ia.377 | CF₃ | H | 3-OCH₃ | 4-fluoro | 5-CF₃ |
| Ia.378 | CF₃ | H | 3-OCF₃ | 4-fluoro | 5-CF₃ |
| Ia.379 | CF₃ | H | 3-fluoro | 4-fluoro | 5-OCH₃ |
| Ia.380 | CF₃ | H | 3-chloro | 4-fluoro | 5-OCH₃ |
| Ia.381 | CF₃ | H | 3-CN | 4-fluoro | 5-OCH₃ |
| Ia.382 | CF₃ | H | 3-CH₃ | 4-fluoro | 5-OCH₃ |
| Ia.383 | CF₃ | H | 3-CF₃ | 4-fluoro | 5-OCH₃ |
| Ia.384 | CF₃ | H | 3-OCH₃ | 4-fluoro | 5-OCH₃ |
| Ia.385 | CF₃ | H | 3-OCF₃ | 4-fluoro | 5-OCH₃ |
| Ia.386 | CF₃ | H | 3-fluoro | 4-fluoro | 5-OCF₃ |
| Ia.387 | CF₃ | H | 3-chloro | 4-fluoro | 5-OCF₃ |
| Ia.388 | CF₃ | H | 3-CN | 4-fluoro | 5-OCF₃ |
| Ia.389 | CF₃ | H | 3-CH₃ | 4-fluoro | 5-OCF₃ |
| Ia.390 | CF₃ | H | 3-CF₃ | 4-fluoro | 5-OCF₃ |
| Ia.391 | CF₃ | H | 3-OCH₃ | 4-fluoro | 5-OCF₃ |
| Ia.392 | CF₃ | H | 3-OCF₃ | 4-fluoro | 5-OCF₃ |
| Ia.393 | CF₃ | H | 3-fluoro | 4-chloro | 5-fluoro |
| Ia.394 | CF₃ | H | 3-chloro | 4-chloro | 5-fluoro |
| Ia.395 | CF₃ | H | 3-CN | 4-chloro | 5-fluoro |
| Ia.396 | CF₃ | H | 3-CH₃ | 4-chloro | 5-fluoro |
| Ia.397 | CF₃ | H | 3-CF₃ | 4-chloro | 5-fluoro |
| Ia.398 | CF₃ | H | 3-OCH₃ | 4-chloro | 5-fluoro |
| Ia.399 | CF₃ | H | 3-OCF₃ | 4-chloro | 5-fluoro |
| Ia.400 | CF₃ | H | 3-fluoro | 4-chloro | 5-chloro |
| Ia.401 | CF₃ | H | 3-chloro | 4-chloro | 5-chloro |
| Ia.402 | CF₃ | H | 3-CN | 4-chloro | 5-chloro |
| Ia.403 | CF₃ | H | 3-CH₃ | 4-chloro | 5-chloro |
| Ia.404 | CF₃ | H | 3-CF₃ | 4-chloro | 5-chloro |
| Ia.405 | CF₃ | H | 3-OCH₃ | 4-chloro | 5-chloro |
| Ia.406 | CF₃ | H | 3-OCF₃ | 4-chloro | 5-chloro |
| Ia.407 | CF₃ | H | 3-fluoro | 4-chloro | 5-CN |
| Ia.408 | CF₃ | H | 3-chloro | 4-chloro | 5-CN |
| Ia.409 | CF₃ | H | 3-CN | 4-chloro | 5-CN |
| Ia.410 | CF₃ | H | 3-CH₃ | 4-chloro | 5-CN |
| Ia.411 | CF₃ | H | 3-CF₃ | 4-chloro | 5-CN |
| Ia.412 | CF₃ | H | 3-OCH₃ | 4-chloro | 5-CN |
| Ia.413 | CF₃ | H | 3-OCF₃ | 4-chloro | 5-CN |
| Ia.414 | CF₃ | H | 3-fluoro | 4-chloro | 5-CH₃ |
| Ia.415 | CF₃ | H | 3-chloro | 4-chloro | 5-CH₃ |
| Ia.416 | CF₃ | H | 3-CN | 4-chloro | 5-CH₃ |
| Ia.417 | CF₃ | H | 3-CH₃ | 4-chloro | 5-CH₃ |
| Ia.418 | CF₃ | H | 3-CF₃ | 4-chloro | 5-CH₃ |
| Ia.419 | CF₃ | H | 3-OCH₃ | 4-chloro | 5-CH₃ |
| Ia.420 | CF₃ | H | 3-OCF₃ | 4-chloro | 5-CH₃ |
| Ia.421 | CF₃ | H | 3-fluoro | 4-chloro | 5-CF₃ |
| Ia.422 | CF₃ | H | 3-chloro | 4-chloro | 5-CF₃ |
| Ia.423 | CF₃ | H | 3-CN | 4-chloro | 5-CF₃ |
| Ia.424 | CF₃ | H | 3-CH₃ | 4-chloro | 5-CF₃ |
| Ia.425 | CF₃ | H | 3-CF₃ | 4-chloro | 5-CF₃ |
| Ia.426 | CF₃ | H | 3-OCH₃ | 4-chloro | 5-CF₃ |
| Ia.427 | CF₃ | H | 3-OCF₃ | 4-chloro | 5-CF₃ |
| Ia.428 | CF₃ | H | 3-fluoro | 4-chloro | 5-OCH₃ |
| Ia.429 | CF₃ | H | 3-chloro | 4-chloro | 5-OCH₃ |
| Ia.430 | CF₃ | H | 3-CN | 4-chloro | 5-OCH₃ |
| Ia.431 | CF₃ | H | 3-CH₃ | 4-chloro | 5-OCH₃ |
| Ia.432 | CF₃ | H | 3-CF₃ | 4-chloro | 5-OCH₃ |
| Ia.433 | CF₃ | H | 3-OCH₃ | 4-chloro | 5-OCH₃ |
| Ia.434 | CF₃ | H | 3-OCF₃ | 4-chloro | 5-OCH₃ |
| Ia.435 | CF₃ | H | 3-fluoro | 4-chloro | 5-OCF₃ |
| Ia.436 | CF₃ | H | 3-chloro | 4-chloro | 5-OCF₃ |
| Ia.437 | CF₃ | H | 3-CN | 4-chloro | 5-OCF₃ |
| Ia.438 | CF₃ | H | 3-CH₃ | 4-chloro | 5-OCF₃ |
| Ia.439 | CF₃ | H | 3-CF₃ | 4-chloro | 5-OCF₃ |
| Ia.440 | CF₃ | H | 3-OCH₃ | 4-chloro | 5-OCF₃ |
| Ia.441 | CF₃ | H | 3-OCF₃ | 4-chloro | 5-OCF₃ |
| Ia.442 | CF₃ | H | 3-fluoro | 4-CN | 5-fluoro |
| Ia.443 | CF₃ | H | 3-chloro | 4-CN | 5-fluoro |
| Ia.444 | CF₃ | H | 3-CN | 4-CN | 5-fluoro |
| Ia.445 | CF₃ | H | 3-CH₃ | 4-CN | 5-fluoro |
| Ia.446 | CF₃ | H | 3-CF₃ | 4-CN | 5-fluoro |
| Ia.447 | CF₃ | H | 3-OCH₃ | 4-CN | 5-fluoro |
| Ia.448 | CF₃ | H | 3-OCF₃ | 4-CN | 5-fluoro |
| Ia.449 | CF₃ | H | 3-fluoro | 4-CN | 5-chloro |
| Ia.450 | CF₃ | H | 3-chloro | 4-CN | 5-chloro |
| Ia.451 | CF₃ | H | 3-CN | 4-CN | 5-chloro |
| Ia.452 | CF₃ | H | 3-CH₃ | 4-CN | 5-chloro |
| Ia.453 | CF₃ | H | 3-CF₃ | 4-CN | 5-chloro |
| Ia.454 | CF₃ | H | 3-OCH₃ | 4-CN | 5-chloro |
| Ia.455 | CF₃ | H | 3-OCF₃ | 4-CN | 5-chloro |
| Ia.456 | CF₃ | H | 3-fluoro | 4-CN | 5-CN |
| Ia.457 | CF₃ | H | 3-chloro | 4-CN | 5-CN |
| Ia.458 | CF₃ | H | 3-CN | 4-CN | 5-CN |
| Ia.459 | CF₃ | H | 3-CH₃ | 4-CN | 5-CN |
| Ia.460 | CF₃ | H | 3-CF₃ | 4-CN | 5-CN |
| Ia.461 | CF₃ | H | 3-OCH₃ | 4-CN | 5-CN |
| Ia.462 | CF₃ | H | 3-OCF₃ | 4-CN | 5-CN |
| Ia.463 | CF₃ | H | 3-fluoro | 4-CN | 5-CH₃ |
| Ia.464 | CF₃ | H | 3-chloro | 4-CN | 5-CH₃ |
| Ia.465 | CF₃ | H | 3-CN | 4-CN | 5-CH₃ |
| Ia.466 | CF₃ | H | 3-CH₃ | 4-CN | 5-CH₃ |
| Ia.467 | CF₃ | H | 3-CF₃ | 4-CN | 5-CH₃ |
| Ia.468 | CF₃ | H | 3-OCH₃ | 4-CN | 5-CH₃ |
| Ia.469 | CF₃ | H | 3-OCF₃ | 4-CN | 5-CH₃ |
| Ia.470 | CF₃ | H | 3-fluoro | 4-CN | 5-CF₃ |
| Ia.471 | CF₃ | H | 3-chloro | 4-CN | 5-CF₃ |
| Ia.472 | CF₃ | H | 3-CN | 4-CN | 5-CF₃ |
| Ia.473 | CF₃ | H | 3-CH₃ | 4-CN | 5-CF₃ |
| Ia.474 | CF₃ | H | 3-CF₃ | 4-CN | 5-CF₃ |
| Ia.475 | CF₃ | H | 3-OCH₃ | 4-CN | 5-CF₃ |
| Ia.476 | CF₃ | H | 3-OCF₃ | 4-CN | 5-CF₃ |
| Ia.477 | CF₃ | H | 3-fluoro | 4-CN | 5-OCH₃ |
| Ia.478 | CF₃ | H | 3-chloro | 4-CN | 5-OCH₃ |
| Ia.479 | CF₃ | H | 3-CN | 4-CN | 5-OCH₃ |
| Ia.480 | CF₃ | H | 3-CH₃ | 4-CN | 5-OCH₃ |
| Ia.481 | CF₃ | H | 3-CF₃ | 4-CN | 5-OCH₃ |
| Ia.482 | CF₃ | H | 3-OCH₃ | 4-CN | 5-OCH₃ |
| Ia.483 | CF₃ | H | 3-OCF₃ | 4-CN | 5-OCH₃ |
| Ia.484 | CF₃ | H | 3-fluoro | 4-CN | 5-OCF₃ |
| Ia.485 | CF₃ | H | 3-chloro | 4-CN | 5-OCF₃ |
| Ia.486 | CF₃ | H | 3-CN | 4-CN | 5-OCF₃ |
| Ia.487 | CF₃ | H | 3-CH₃ | 4-CN | 5-OCF₃ |
| Ia.488 | CF₃ | H | 3-CF₃ | 4-CN | 5-OCF₃ |
| Ia.489 | CF₃ | H | 3-OCH₃ | 4-CN | 5-OCF₃ |
| Ia.490 | CF₃ | H | 3-OCF₃ | 4-CN | 5-OCF₃ |
| Ia.491 | CF₃ | H | 3-fluoro | 4-CH₃ | 5-fluoro |
| Ia.492 | CF₃ | H | 3-chloro | 4-CH₃ | 5-fluoro |
| Ia.493 | CF₃ | H | 3-CN | 4-CH₃ | 5-fluoro |
| Ia.494 | CF₃ | H | 3-CH₃ | 4-CH₃ | 5-fluoro |
| Ia.495 | CF₃ | H | 3-CF₃ | 4-CH₃ | 5-fluoro |
| Ia.496 | CF₃ | H | 3-OCH₃ | 4-CH₃ | 5-fluoro |
| Ia.497 | CF₃ | H | 3-OCF₃ | 4-CH₃ | 5-fluoro |
| Ia.498 | CF₃ | H | 3-fluoro | 4-CH₃ | 5-chloro |
| Ia.499 | CF₃ | H | 3-chloro | 4-CH₃ | 5-chloro |
| Ia.500 | CF₃ | H | 3-CN | 4-CH₃ | 5-chloro |
| Ia.501 | CF₃ | H | 3-CH₃ | 4-CH₃ | 5-chloro |
| Ia.502 | CF₃ | H | 3-CF₃ | 4-CH₃ | 5-chloro |
| Ia.503 | CF₃ | H | 3-OCH₃ | 4-CH₃ | 5-chloro |
| Ia.504 | CF₃ | H | 3-OCF₃ | 4-CH₃ | 5-chloro |
| Ia.505 | CF₃ | H | 3-fluoro | 4-CH₃ | 5-CN |
| Ia.506 | CF₃ | H | 3-chloro | 4-CH₃ | 5-CN |
| Ia.507 | CF₃ | H | 3-CN | 4-CH₃ | 5-CN |
| Ia.508 | CF₃ | H | 3-CH₃ | 4-CH₃ | 5-CN |
| Ia.509 | CF₃ | H | 3-CF₃ | 4-CH₃ | 5-CN |
| Ia.510 | CF₃ | H | 3-OCH₃ | 4-CH₃ | 5-CN |
| Ia.511 | CF₃ | H | 3-OCF₃ | 4-CH₃ | 5-CN |
| Ia.512 | CF₃ | H | 3-fluoro | 4-CH₃ | 5-CH₃ |
| Ia.513 | CF₃ | H | 3-chloro | 4-CH₃ | 5-CH₃ |
| Ia.514 | CF₃ | H | 3-CN | 4-CH₃ | 5-CH₃ |
| Ia.515 | CF₃ | H | 3-CH₃ | 4-CH₃ | 5-CH₃ |
| Ia.516 | CF₃ | H | 3-CF₃ | 4-CH₃ | 5-CH₃ |
| Ia.517 | CF₃ | H | 3-OCH₃ | 4-CH₃ | 5-CH₃ |
| Ia.518 | CF₃ | H | 3-OCF₃ | 4-CH₃ | 5-CH₃ |
| Ia.519 | CF₃ | H | 3-fluoro | 4-CH₃ | 5-CF₃ |
| Ia.520 | CF₃ | H | 3-chloro | 4-CH₃ | 5-CF₃ |
| Ia.521 | CF₃ | H | 3-CN | 4-CH₃ | 5-CF₃ |
| Ia.522 | CF₃ | H | 3-CH₃ | 4-CH₃ | 5-CF₃ |
| Ia.523 | CF₃ | H | 3-CF₃ | 4-CH₃ | 5-CF₃ |
| Ia.524 | CF₃ | H | 3-OCH₃ | 4-CH₃ | 5-CF₃ |
| Ia.525 | CF₃ | H | 3-OCF₃ | 4-CH₃ | 5-CF₃ |
| Ia.526 | CF₃ | H | 3-fluoro | 4-CH₃ | 5-OCH₃ |
| Ia.527 | CF₃ | H | 3-chloro | 4-CH₃ | 5-OCH₃ |
| Ia.528 | CF₃ | H | 3-CN | 4-CH₃ | 5-OCH₃ |
| Ia.529 | CF₃ | H | 3-CH₃ | 4-CH₃ | 5-OCH₃ |
| Ia.530 | CF₃ | H | 3-CF₃ | 4-CH₃ | 5-OCH₃ |
| Ia.531 | CF₃ | H | 3-OCH₃ | 4-CH₃ | 5-OCH₃ |
| Ia.532 | CF₃ | H | 3-OCF₃ | 4-CH₃ | 5-OCH₃ |
| Ia.533 | CF₃ | H | 3-fluoro | 4-CH₃ | 5-OCF₃ |
| Ia.534 | CF₃ | H | 3-chloro | 4-CH₃ | 5-OCF₃ |
| Ia.535 | CF₃ | H | 3-CN | 4-CH₃ | 5-OCF₃ |
| Ia.536 | CF₃ | H | 3-CH₃ | 4-CH₃ | 5-OCF₃ |
| Ia.537 | CF₃ | H | 3-CF₃ | 4-CH₃ | 5-OCF₃ |
| Ia.538 | CF₃ | H | 3-OCH₃ | 4-CH₃ | 5-OCF₃ |
| Ia.539 | CF₃ | H | 3-OCF₃ | 4-CH₃ | 5-OCF₃ |
| Ia.540 | CF₃ | H | 3-fluoro | 4-CF₃ | 5-fluoro |
| Ia.541 | CF₃ | H | 3-chloro | 4-CF₃ | 5-fluoro |
| Ia.542 | CF₃ | H | 3-CN | 4-CF₃ | 5-fluoro |
| Ia.543 | CF₃ | H | 3-CH₃ | 4-CF₃ | 5-fluoro |
| Ia.544 | CF₃ | H | 3-CF₃ | 4-CF₃ | 5-fluoro |
| Ia.545 | CF₃ | H | 3-OCH₃ | 4-CF₃ | 5-fluoro |
| Ia.546 | CF₃ | H | 3-OCF₃ | 4-CF₃ | 5-fluoro |
| Ia.547 | CF₃ | H | 3-fluoro | 4-CF₃ | 5-chloro |
| Ia.548 | CF₃ | H | 3-chloro | 4-CF₃ | 5-chloro |
| Ia.549 | CF₃ | H | 3-CN | 4-CF₃ | 5-chloro |
| Ia.550 | CF₃ | H | 3-CH₃ | 4-CF₃ | 5-chloro |
| Ia.551 | CF₃ | H | 3-CF₃ | 4-CF₃ | 5-chloro |
| Ia.552 | CF₃ | H | 3-OCH₃ | 4-CF₃ | 5-chloro |
| Ia.553 | CF₃ | H | 3-OCF₃ | 4-CF₃ | 5-chloro |
| Ia.554 | CF₃ | H | 3-fluoro | 4-CF₃ | 5-CN |
| Ia.555 | CF₃ | H | 3-chloro | 4-CF₃ | 5-CN |
| Ia.556 | CF₃ | H | 3-CN | 4-CF₃ | 5-CN |
| Ia.557 | CF₃ | H | 3-CH₃ | 4-CF₃ | 5-CN |
| Ia.558 | CF₃ | H | 3-CF₃ | 4-CF₃ | 5-CN |
| Ia.559 | CF₃ | H | 3-OCH₃ | 4-CF₃ | 5-CN |
| Ia.560 | CF₃ | H | 3-OCF₃ | 4-CF₃ | 5-CN |
| Ia.561 | CF₃ | H | 3-fluoro | 4-CF₃ | 5-CH₃ |
| Ia.562 | CF₃ | H | 3-chloro | 4-CF₃ | 5-CH₃ |
| Ia.563 | CF₃ | H | 3-CN | 4-CF₃ | 5-CH₃ |
| Ia.564 | CF₃ | H | 3-CH₃ | 4-CF₃ | 5-CH₃ |
| Ia.565 | CF₃ | H | 3-CF₃ | 4-CF₃ | 5-CH₃ |
| Ia.566 | CF₃ | H | 3-OCH₃ | 4-CF₃ | 5-CH₃ |
| Ia.567 | CF₃ | H | 3-OCF₃ | 4-CF₃ | 5-CH₃ |
| Ia.568 | CF₃ | H | 3-fluoro | 4-CF₃ | 5-CF₃ |
| Ia.569 | CF₃ | H | 3-chloro | 4-CF₃ | 5-CF₃ |
| Ia.570 | CF₃ | H | 3-CN | 4-CF₃ | 5-CF₃ |
| Ia.571 | CF₃ | H | 3-CH₃ | 4-CF₃ | 5-CF₃ |
| Ia.572 | CF₃ | H | 3-CF₃ | 4-CF₃ | 5-CF₃ |
| Ia.573 | CF₃ | H | 3-OCH₃ | 4-CF₃ | 5-CF₃ |
| Ia.574 | CF₃ | H | 3-OCF₃ | 4-CF₃ | 5-CF₃ |
| Ia.575 | CF₃ | H | 3-fluoro | 4-CF₃ | 5-OCH₃ |
| Ia.576 | CF₃ | H | 3-chloro | 4-CF₃ | 5-OCH₃ |
| Ia.577 | CF₃ | H | 3-CN | 4-CF₃ | 5-OCH₃ |
| Ia.578 | CF₃ | H | 3-CH₃ | 4-CF₃ | 5-OCH₃ |
| Ia.579 | CF₃ | H | 3-CF₃ | 4-CF₃ | 5-OCH₃ |
| Ia.560 | CF₃ | H | 3-OCH₃ | 4-CF₃ | 5-OCH₃ |
| Ia.561 | CF₃ | H | 3-OCF₃ | 4-CF₃ | 5-OCH₃ |
| Ia.562 | CF₃ | H | 3-fluoro | 4-CF₃ | 5-OCF₃ |
| Ia.563 | CF₃ | H | 3-chloro | 4-CF₃ | 5-OCF₃ |
| Ia.564 | CF₃ | H | 3-CN | 4-CF₃ | 5-OCF₃ |
| Ia.565 | CF₃ | H | 3-CH₃ | 4-CF₃ | 5-OCF₃ |
| Ia.566 | CF₃ | H | 3-CF₃ | 4-CF₃ | 5-OCF₃ |
| Ia.567 | CF₃ | H | 3-OCH₃ | 4-CF₃ | 5-OCF₃ |
| Ia.568 | CF₃ | H | 3-OCF₃ | 4-CF₃ | 5-OCF₃ |
| Ia.569 | CF₃ | H | 3-fluoro | 4-OCH₃ | 5-fluoro |
| Ia.570 | CF₃ | H | 3-chloro | 4-OCH₃ | 5-fluoro |
| Ia.571 | CF₃ | H | 3-CN | 4-OCH₃ | 5-fluoro |
| Ia.572 | CF₃ | H | 3-CH₃ | 4-OCH₃ | 5-fluoro |
| Ia.573 | CF₃ | H | 3-CF₃ | 4-OCH₃ | 5-fluoro |
| Ia.574 | CF₃ | H | 3-OCH₃ | 4-OCH₃ | 5-fluoro |
| Ia.575 | CF₃ | H | 3-OCF₃ | 4-OCH₃ | 5-fluoro |
| Ia.576 | CF₃ | H | 3-fluoro | 4-OCH₃ | 5-chloro |
| Ia.577 | CF₃ | H | 3-chloro | 4-OCH₃ | 5-chloro |
| Ia.578 | CF₃ | H | 3-CN | 4-OCH₃ | 5-chloro |
| Ia.579 | CF₃ | H | 3-CH₃ | 4-OCH₃ | 5-chloro |
| Ia.580 | CF₃ | H | 3-CF₃ | 4-OCH₃ | 5-chloro |
| Ia.581 | CF₃ | H | 3-OCH₃ | 4-OCH₃ | 5-chloro |
| Ia.582 | CF₃ | H | 3-OCF₃ | 4-OCH₃ | 5-chloro |
| Ia.583 | CF₃ | H | 3-fluoro | 4-OCH₃ | 5-CN |
| Ia.584 | CF₃ | H | 3-chloro | 4-OCH₃ | 5-CN |
| Ia.585 | CF₃ | H | 3-CN | 4-OCH₃ | 5-CN |
| Ia.586 | CF₃ | H | 3-CH₃ | 4-OCH₃ | 5-CN |
| Ia.587 | CF₃ | H | 3-CF₃ | 4-OCH₃ | 5-CN |
| Ia.588 | CF₃ | H | 3-OCH₃ | 4-OCH₃ | 5-CN |
| Ia.589 | CF₃ | H | 3-OCF₃ | 4-OCH₃ | 5-CN |
| Ia.590 | CF₃ | H | 3-fluoro | 4-OCH₃ | 5-CH₃ |
| Ia.591 | CF₃ | H | 3-chloro | 4-OCH₃ | 5-CH₃ |
| Ia.592 | CF₃ | H | 3-CN | 4-OCH₃ | 5-CH₃ |
| Ia.593 | CF₃ | H | 3-CH₃ | 4-OCH₃ | 5-CH₃ |
| Ia.594 | CF₃ | H | 3-CF₃ | 4-OCH₃ | 5-CH₃ |
| Ia.595 | CF₃ | H | 3-OCH₃ | 4-OCH₃ | 5-CH₃ |
| Ia.596 | CF₃ | H | 3-OCF₃ | 4-OCH₃ | 5-CH₃ |
| Ia.597 | CF₃ | H | 3-fluoro | 4-OCH₃ | 5-CF₃ |
| Ia.598 | CF₃ | H | 3-chloro | 4-OCH₃ | 5-CF₃ |
| Ia.599 | CF₃ | H | 3-CN | 4-OCH₃ | 5-CF₃ |
| Ia.600 | CF₃ | H | 3-CH₃ | 4-OCH₃ | 5-CF₃ |
| Ia.601 | CF₃ | H | 3-CF₃ | 4-OCH₃ | 5-CF₃ |
| Ia.602 | CF₃ | H | 3-OCH₃ | 4-OCH₃ | 5-CF₃ |
| Ia.603 | CF₃ | H | 3-OCF₃ | 4-OCH₃ | 5-CF₃ |
| Ia.604 | CF₃ | H | 3-fluoro | 4-OCH₃ | 5-OCH₃ |
| Ia.605 | CF₃ | H | 3-chloro | 4-OCH₃ | 5-OCH₃ |
| Ia.606 | CF₃ | H | 3-CN | 4-OCH₃ | 5-OCH₃ |
| Ia.607 | CF₃ | H | 3-CH₃ | 4-OCH₃ | 5-OCH₃ |
| Ia.608 | CF₃ | H | 3-CF₃ | 4-OCH₃ | 5-OCH₃ |
| Ia.609 | CF₃ | H | 3-OCH₃ | 4-OCH₃ | 5-OCH₃ |
| Ia.610 | CF₃ | H | 3-OCF₃ | 4-OCH₃ | 5-OCH₃ |
| Ia.611 | CF₃ | H | 3-fluoro | 4-OCH₃ | 5-OCF₃ |
| Ia.612 | CF₃ | H | 3-chloro | 4-OCH₃ | 5-OCF₃ |
| Ia.613 | CF₃ | H | 3-CN | 4-OCH₃ | 5-OCF₃ |
| Ia.614 | CF₃ | H | 3-CH₃ | 4-OCH₃ | 5-OCF₃ |
| Ia.615 | CF₃ | H | 3-CF₃ | 4-OCH₃ | 5-OCF₃ |
| Ia.616 | CF₃ | H | 3-OCH₃ | 4-OCH₃ | 5-OCF₃ |
| Ia.617 | CF₃ | H | 3-OCF₃ | 4-OCH₃ | 5-OCF₃ |
| Ia.618 | CF₃ | H | 3-fluoro | 4-OCF₃ | 5-fluoro |
| Ia.619 | CF₃ | H | 3-chloro | 4-OCF₃ | 5-fluoro |
| Ia.620 | CF₃ | H | 3-CN | 4-OCF₃ | 5-fluoro |
| Ia.621 | CF₃ | H | 3-CH₃ | 4-OCF₃ | 5-fluoro |
| Ia.622 | CF₃ | H | 3-CF₃ | 4-OCF₃ | 5-fluoro |
| Ia.623 | CF₃ | H | 3-OCH₃ | 4-OCF₃ | 5-fluoro |
| Ia.624 | CF₃ | H | 3-OCF₃ | 4-OCF₃ | 5-fluoro |
| Ia.625 | CF₃ | H | 3-fluoro | 4-OCF₃ | 5-chloro |
| Ia.626 | CF₃ | H | 3-chloro | 4-OCF₃ | 5-chloro |
| Ia.627 | CF₃ | H | 3-CN | 4-OCF₃ | 5-chloro |
| Ia.628 | CF₃ | H | 3-CH₃ | 4-OCF₃ | 5-chloro |
| Ia.629 | CF₃ | H | 3-CF₃ | 4-OCF₃ | 5-chloro |
| Ia.630 | CF₃ | H | 3-OCH₃ | 4-OCF₃ | 5-chloro |
| Ia.631 | CF₃ | H | 3-OCF₃ | 4-OCF₃ | 5-chloro |
| Ia.632 | CF₃ | H | 3-fluoro | 4-OCF₃ | 5-CN |
| Ia.633 | CF₃ | H | 3-chloro | 4-OCF₃ | 5-CN |
| Ia.634 | CF₃ | H | 3-CN | 4-OCF₃ | 5-CN |
| Ia.635 | CF₃ | H | 3-CH₃ | 4-OCF₃ | 5-CN |
| Ia.636 | CF₃ | H | 3-CF₃ | 4-OCF₃ | 5-CN |
| Ia.637 | CF₃ | H | 3-OCH₃ | 4-OCF₃ | 5-CN |
| Ia.638 | CF₃ | H | 3-OCF₃ | 4-OCF₃ | 5-CN |
| Ia.639 | CF₃ | H | 3-fluoro | 4-OCF₃ | 5-CH₃ |
| Ia.640 | CF₃ | H | 3-chloro | 4-OCF₃ | 5-CH₃ |
| Ia.641 | CF₃ | H | 3-CN | 4-OCF₃ | 5-CH₃ |
| Ia.642 | CF₃ | H | 3-CH₃ | 4-OCF₃ | 5-CH₃ |
| Ia.643 | CF₃ | H | 3-CF3 | 4-OCF₃ | 5-CH₃ |
| Ia.644 | CF₃ | H | 3-OCH₃ | 4-OCF₃ | 5-CH₃ |
| Ia.645 | CF₃ | H | 3-OCF₃ | 4-OCF₃ | 5-CH₃ |
| Ia.646 | CF₃ | H | 3-fluoro | 4-OCF₃ | 5-CF₃ |
| Ia.647 | CF₃ | H | 3-chloro | 4-OCF₃ | 5-CF₃ |
| Ia.648 | CF₃ | H | 3-CN | 4-OCF₃ | 5-CF₃ |
| Ia.649 | CF₃ | H | 3-CH₃ | 4-OCF₃ | 5-CF₃ |
| Ia.650 | CF₃ | H | 3-CF₃ | 4-OCF₃ | 5-CF₃ |
| Ia.651 | CF₃ | H | 3-OCH₃ | 4-OCF₃ | 5-CF₃ |
| Ia.652 | CF₃ | H | 3-OCF₃ | 4-OCF₃ | 5-CF₃ |
| Ia.653 | CF₃ | H | 3-fluoro | 4-OCF₃ | 5-OCH₃ |
| Ia.654 | CF₃ | H | 3-chloro | 4-OCF₃ | 5-OCH₃ |
| Ia.655 | CF₃ | H | 3-CN | 4-OCF₃ | 5-OCH₃ |
| Ia.656 | CF₃ | H | 3-CH₃ | 4-OCF₃ | 5-OCH₃ |
| Ia.657 | CF₃ | H | 3-CF₃ | 4-OCF₃ | 5-OCH₃ |
| Ia.658 | CF₃ | H | 3-OCH₃ | 4-OCF₃ | 5-OCH₃ |
| Ia.659 | CF₃ | H | 3-OCF₃ | 4-OCF₃ | 5-OCH₃ |
| Ia.660 | CF₃ | H | 3-fluoro | 4-OCF₃ | 5-OCF₃ |
| Ia.661 | CF₃ | H | 3-chloro | 4-OCF₃ | 5-OCF₃ |
| Ia.662 | CF₃ | H | 3-CN | 4-OCF₃ | 5-OCF₃ |
| Ia.663 | CF₃ | H | 3-CH₃ | 4-OCF₃ | 5-OCF₃ |
| Ia.664 | CF₃ | H | 3-CF₃ | 4-OCF₃ | 5-OCF₃ |
| Ia.665 | CF₃ | H | 3-OCH₃ | 4-OCF₃ | 5-OCF₃ |
| Ia.666 | CF₃ | H | 3-OCF₃ | 4-OCF₃ | 5-OCF₃ |
| Ia.667 | CF₃ | H | 2-fluoro | 4-fluoro | 5-fluoro |
| Ia.668 | CF₃ | H | 2-fluoro | 4-fluoro | 5-chloro |
| Ia.669 | CF₃ | H | 2-fluoro | 4-fluoro | 5-CN |
| Ia.670 | CF₃ | H | 2-fluoro | 4-fluoro | 5-CH₃ |
| Ia.671 | CF₃ | H | 2-fluoro | 4-fluoro | 5-CF₃ |
| Ia.672 | CF₃ | H | 2-fluoro | 4-fluoro | 5-OCH₃ |
| Ia.673 | CF₃ | H | 2-fluoro | 4-fluoro | 5-OCF₃ |
| Ia.674 | CF₃ | H | 2-chloro | 4-fluoro | 5-fluoro |
| Ia.675 | CF₃ | H | 2-chloro | 4-fluoro | 5-chloro |
| Ia.676 | CF₃ | H | 2-chloro | 4-fluoro | 5-CN |
| Ia.677 | CF₃ | H | 2-chloro | 4-fluoro | 5-CH₃ |
| Ia.678 | CF₃ | H | 2-chloro | 4-fluoro | 5-CF₃ |
| Ia.679 | CF₃ | H | 2-chloro | 4-fluoro | 5-OCH₃ |
| Ia.680 | CF₃ | H | 2-chloro | 4-fluoro | 5-OCF₃ |
| Ia.681 | CF₃ | H | 2-CN | 4-fluoro | 5-fluoro |
| Ia.682 | CF₃ | H | 2-CN | 4-fluoro | 5-chloro |
| Ia.683 | CF₃ | H | 2-CN | 4-fluoro | 5-CN |
| Ia.684 | CF₃ | H | 2-CN | 4-fluoro | 5-CH₃ |
| Ia.685 | CF₃ | H | 2-CN | 4-fluoro | 5-CF₃ |
| Ia.686 | CF₃ | H | 2-CN | 4-fluoro | 5-OCH₃ |
| Ia.687 | CF₃ | H | 2-CN | 4-fluoro | 5-OCF₃ |
| Ia.688 | CF₃ | H | 2-methyl | 4-fluoro | 5-fluoro |
| Ia.689 | CF₃ | H | 2-methyl | 4-fluoro | 5-chloro |
| Ia.690 | CF₃ | H | 2-methyl | 4-fluoro | 5-CN |
| Ia.691 | CF₃ | H | 2-methyl | 4-fluoro | 5-CH₃ |
| Ia.692 | CF₃ | H | 2-methyl | 4-fluoro | 5-CF₃ |
| Ia.693 | CF₃ | H | 2-methyl | 4-fluoro | 5-OCH₃ |
| Ia.694 | CF₃ | H | 2-methyl | 4-fluoro | 5-OCF₃ |
| Ia.695 | CF₃ | H | 2-CF₃ | 4-fluoro | 5-fluoro |
| Ia.696 | CF₃ | H | 2-CF₃ | 4-fluoro | 5-chloro |
| Ia.697 | CF₃ | H | 2-CF₃ | 4-fluoro | 5-CN |
| Ia.698 | CF₃ | H | 2-CF₃ | 4-fluoro | 5-CH₃ |
| Ia.699 | CF₃ | H | 2-CF₃ | 4-fluoro | 5-CF₃ |
| Ia.700 | CF₃ | H | 2-CF₃ | 4-fluoro | 5-OCH₃ |
| Ia.701 | CF₃ | H | 2-CF₃ | 4-fluoro | 5-OCF₃ |
| Ia.702 | CF₃ | H | 2-OCH₃ | 4-fluoro | 5-fluoro |
| Ia.703 | CF₃ | H | 2-OCH₃ | 4-fluoro | 5-chloro |
| Ia.704 | CF₃ | H | 2-OCH₃ | 4-fluoro | 5-CN |
| Ia.705 | CF₃ | H | 2-OCH₃ | 4-fluoro | 5-CH₃ |
| Ia.706 | CF₃ | H | 2-OCH₃ | 4-fluoro | 5-CF₃ |
| Ia.707 | CF₃ | H | 2-OCH₃ | 4-fluoro | 5-OCH₃ |
| Ia.708 | CF₃ | H | 2-OCH₃ | 4-fluoro | 5-OCF₃ |
| Ia.709 | CF₃ | H | 2-OCF₃ | 4-fluoro | 5-fluoro |
| Ia.710 | CF₃ | H | 2-OCF₃ | 4-fluoro | 5-chloro |
| Ia.711 | CF₃ | H | 2-OCF₃ | 4-fluoro | 5-CN |
| Ia.712 | CF₃ | H | 2-OCF₃ | 4-fluoro | 5-CH₃ |
| Ia.713 | CF₃ | H | 2-OCF₃ | 4-fluoro | 5-CF₃ |
| Ia.714 | CF₃ | H | 2-OCF₃ | 4-fluoro | 5-OCH₃ |
| Ia.715 | CF₃ | H | 2-OCF₃ | 4-fluoro | 5-OCF₃ |
| Ia.716 | CF₃ | H | 2-fluoro | 4-chloro | 5-fluoro |
| Ia.717 | CF₃ | H | 2-fluoro | 4-chloro | 5-chloro |
| Ia.718 | CF₃ | H | 2-fluoro | 4-chloro | 5-CN |
| Ia.719 | CF₃ | H | 2-fluoro | 4-chloro | 5-CH₃ |
| Ia.720 | CF₃ | H | 2-fluoro | 4-chloro | 5-CF₃ |
| Ia.721 | CF₃ | H | 2-fluoro | 4-chloro | 5-OCH₃ |
| Ia.722 | CF₃ | H | 2-fluoro | 4-chloro | 5-OCF₃ |
| Ia.723 | CF₃ | H | 2-chloro | 4-chloro | 5-fluoro |
| Ia.724 | CF₃ | H | 2-chloro | 4-chloro | 5-chloro |
| Ia.725 | CF₃ | H | 2-chloro | 4-chloro | 5-CN |
| Ia.726 | CF₃ | H | 2-chloro | 4-chloro | 5-CH₃ |
| Ia.727 | CF₃ | H | 2-chloro | 4-chloro | 5-CF₃ |
| Ia.728 | CF₃ | H | 2-chloro | 4-chloro | 5-OCH₃ |
| Ia.729 | CF₃ | H | 2-chloro | 4-chloro | 5-OCF₃ |
| Ia.730 | CF₃ | H | 2-CN | 4-chloro | 5-fluoro |
| Ia.731 | CF₃ | H | 2-CN | 4-chloro | 5-chloro |
| Ia.732 | CF₃ | H | 2-CN | 4-chloro | 5-CN |
| Ia.733 | CF₃ | H | 2-CN | 4-chloro | 5-CH₃ |
| Ia.734 | CF₃ | H | 2-CN | 4-chloro | 5-CF₃ |
| Ia.735 | CF₃ | H | 2-CN | 4-chloro | 5-OCH₃ |
| Ia.736 | CF₃ | H | 2-CN | 4-chloro | 5-OCF₃ |
| Ia.737 | CF₃ | H | 2-methyl | 4-chloro | 5-fluoro |
| Ia.738 | CF₃ | H | 2-methyl | 4-chloro | 5-chloro |
| Ia.739 | CF₃ | H | 2-methyl | 4-chloro | 5-CN |
| Ia.740 | CF₃ | H | 2-methyl | 4-chloro | 5-CH₃ |
| Ia.741 | CF₃ | H | 2-methyl | 4-chloro | 5-CF₃ |
| Ia.742 | CF₃ | H | 2-methyl | 4-chloro | 5-OCH₃ |
| Ia.743 | CF₃ | H | 2-methyl | 4-chloro | 5-OCF₃ |
| Ia.744 | CF₃ | H | 2-CF₃ | 4-chloro | 5-fluoro |
| Ia.745 | CF₃ | H | 2-CF₃ | 4-chloro | 5-chloro |
| Ia.746 | CF₃ | H | 2-CF₃ | 4-chloro | 5-CN |
| Ia.747 | CF₃ | H | 2-CF₃ | 4-chloro | 5-CH₃ |
| Ia.748 | CF₃ | H | 2-CF₃ | 4-chloro | 5-CF₃ |
| Ia.749 | CF₃ | H | 2-CF₃ | 4-chloro | 5-OCH₃ |
| Ia.750 | CF₃ | H | 2-CF₃ | 4-chloro | 5-OCF₃ |
| Ia.751 | CF₃ | H | 2-OCH₃ | 4-chloro | 5-fluoro |
| Ia.752 | CF₃ | H | 2-OCH₃ | 4-chloro | 5-chloro |
| Ia.753 | CF₃ | H | 2-OCH₃ | 4-chloro | 5-CN |
| Ia.754 | CF₃ | H | 2-OCH₃ | 4-chloro | 5-CH₃ |
| Ia.755 | CF₃ | H | 2-OCH₃ | 4-chloro | 5-CF₃ |
| Ia.756 | CF₃ | H | 2-OCH₃ | 4-chloro | 5-OCH₃ |
| Ia.757 | CF₃ | H | 2-OCH₃ | 4-chloro | 5-OCF₃ |
| Ia.758 | CF₃ | H | 2-OCF₃ | 4-chloro | 5-fluoro |
| Ia.759 | CF₃ | H | 2-OCF₃ | 4-chloro | 5-chloro |
| Ia.760 | CF₃ | H | 2-OCF₃ | 4-chloro | 5-CN |
| Ia.761 | CF₃ | H | 2-OCF₃ | 4-chloro | 5-CH₃ |
| Ia.762 | CF₃ | H | 2-OCF₃ | 4-chloro | 5-CF₃ |
| Ia.763 | CF₃ | H | 2-OCF₃ | 4-chloro | 5-OCH₃ |
| Ia.764 | CF₃ | H | 2-OCF₃ | 4-chloro | 5-OCF₃ |
| Ia.765 | CF₃ | H | 2-fluoro | 4-CN | 5-fluoro |
| Ia.766 | CF₃ | H | 2-fluoro | 4-CN | 5-chloro |
| Ia.767 | CF₃ | H | 2-fluoro | 4-CN | 5-CN |
| Ia.768 | CF₃ | H | 2-fluoro | 4-CN | 5-CH₃ |
| Ia.769 | CF₃ | H | 2-fluoro | 4-CN | 5-CF₃ |
| Ia.770 | CF₃ | H | 2-fluoro | 4-CN | 5-OCH₃ |
| Ia.771 | CF₃ | H | 2-fluoro | 4-CN | 5-OCF₃ |
| Ia.772 | CF₃ | H | 2-chloro | 4-CN | 5-fluoro |
| Ia.773 | CF₃ | H | 2-chloro | 4-CN | 5-chloro |
| Ia.774 | CF₃ | H | 2-chloro | 4-CN | 5-CN |
| Ia.775 | CF₃ | H | 2-chloro | 4-CN | 5-CH₃ |
| Ia.776 | CF₃ | H | 2-chloro | 4-CN | 5-CF₃ |
| Ia.777 | CF₃ | H | 2-chloro | 4-CN | 5-OCH₃ |
| Ia.778 | CF₃ | H | 2-chloro | 4-CN | 5-OCF₃ |
| Ia.779 | CF₃ | H | 2-CN | 4-CN | 5-fluoro |
| Ia.780 | CF₃ | H | 2-CN | 4-CN | 5-chloro |
| Ia.781 | CF₃ | H | 2-CN | 4-CN | 5-CN |
| Ia.782 | CF₃ | H | 2-CN | 4-CN | 5-CH₃ |
| Ia.783 | CF₃ | H | 2-CN | 4-CN | 5-CF₃ |
| Ia.784 | CF₃ | H | 2-CN | 4-CN | 5-OCH₃ |
| Ia.785 | CF₃ | H | 2-CN | 4-CN | 5-OCF₃ |
| Ia.786 | CF₃ | H | 2-methyl | 4-CN | 5-fluoro |
| Ia.787 | CF₃ | H | 2-methyl | 4-CN | 5-chloro |
| Ia.788 | CF₃ | H | 2-methyl | 4-CN | 5-CN |
| Ia.789 | CF₃ | H | 2-methyl | 4-CN | 5-CH₃ |
| Ia.790 | CF₃ | H | 2-methyl | 4-CN | 5-CF₃ |
| Ia.791 | CF₃ | H | 2-methyl | 4-CN | 5-OCH₃ |
| Ia.792 | CF₃ | H | 2-methyl | 4-CN | 5-OCF₃ |
| Ia.793 | CF₃ | H | 2-CF₃ | 4-CN | 5-fluoro |
| Ia.794 | CF₃ | H | 2-CF₃ | 4-CN | 5-chloro |
| Ia.795 | CF₃ | H | 2-CF₃ | 4-CN | 5-CN |
| Ia.796 | CF₃ | H | 2-CF₃ | 4-CN | 5-CH₃ |
| Ia.797 | CF₃ | H | 2-CF₃ | 4-CN | 5-CF₃ |
| Ia.798 | CF₃ | H | 2-CF₃ | 4-CN | 5-OCH₃ |
| Ia.799 | CF₃ | H | 2-CF₃ | 4-CN | 5-OCF₃ |
| Ia.800 | CF₃ | H | 2-OCH₃ | 4-CN | 5-fluoro |
| Ia.801 | CF₃ | H | 2-OCH₃ | 4-CN | 5-chloro |
| Ia.802 | CF₃ | H | 2-OCH₃ | 4-CN | 5-CN |
| Ia.803 | CF₃ | H | 2-OCH₃ | 4-CN | 5-CH₃ |
| Ia.804 | CF₃ | H | 2-OCH₃ | 4-CN | 5-CF₃ |
| Ia.805 | CF₃ | H | 2-OCH₃ | 4-CN | 5-OCH₃ |
| Ia.806 | CF₃ | H | 2-OCH₃ | 4-CN | 5-OCF₃ |
| Ia.807 | CF₃ | H | 2-OCF₃ | 4-CN | 5-fluoro |
| Ia.808 | CF₃ | H | 2-OCF₃ | 4-CN | 5-chloro |
| Ia.809 | CF₃ | H | 2-OCF₃ | 4-CN | 5-CN |
| Ia.810 | CF₃ | H | 2-OCF₃ | 4-CN | 5-CH₃ |
| Ia.811 | CF₃ | H | 2-OCF₃ | 4-CN | 5-CF₃ |
| Ia.812 | CF₃ | H | 2-OCF₃ | 4-CN | 5-OCH₃ |
| Ia.813 | CF₃ | H | 2-OCF₃ | 4-CN | 5-OCF₃ |
| Ia.814 | CF₃ | H | 2-fluoro | 4-CH₃ | 5-fluoro |
| Ia.815 | CF₃ | H | 2-fluoro | 4-CH₃ | 5-chloro |
| Ia.816 | CF₃ | H | 2-fluoro | 4-CH₃ | 5-CN |
| Ia.817 | CF₃ | H | 2-fluoro | 4-CH₃ | 5-CH₃ |
| Ia.818 | CF₃ | H | 2-fluoro | 4-CH₃ | 5-CF₃ |
| Ia.819 | CF₃ | H | 2-fluoro | 4-CH₃ | 5-OCH₃ |
| Ia.820 | CF₃ | H | 2-fluoro | 4-CH₃ | 5-OCF₃ |
| Ia.821 | CF₃ | H | 2-chloro | 4-CH₃ | 5-fluoro |
| Ia.822 | CF₃ | H | 2-chloro | 4-CH₃ | 5-chloro |
| Ia.823 | CF₃ | H | 2-chloro | 4-CH₃ | 5-CN |
| Ia.824 | CF₃ | H | 2-chloro | 4-CH₃ | 5-CH₃ |
| Ia.825 | CF₃ | H | 2-chloro | 4-CH₃ | 5-CF₃ |
| Ia.826 | CF₃ | H | 2-chloro | 4-CH₃ | 5-OCH₃ |
| Ia.827 | CF₃ | H | 2-chloro | 4-CH₃ | 5-OCF₃ |
| Ia.828 | CF₃ | H | 2-CN | 4-CH₃ | 5-fluoro |
| Ia.829 | CF₃ | H | 2-CN | 4-CH₃ | 5-chloro |
| Ia.830 | CF₃ | H | 2-CN | 4-CH₃ | 5-CN |
| Ia.831 | CF₃ | H | 2-CN | 4-CH₃ | 5-CH₃ |
| Ia.832 | CF₃ | H | 2-CN | 4-CH₃ | 5-CF₃ |
| Ia.833 | CF₃ | H | 2-CN | 4-CH₃ | 5-OCH₃ |
| Ia.834 | CF₃ | H | 2-CN | 4-CH₃ | 5-OCF₃ |
| Ia.835 | CF₃ | H | 2-methyl | 4-CH₃ | 5-fluoro |
| Ia.836 | CF₃ | H | 2-methyl | 4-CH₃ | 5-chloro |
| Ia.837 | CF₃ | H | 2-methyl | 4-CH₃ | 5-CN |
| Ia.838 | CF₃ | H | 2-methyl | 4-CH₃ | 5-CH₃ |
| Ia.839 | CF₃ | H | 2-methyl | 4-CH₃ | 5-CF₃ |
| Ia.840 | CF₃ | H | 2-methyl | 4-CH₃ | 5-OCH₃ |
| Ia.841 | CF₃ | H | 2-methyl | 4-CH₃ | 5-OCF₃ |
| Ia.842 | CF₃ | H | 2-CF₃ | 4-CH₃ | 5-fluoro |
| Ia.843 | CF₃ | H | 2-CF₃ | 4-CH₃ | 5-chloro |
| Ia.844 | CF₃ | H | 2-CF₃ | 4-CH₃ | 5-CN |
| Ia.845 | CF₃ | H | 2-CF₃ | 4-CH₃ | 5-CH₃ |
| Ia.846 | CF₃ | H | 2-CF₃ | 4-CH₃ | 5-CF₃ |
| Ia.847 | CF₃ | H | 2-CF₃ | 4-CH₃ | 5-OCH₃ |
| Ia.848 | CF₃ | H | 2-CF₃ | 4-CH₃ | 5-OCF₃ |
| Ia.849 | CF₃ | H | 2-OCH₃ | 4-CH₃ | 5-fluoro |
| Ia.850 | CF₃ | H | 2-OCH₃ | 4-CH₃ | 5-chloro |
| Ia.851 | CF₃ | H | 2-OCH₃ | 4-CH₃ | 5-CN |
| Ia.852 | CF₃ | H | 2-OCH₃ | 4-CH₃ | 5-CH₃ |
| Ia.853 | CF₃ | H | 2-OCH₃ | 4-CH₃ | 5-CF₃ |
| Ia.854 | CF₃ | H | 2-OCH₃ | 4-CH₃ | 5-OCH₃ |
| Ia.855 | CF₃ | H | 2-OCH₃ | 4-CH₃ | 5-OCF₃ |
| Ia.856 | CF₃ | H | 2-OCF₃ | 4-CH₃ | 5-fluoro |
| Ia.857 | CF₃ | H | 2-OCF₃ | 4-CH₃ | 5-chloro |
| Ia.858 | CF₃ | H | 2-OCF₃ | 4-CH₃ | 5-CN |
| Ia.859 | CF₃ | H | 2-OCF₃ | 4-CH₃ | 5-CH₃ |
| Ia.860 | CF₃ | H | 2-OCF₃ | 4-CH₃ | 5-CF₃ |
| Ia.861 | CF₃ | H | 2-OCF₃ | 4-CH₃ | 5-OCH₃ |
| Ia.862 | CF₃ | H | 2-OCF₃ | 4-CH₃ | 5-OCF₃ |
| Ia.863 | CF₃ | H | 2-fluoro | 4-CF₃ | 5-fluoro |
| Ia.864 | CF₃ | H | 2-fluoro | 4-CF₃ | 5-chloro |
| Ia.865 | CF₃ | H | 2-fluoro | 4-CF₃ | 5-CN |
| Ia.866 | CF₃ | H | 2-fluoro | 4-CF₃ | 5-CH₃ |
| Ia.867 | CF₃ | H | 2-fluoro | 4-CF₃ | 5-CF₃ |
| Ia.868 | CF₃ | H | 2-fluoro | 4-CF₃ | 5-OCH₃ |
| Ia.869 | CF₃ | H | 2-fluoro | 4-CF₃ | 5-OCF₃ |
| Ia.870 | CF₃ | H | 2-chloro | 4-CF₃ | 5-fluoro |
| Ia.871 | CF₃ | H | 2-chloro | 4-CF₃ | 5-chloro |
| Ia.872 | CF₃ | H | 2-chloro | 4-CF₃ | 5-CN |
| Ia.873 | CF₃ | H | 2-chloro | 4-CF₃ | 5-CH₃ |
| Ia.874 | CF₃ | H | 2-chloro | 4-CF₃ | 5-CF₃ |
| Ia.875 | CF₃ | H | 2-chloro | 4-CF₃ | 5-OCH₃ |
| Ia.876 | CF₃ | H | 2-chloro | 4-CF₃ | 5-OCF₃ |
| Ia.877 | CF₃ | H | 2-CN | 4-CF₃ | 5-fluoro |
| Ia.878 | CF₃ | H | 2-CN | 4-CF₃ | 5-chloro |
| Ia.879 | CF₃ | H | 2-CN | 4-CF₃ | 5-CN |
| Ia.880 | CF₃ | H | 2-CN | 4-CF₃ | 5-CH₃ |
| Ia.881 | CF₃ | H | 2-CN | 4-CF₃ | 5-CF₃ |
| Ia.882 | CF₃ | H | 2-CN | 4-CF₃ | 5-OCH₃ |
| Ia.883 | CF₃ | H | 2-CN | 4-CF₃ | 5-OCF₃ |
| Ia.884 | CF₃ | H | 2-methyl | 4-CF₃ | 5-fluoro |
| Ia.885 | CF₃ | H | 2-methyl | 4-CF₃ | 5-chloro |
| Ia.886 | CF₃ | H | 2-methyl | 4-CF₃ | 5-CN |
| Ia.887 | CF₃ | H | 2-methyl | 4-CF₃ | 5-CH₃ |
| Ia.888 | CF₃ | H | 2-methyl | 4-CF₃ | 5-CF₃ |
| Ia.889 | CF₃ | H | 2-methyl | 4-CF₃ | 5-OCH₃ |
| Ia.890 | CF₃ | H | 2-methyl | 4-CF₃ | 5-OCF₃ |
| Ia.891 | CF₃ | H | 2-CF₃ | 4-CF₃ | 5-fluoro |
| Ia.892 | CF₃ | H | 2-CF₃ | 4-CF₃ | 5-chloro |
| Ia.893 | CF₃ | H | 2-CF₃ | 4-CF₃ | 5-CN |
| Ia.894 | CF₃ | H | 2-CF₃ | 4-CF₃ | 5-CH₃ |
| Ia.895 | CF₃ | H | 2-CF₃ | 4-CF₃ | 5-CF₃ |
| Ia.896 | CF₃ | H | 2-CF₃ | 4-CF₃ | 5-OCH₃ |
| Ia.897 | CF₃ | H | 2-CF₃ | 4-CF₃ | 5-OCF₃ |
| Ia.898 | CF₃ | H | 2-OCH₃ | 4-CF₃ | 5-fluoro |
| Ia.899 | CF₃ | H | 2-OCH₃ | 4-CF₃ | 5-chloro |
| Ia.900 | CF₃ | H | 2-OCH₃ | 4-CF₃ | 5-CN |
| Ia.901 | CF₃ | H | 2-OCH₃ | 4-CF₃ | 5-CH₃ |
| Ia.902 | CF₃ | H | 2-OCH₃ | 4-CF₃ | 5-CF₃ |
| Ia.903 | CF₃ | H | 2-OCH₃ | 4-CF₃ | 5-OCH₃ |
| Ia.904 | CF₃ | H | 2-OCH₃ | 4-CF₃ | 5-OCF₃ |
| Ia.905 | CF₃ | H | 2-OCF₃ | 4-CF₃ | 5-fluoro |
| Ia.906 | CF₃ | H | 2-OCF₃ | 4-CF₃ | 5-chloro |
| Ia.907 | CF₃ | H | 2-OCF₃ | 4-CF₃ | 5-CN |
| Ia.908 | CF₃ | H | 2-OCF₃ | 4-CF₃ | 5-CH₃ |
| Ia.909 | CF₃ | H | 2-OCF₃ | 4-CF₃ | 5-CF₃ |
| Ia.910 | CF₃ | H | 2-OCF₃ | 4-CF₃ | 5-OCH₃ |
| Ia.911 | CF₃ | H | 2-OCF₃ | 4-CF₃ | 5-OCF₃ |
| Ia.912 | CF₃ | H | 2-fluoro | 4-OCH₃ | 5-fluoro |
| Ia.913 | CF₃ | H | 2-fluoro | 4-OCH₃ | 5-chloro |
| Ia.914 | CF₃ | H | 2-fluoro | 4-OCH₃ | 5-CN |
| Ia.915 | CF₃ | H | 2-fluoro | 4-OCH₃ | 5-CH₃ |
| Ia.916 | CF₃ | H | 2-fluoro | 4-OCH₃ | 5-CF₃ |
| Ia.917 | CF₃ | H | 2-fluoro | 4-OCH₃ | 5-OCH₃ |
| Ia.918 | CF₃ | H | 2-fluoro | 4-OCH₃ | 5-OCF₃ |
| Ia.919 | CF₃ | H | 2-chloro | 4-OCH₃ | 5-fluoro |
| Ia.920 | CF₃ | H | 2-chloro | 4-OCH₃ | 5-chloro |
| Ia.921 | CF₃ | H | 2-chloro | 4-OCH₃ | 5-CN |
| Ia.922 | CF₃ | H | 2-chloro | 4-OCH₃ | 5-CH₃ |
| Ia.923 | CF₃ | H | 2-chloro | 4-OCH₃ | 5-CF₃ |
| Ia.924 | CF₃ | H | 2-chloro | 4-OCH₃ | 5-OCH₃ |
| Ia.925 | CF₃ | H | 2-chloro | 4-OCH₃ | 5-OCF₃ |
| Ia.926 | CF₃ | H | 2-CN | 4-OCH₃ | 5-fluoro |
| Ia.927 | CF₃ | H | 2-CN | 4-OCH₃ | 5-chloro |
| Ia.928 | CF₃ | H | 2-CN | 4-OCH₃ | 5-CN |
| Ia.929 | CF₃ | H | 2-CN | 4-OCH₃ | 5-CH₃ |
| Ia.930 | CF₃ | H | 2-CN | 4-OCH₃ | 5-CF₃ |
| Ia.931 | CF₃ | H | 2-CN | 4-OCH₃ | 5-OCH₃ |
| Ia.932 | CF₃ | H | 2-CN | 4-OCH₃ | 5-OCF₃ |
| Ia.933 | CF₃ | H | 2-methyl | 4-OCH₃ | 5-fluoro |
| Ia.934 | CF₃ | H | 2-methyl | 4-OCH₃ | 5-chloro |
| Ia.935 | CF₃ | H | 2-methyl | 4-OCH₃ | 5-CN |
| Ia.936 | CF₃ | H | 2-methyl | 4-OCH₃ | 5-CH₃ |
| Ia.937 | CF₃ | H | 2-methyl | 4-OCH₃ | 5-CF₃ |
| Ia.938 | CF₃ | H | 2-methyl | 4-OCH₃ | 5-OCH₃ |
| Ia.939 | CF₃ | H | 2-methyl | 4-OCH₃ | 5-OCF₃ |
| Ia.940 | CF₃ | H | 2-CF₃ | 4-OCH₃ | 5-fluoro |
| Ia.941 | CF₃ | H | 2-CF₃ | 4-OCH₃ | 5-chloro |
| Ia.942 | CF₃ | H | 2-CF₃ | 4-OCH₃ | 5-CN |
| Ia.943 | CF₃ | H | 2-CF₃ | 4-OCH₃ | 5-CH₃ |
| Ia.944 | CF₃ | H | 2-CF₃ | 4-OCH₃ | 5-CF₃ |
| Ia.945 | CF₃ | H | 2-CF₃ | 4-OCH₃ | 5-OCH₃ |
| Ia.946 | CF₃ | H | 2-CF₃ | 4-OCH₃ | 5-OCF₃ |
| Ia.947 | CF₃ | H | 2-OCH₃ | 4-OCH₃ | 5-fluoro |
| Ia.948 | CF₃ | H | 2-OCH₃ | 4-OCH₃ | 5-chloro |
| Ia.949 | CF₃ | H | 2-OCH₃ | 4-OCH₃ | 5-CN |
| Ia.950 | CF₃ | H | 2-OCH₃ | 4-OCH₃ | 5-CH₃ |
| Ia.951 | CF₃ | H | 2-OCH₃ | 4-OCH₃ | 5-CF₃ |
| Ia.952 | CF₃ | H | 2-OCH₃ | 4-OCH₃ | 5-OCH₃ |
| Ia.953 | CF₃ | H | 2-OCH₃ | 4-OCH₃ | 5-OCF₃ |
| Ia.954 | CF₃ | H | 2-OCF₃ | 4-OCH₃ | 5-fluoro |
| Ia.955 | CF₃ | H | 2-OCF₃ | 4-OCH₃ | 5-chloro |
| Ia.956 | CF₃ | H | 2-OCF₃ | 4-OCH₃ | 5-CN |
| Ia.957 | CF₃ | H | 2-OCF₃ | 4-OCH₃ | 5-CH₃ |
| Ia.958 | CF₃ | H | 2-OCF₃ | 4-OCH₃ | 5-CF₃ |
| Ia.959 | CF₃ | H | 2-OCF₃ | 4-OCH₃ | 5-OCH₃ |
| Ia.960 | CF₃ | H | 2-OCF₃ | 4-OCH₃ | 5-OCF₃ |
| Ia.961 | CF₃ | H | 2-fluoro | 4-OCF₃ | 5-fluoro |
| Ia.962 | CF₃ | H | 2-fluoro | 4-OCF₃ | 5-chloro |
| Ia.963 | CF₃ | H | 2-fluoro | 4-OCF₃ | 5-CN |
| Ia.964 | CF₃ | H | 2-fluoro | 4-OCF₃ | 5-CH₃ |
| Ia.965 | CF₃ | H | 2-fluoro | 4-OCF₃ | 5-CF₃ |
| Ia.966 | CF₃ | H | 2-fluoro | 4-OCF₃ | 5-OCH₃ |
| Ia.967 | CF₃ | H | 2-fluoro | 4-OCF₃ | 5-OCF₃ |
| Ia.968 | CF₃ | H | 2-chloro | 4-OCF₃ | 5-fluoro |
| Ia.969 | CF₃ | H | 2-chloro | 4-OCF₃ | 5-chloro |
| Ia.970 | CF₃ | H | 2-chloro | 4-OCF₃ | 5-CN |
| Ia.971 | CF₃ | H | 2-chloro | 4-OCF₃ | 5-CH₃ |
| Ia.972 | CF₃ | H | 2-chloro | 4-OCF₃ | 5-CF₃ |
| Ia.973 | CF₃ | H | 2-chloro | 4-OCF₃ | 5-OCH₃ |
| Ia.974 | CF₃ | H | 2-chloro | 4-OCF₃ | 5-OCF₃ |
| Ia.975 | CF₃ | H | 2-CN | 4-OCF₃ | 5-fluoro |
| Ia.976 | CF₃ | H | 2-CN | 4-OCF₃ | 5-chloro |
| Ia.977 | CF₃ | H | 2-CN | 4-OCF₃ | 5-CN |
| Ia.978 | CF₃ | H | 2-CN | 4-OCF₃ | 5-CH₃ |
| Ia.979 | CF₃ | H | 2-CN | 4-OCF₃ | 5-CF₃ |
| Ia.980 | CF₃ | H | 2-CN | 4-OCF₃ | 5-OCH₃ |
| Ia.981 | CF₃ | H | 2-CN | 4-OCF₃ | 5-OCF₃ |
| Ia.982 | CF₃ | H | 2-methyl | 4-OCF₃ | 5-fluoro |
| Ia.983 | CF₃ | H | 2-methyl | 4-OCF₃ | 5-chloro |
| Ia.984 | CF₃ | H | 2-methyl | 4-OCF₃ | 5-CN |
| Ia.985 | CF₃ | H | 2-methyl | 4-OCF₃ | 5-CH₃ |
| Ia.986 | CF₃ | H | 2-methyl | 4-OCF₃ | 5-CF₃ |
| Ia.987 | CF₃ | H | 2-methyl | 4-OCF₃ | 5-OCH₃ |
| Ia.988 | CF₃ | H | 2-methyl | 4-OCF₃ | 5-OCF₃ |
| Ia.989 | CF₃ | H | 2-CF₃ | 4-OCF₃ | 5-fluoro |
| Ia.990 | CF₃ | H | 2-CF₃ | 4-OCF₃ | 5-chloro |
| Ia.991 | CF₃ | H | 2-CF₃ | 4-OCF₃ | 5-CN |
| Ia.992 | CF₃ | H | 2-CF₃ | 4-OCF₃ | 5-CH₃ |
| Ia.993 | CF₃ | H | 2-CF₃ | 4-OCF₃ | 5-CF₃ |
| Ia.994 | CF₃ | H | 2-CF₃ | 4-OCF₃ | 5-OCH₃ |
| Ia.995 | CF₃ | H | 2-CF₃ | 4-OCF₃ | 5-OCF₃ |
| Ia.996 | CF₃ | H | 2-OCH₃ | 4-OCF₃ | 5-fluoro |
| Ia.997 | CF₃ | H | 2-OCH₃ | 4-OCF₃ | 5-chloro |
| Ia.998 | CF₃ | H | 2-OCH₃ | 4-OCF₃ | 5-CN |
| Ia.999 | CF₃ | H | 2-OCH₃ | 4-OCF₃ | 5-CH₃ |
| Ia.1000 | CF₃ | H | 2-OCH₃ | 4-OCF₃ | 5-CF₃ |
| Ia.1001 | CF₃ | H | 2-OCH₃ | 4-OCF₃ | 5-OCH₃ |
| Ia.1002 | CF₃ | H | 2-OCH₃ | 4-OCF₃ | 5-OCF₃ |
| Ia.1003 | CF₃ | H | 2-OCF₃ | 4-OCF₃ | 5-fluoro |
| Ia.1004 | CF₃ | H | 2-OCF₃ | 4-OCF₃ | 5-chloro |
| Ia.1005 | CF₃ | H | 2-OCF₃ | 4-OCF₃ | 5-CN |
| Ia.1006 | CF₃ | H | 2-OCF₃ | 4-OCF₃ | 5-CH₃ |
| Ia.1007 | CF₃ | H | 2-OCF₃ | 4-OCF₃ | 5-CF₃ |
| Ia.1008 | CF₃ | H | 2-OCF₃ | 4-OCF₃ | 5-OCH₃ |
| Ia.1009 | CF₃ | H | 2-OCF₃ | 4-OCF₃ | 5-OCF₃ |
| Ia.1010 | CF₃ | H | H | 3-Cl | 4-Cl |

Particular preference is furthermore given to 1-methylpyrazol-4-ylcarboxanilides of the formulae Ib to Im, in particular to
the compounds Ib.1 to Ib.1010 which differ from the corresponding compounds Ia.1 to Ia.1010 only in that R² is fluorine:

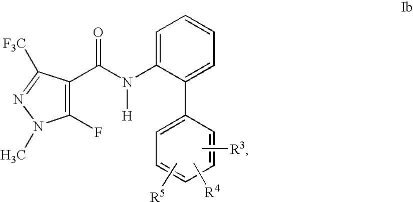

the compounds Ic.1 to Ic.1010 which differ from the corresponding compounds Ia.1 to Ia.1010 only in that R² is chlorine:

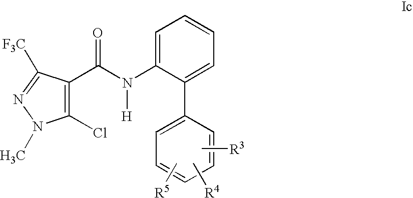

the compounds Id.1 to Id.1010 which differ from the corresponding compounds Ia.1 to Ia.1010 only in that R¹ is difluoromethyl:

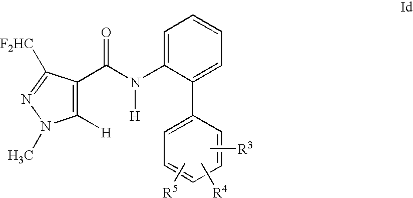

the compounds Ie.1 to Ie.1010 which differ from the corresponding compounds Ia.1 to Ia.1010 only in that R¹ is difluoromethyl and R² is fluorine:

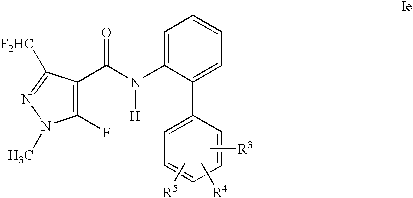

the compounds If.1 to If.1010 which differ from the corresponding compounds Ia.1 to Ia.1010 only in that R¹ is difluoromethyl and R² is chlorine:

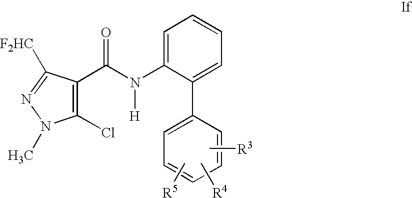

the compounds Ig.1 to Ig.1010 which differ from the corresponding compounds Ia.1 to Ia.1010 only in that R¹ is fluoromethyl:

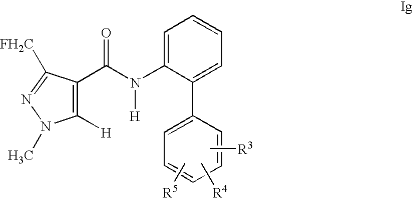

the compounds Ih.1 to Ih.1010 which differ from the corresponding compounds Ia.1 to Ia.1010 only in that R¹ is CF₂Cl:

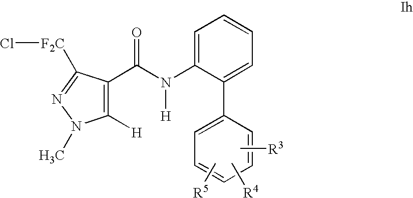

the compounds Ij.1 to Ij.1010 which differ from the corresponding compounds Ia.1 to Ia.1010 only in that R¹ is chlorofluoromethyl:

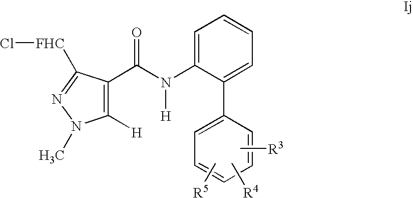

the compounds Ik.1 to Ik.1010 which differ from the corresponding compounds Ia.1 to Ia.1010 only in that X is 4-fluorine:

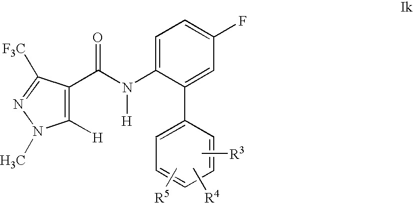

the compounds Im.1 to Im.1010 which differ from the corresponding compounds Ia.1 to Ia.1010 only in that X is 4-fluorine and R¹ is difluoromethyl:

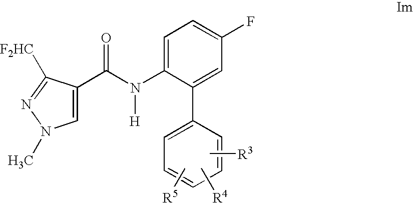

Among those 1-methylpyrazol-4-ylcarboxanilides I where X is hydrogen, particular preference is given to N-(2′-fluoro-4′-chloro-5′-methoxybiphenyl-2-yl)-3-trifluoromethyl-1-methyl-1H-pyrazole-4-carboxamide, N-(2′-fluoro-4′-chloro-5′-methylbiphenyl-2-yl)-3-trifluoromethyl-1-methyl-1H-pyrazole-4-carboxamide, N-(3′,4′,5′-trifluorobiphenyl-2-yl)-3-trifluoromethyl-1-methyl-1H-pyrazole-4-carboxamide, N-(2′,4′,5′-trifluorobiphenyl-2-yl)-3-trifluoromethyl-1-methyl-1H-pyrazole-4-carboxamide, N-(2′-fluoro-4′-chloro-5′-methoxybiphenyl-2-yl)-3-difluoromethyl-1-methyl-1H-pyrazole-4-carboxamide, N-(2′,3′,4′-trifluorobiphenyl-2-yl)-3-trifluoromethyl-1-methyl-1H-pyrazole-4-carboxamide, (2′-fluoro-4′-chloro-5′-methylbiphenyl-2-yl)-3-difluoromethyl-1-methyl-1H-pyrazole-4-carboxamide, N-(3′,4′,5′-trifluorobiphenyl-2-yl)-3-difluoromethyl-1-methyl-1H-pyrazole-4-carboxamide, N-(2′,4′,5′-trifluorobiphenyl-2-yl)-3-difluoromethyl-1-methyl-1H-pyrazole-4-carboxamide, N-(3′,4′,5′-trifluorobiphenyl-2-yl)-3-fluoromethyl-1-methyl-1H-pyrazole-4-carboxamide, N-(3′,4′,5′-trifluorobiphenyl-2-yl)-3-chlorodifluoromethyl-1-methyl-1H-pyrazole-4-carboxamide, N-(3′,4′,5′-trifluorobiphenyl-2-yl)-3-chlorofluoromethyl-1-methyl-1H-pyrazole-4-carboxamide, N-(2′,3′,4′-trifluorobiphenyl-2-yl)-3-fluoromethyl-1-methyl-1H-pyrazole-4-carboxamide and N-(2′,4′,5′-trifluorobiphenyl-2-yl)-3-fluoro-methyl-1-methyl-1H-pyrazole-4-carboxamide.

Among those 1-methylpyrazol-4-ylcarboxanilides I where X is fluorine, particular preference is given to N-(3′,4′-dichloro-3-fluorobiphenyl-2-yl)-1-methyl-3-trifluoromethyl-1H-pyrazole-4-carboxamide, N-(3′,4′-dichloro-3-fluorobiphenyl-2-yl)-1-methyl-3-difluoromethyl-1H-pyrazole-4-carboxamide, N-(3′,4′-difluoro-3-fluorobiphenyl-2-yl)-1-methyl-3-trifluoromethyl-1H-pyrazole-4-carboxamide, N-(3′,4′-difluoro-3-fluorobiphenyl-2-yl)-1-methyl-3-difluoromethyl-1H-pyrazole-4-carboxamide, N-(3′-chloro-4′-fluoro-3-fluorobiphenyl-2-yl)-1-methyl-3-difluoromethyl-1H-pyrazole-4-carboxamide, N-(3′,4′-dichloro-4-fluorobiphenyl-2-yl)-1-methyl-3-trifluoromethyl-1H-pyrazole-4-carboxamide, N-(3′,4′-difluoro-4-fluorobiphenyl-2-yl)-1-methyl-3-trifluoromethyl-1H-pyrazole-4-carboxamide, N-(3′,4′-dichloro-4-fluorobiphenyl-2-yl)-1-methyl-3-difluoromethyl-1H-pyrazole-4-carboxamide, N-(3′,4′-difluoro-4-fluorobiphenyl-2-yl)-1-methyl-3-difluoromethyl-1H-pyrazole-4-carboxamide, N-(3′-chloro-4′-fluoro-4-fluorobiphenyl-2-yl)-1-methyl-3-difluoromethyl-1H-pyrazole-4-carboxamide, N-(3′,4′-dichloro-5-fluorobiphenyl-2-yl)-1-methyl-3-trifluoromethyl-1H-pyrazole-4-carboxamide, N-(3′,4′-difluoro-5-fluorobiphenyl-2-yl)-1-methyl-3-trifluoromethyl-1H-pyrazole-4-carboxamide, N-(3′,4′-dichloro-5-fluorobiphenyl-2-yl)-1-methyl-3-difluoromethyl-1H-pyrazole-4-carboxamide, N-(3′,4′-difluoro-5-fluorobiphenyl-2-yl)-1-methyl-3-difluoromethyl-1H-pyrazole-4-carboxamide, N-(3′,4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-fluorobiphenyl-2-yl)-1-methyl-3-trifluoromethyl-1H-pyrazole-4-carboxamide, N-(4′-chloro-5-fluorobiphenyl-2-yl)-1-methyl-3-trifluoromethyl-1H-pyrazole-4-carboxamide, N-(4′-methyl-5-fluorobiphenyl-2-yl)-1-methyl-3-trifluoromethyl-1H-pyrazole-4-carboxamide, N-(4′-fluoro-5-fluorobiphenyl-2-yl)-1,3-dimethyl-1H-pyrazole-4-carboxamide, N-(4′-chloro-5-fluorobiphenyl-2-yl)-1,3-dimethyl-1H-pyrazole-4-carboxamide, N-(4′-methyl-5-fluorobiphenyl-2-yl)-1,3-dimethyl-1H-pyrazole-4-carboxamide, N-(4′-fluoro-6-fluorobiphenyl-2-yl)-1-methyl-3-trifluoromethyl-1H-pyrazole-4-carboxamide and N-(4′-chloro-6-fluorobiphenyl-2-yl)-1-methyl-3-trifluoromethyl-1H-pyrazole-4-carboxamide.

Preference is given to mixtures of a compound of the formula I with at least one active compound selected from the group of the A) azoles.

Preference is also given to mixtures of a compound of the formula I with at least one active compound selected from the group of the B) strobilurins.

Preference is given to mixtures of a compound of the formula I with at least one active compound selected from the group of the C) carboxamides.

Preference is furthermore also given to mixtures of a compound of the formula I with at least one active compound selected from the group of the D) heterocyclic compounds.

Preference is furthermore also given to mixtures of a compound of the formula I with at least one active compound selected from the group of the E) carbamates.

Preference is furthermore also given to mixtures of a compound of the formula I with at least one active compound selected from the group of the F) other fungicides.

Preference is furthermore also given to mixtures of a compound of the formula I with at least one active compound selected from the group of the G) plant growth regulators.

Preference is also given to mixtures of a compound of the formula I with at least one active compound selected from the group of the F) other fungicides selected from the group consisting of N′-(4-(4-chloro-3-trifluoromethyl-phenoxy)-2,5-dimethyl-phenyl)-N-ethyl-N-methyl formamidine and N′-(4-(4-fluoro-3-trifluoromethyl-phenoxy)-2,5-dimethyl-phenyl)-N-ethyl-N-methyl formamidine.

Preference is also given to mixtures of a compound of the formula I with at least one acitve compound selected from the group of the G) plant growth regulators selected from the group consisting of abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6 benzyladenine, prohexadione (prohexadione calcium), prohydrojasmon, thidiazuron, triapenthenol, tributyl phosphorotrithioate, 2,3,5-tri-iodobenzoic acid and trinexapac (trinexapac-ethyl).

Preference is also given to three-component mixtures of one compound of the formula I with two of the active compounds II mentioned above.

Preference is also given to three-component mixtures of one compound of the formula I with two of the active compounds II mentioned above or with one active compound II and a further fungicidally active compound III selected from active compound groups H) to N):
H) azoles selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thiabendazole, fuberidazole, ethaboxam, etridiazole and hymexazole;
J) strobilurins selected from the group consisting of azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methyl-pyridin-2-ylmethoxyimino)ethyl]benzyl)carbamate and methyl 2-(ortho-(2,5-dimethylphenyloxymethylene)phenyl)-3-methoxyacrylate;
K) carboxamides selected from the group consisting of carboxin, benalaxyl, boscalid, fenhexamid, flutolanil, furametpyr, mepronil, metalaxyl, mefenoxam, ofurace, oxadixyl, oxycarboxin, penthiopyrad, thifluzamide, tiadinil, 3,4-dichloro-N-(2-cyanophenyl)isothiazole-5-carboxamide, penthiopyrad, dimethomorph, flumorph, flumetover, fluopicolide (picobenzamid), zoxamide, carpropamid, diclocymet, mandipropamid, N-(2-(4-[3-(4-chlorophenyl) prop-2-ynyloxy]-3-ethoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide, methyl 3-(4-chlorophenyl)-3-(2-isopropoxycarbonylamino-3-methylbutyrylamino)propionate, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide and N-(2-cyanophenyl)-3,4-dichloroisothiazole-5-carboxamide;
L) heterocyclic compounds selected from the group consisting of fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, probenazole, 5-chloro-7-(4-methylpiperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen and N,N-dimethyl-3-(3-bromo-6-fluoro-2-methylindole-1-sulfonyl)-[1 ,2,4]triazole-1-sulfonamide;
M) carbamates selected from the group consisting of mancozeb, maneb, metam, metiram, ferbam, propineb, thiram, zineb, ziram, diethofencarb, iprovalicarb, flubenthiavalicarb, propamocarb, 4-fluorophenyl N-(1-(1-(4-cyanophenyl)ethane-sulfonyl)but-2-yl)carbamate, methyl 3-(4-chlorophenyl)-3-(2-isopropoxycarbonylamino-3-methylbutyrylamino)propanoate and carbamate oxime ethers of the formula IV

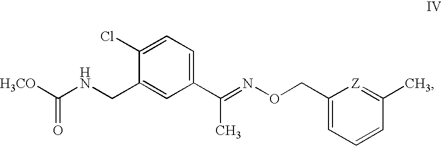

in which Z is N or CH;
N) other fungicides selected from the group consisting of guanidine, dodine, iminoctadine, guazatine, antibiotics: kasugamycin, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts such as fentin acetate, organophosphorus compounds: edifenphos, iprobenfos, fosetyl, fosetyl-aluminum, phosphorous acid and its salts, pyrazophos, tolclofos-methyl, organochlorine compounds: chlorothalonil, dichlofluanid, flusulfamide, hexachlor-benzene, phthalide, pencycuron, quintozene, thiophanate-methyl, tolylfluanid, inorganic active compounds: Bordeaux mixture, copper acetate, copper hydroxide, copper oxychloride, basic copper sulfate, sulfur, others: cyflufenamid, cymoxanil, dimethirimol, ethirimol, furalaxyl, metrafenone and spiroxamine.

The active compounds III mentioned above, their preparation and their action against harmful fungi are generally known (cf., for example, http://www.alanwood.net/pesticides/index_cn_frame.html); they are commercially available.

Preference is given to three-component mixtures of compounds I and II with an active compound selected from the group of the azoles H).

Preference is also given to three-component mixtures of compounds I and II with an active compound selected from the group of the strobilurins J).

Preference is given to three-component mixtures of compounds I and II with an active compound selected from the group of the carboxamides K).

Preference is furthermore also given to three-component mixtures of compounds I and II with an active compound selected from the group of the heterocyclic compounds L).

Preference is furthermore also given to three-component mixtures of compounds I and II with an active compound selected from the group of the carbamates M).

Preference is furthermore also given to three-component mixtures of compounds I and II with an active compound selected from the group of the other fungicides N).

Preference is furthermore also given to three-component mixtures of compounds I and II with an active compound selected from the group of the azoles H) selected from the group consisting of cyproconazole, difenoconazole, epoxiconazole, fluquinconazole, flusilazole, flutriafol, metconazole, myclobutanil, penconazole, propiconazole, prothioconazole, triadimefon, triadimenol, tebuconazole, tetraconazole, triticonazole, prochloraz, cyazofamid, benomyl, carbendazim and ethaboxam.

Particular preference is also given to three-component mixtures of compounds I and II with an active compound selected from the group of the azoles H) selected from the group consisting of cyproconazole, difenoconazole, epoxiconazole, fluquinconazole, flusilazole, flutriafol, metconazole, myclobutanil, propiconazole, prothioconazole, triadimefon, triadimenol, tebuconazole, tetraconazole, triticonazole, prochloraz, cyazofamid, benomyl and carbendazim.

Very particular preference is also given to three-component mixtures of compounds I and II with an active compound selected from the group of the azoles H) selected from the group consisting of epoxiconazole, fluquinconazole, flutriafol, metconazole, tebuconazole, triticonazole, prochloraz and carbendazim.

Preference is also given to three-component mixtures of compounds I and II with at least one active compound selected from the group of the strobilurins J) selected from the group consisting of azoxystrobin, dimoxystrobin, fluoxastrobin, kresoxim-methyl, orysastrobin, picoxystrobin, pyraclostrobin and trifloxystrobin.

Particular preference is also given to three-component mixtures of compounds I and II with an active compound selected from the group of the strobilurins J) selected from the group consisting of kresoxim-methyl, orysastrobin and pyraclostrobin.

Very particular preference is also given to three-component mixtures of compounds I and II with pyraclostrobin.

Preference is also given to three-component mixtures of compounds I and II with an active compound selected from the group of the carboxamides K) selected from the group consisting of fenhexamid, metalaxyl, mefenoxam, ofurace, dimethomorph, flumorph, fluopicolide (picobenzamid), zoxamide, carpropamid and mandipropamid.

Particular preference is also given to three-component mixtures of compounds I and II with an active compound selected from the group of the carboxamides K) selected from the group consisting of fenhexamid, metalaxyl, mefenoxam, ofurace, dimethomorph, zoxamide and carpropamid.

Preference is also given to three-component mixtures of compounds I and II with an active compound selected from the group of the heterocyclic compounds K) selected from the group consisting of fluazinam, cyprodinil, fenarimol, mepanipyrim, pyrimethanil, triforine, fludioxonil, dodemorph, fenpropimorph, tridemorph, fenpropidin, iprodione, vinclozolin, famoxadone, fenamidone, probenazole, 5-chloro-7-(4-methyl-piperidin-1-yl)-6-(2,4,6-trifluorophenyl)-[1,2,4]triazolo[1,5-a]pyrimidine, proquinazid, acibenzolar-S-methyl, captafol, folpet, fenoxanil and quinoxyfen, in particular fluazinam, cyprodinil, fenarimol, mepanipyrim, pyrimethanil, triforine, fludioxonil, dodemorph, fenpropimorph, tridemorph, fenpropidin, iprodione, vinclozolin, famoxadone, fenamidone, probenazole, proquinazid, acibenzolar-S-methyl, captafol, folpet, fenoxanil and quinoxyfen.

Particular preference is also given to three-component mixtures of compounds I and II with an active compound selected from the group of the heterocyclic compounds L) selected from the group consisting of pyrimethanil, dodemorph, fenpropimorph, tridemorph, iprodione, vinclozolin, 5-chloro-7-(4-methylpiperidin-1-yl)-6-(2,4,6-trifluorophenyl)-[1,2,4]triazolo[1,5-a]pyrimidine and quinoxyfen, in particular pyrimethanil, dodemorph, fenpropimorph, tridemorph, iprodione, vinclozolin and quinoxyfen.

Preference is also given to three-component mixtures of compounds I and II with at least one active compound selected from the group of the carbamates M) selected from the group consisting of mancozeb, metiram, propineb, thiram, iprovalicarb, flubenthiavalicarb and propamocarb.

Particular preference is also given to three-component mixtures of compounds I and II with an active compound selected from the group of the carbamates M) selected from the group consisting of mancozeb and metiram.

Preference is also given to three-component mixtures of compounds I and II with an active compound selected from the group of the other fungicides N) selected from the group consisting of dithianon, fentin salts, such as fentin acetate, fosetyl, fosetylaluminum, phosphorous acid and its salts, chlorothalonil, dichlofluanid, thiophanatemethyl, copper acetate, copper hydroxide, copper oxychloride, basic copper sulfate, sulfur, cymoxanil, metrafenone and spiroxamine.

Particular preference is also given to three-component mixtures of compounds I and II with an active compound selected from the group of the other fungicides N) selected from the group consisting of phosphorous acid and its salts, chlorothalonil and metrafenone.

Preference is also given to four-component mixtures of compounds I and II with two futher active compounds selected from compounds II and III mentioned above.

Preferred active compound combinations are listed in tables 3 to 8 below:

TABLE 3
Active compound combinations of compounds I
with active compounds II of group A):

| Mixture | Compound I | Compound II |
|---|---|---|
| No. A.1 | No. Ia.344 | azaconazole |
| No. A.2 | No. Ia.719 | azaconazole |
| No. A.3 | No. Id.344 | azaconazole |
| No. A.4 | No. Id.667 | azaconazole |
| No. A.5 | No. Ij.344 | azaconazole |
| No. A.6 | No. Im.1010 | azaconazole |
| No. A.7 | No. Ia.344 | diniconazole-M |
| No. A.8 | No. Ia.719 | diniconazole-M |
| No. A.9 | No. Id.344 | diniconazole-M |
| No. A.10 | No. Id.667 | diniconazole-M |
| No. A.11 | No. Ij.344 | diniconazole-M |
| No. A.12 | No. Im.1010 | diniconazole-M |
| No. A.13 | No. Ia.344 | oxpoconazol |
| No. A.14 | No. Ia.719 | oxpoconazol |
| No. A.15 | No. Id.344 | oxpoconazol |
| No. A.16 | No. Id.667 | oxpoconazol |
| No. A.17 | No. Ij.344 | oxpoconazol |
| No. A.18 | No. Im.1010 | oxpoconazol |
| No. A.19 | No. Ia.344 | paclobutrazol |
| No. A.20 | No. Ia.719 | paclobutrazol |
| No. A.21 | No. Id.344 | paclobutrazol |
| No. A.22 | No. Id.667 | paclobutrazol |
| No. A.23 | No. Ij.344 | paclobutrazol |
| No. A.24 | No. Im.1010 | paclobutrazol |
| No. A.25 | No. Ia.344 | uniconazol |
| No. A.26 | No. Ia.719 | uniconazol |
| No. A.27 | No. Id.344 | uniconazol |
| No. A.28 | No. Id.667 | uniconazol |
| No. A.29 | No. Ij.344 | uniconazol |
| No. A.30 | No. Im.1010 | uniconazol |
| No. A.31 | No. Ia.344 | 1-(4-chloro-phenyl)-2-([1,2,4]triazol-1-yl)- |
| | | cycloheptanol |
| No. A.32 | No. Ia.719 | 1-(4-chloro-phenyl)-2-([1,2,4]triazol-1-yl)- |
| | | cycloheptanol |
| No. A.33 | No. Id.344 | 1-(4-chloro-phenyl)-2-([1,2,4]triazol-1-yl)- |
| | | cycloheptanol |
| No. A.34 | No. Id.667 | 1-(4-chloro-phenyl)-2-([1,2,4]triazol-1-yl)- |
| | | cycloheptanol |
| No. A.35 | No. Ij.344 | 1-(4-chloro-phenyl)-2-([1,2,4]triazol-1-yl)- |
| | | cycloheptanol |
| No. A.36 | No. Im.1010 | 1-(4-chloro-phenyl)-2-([1,2,4]triazol-1-yl)- |
| | | cycloheptanol |
| No. A.37 | No. Ia.344 | imazalil-sulfphate |
| No. A.38 | No. Ia.719 | imazalil-sulfphate |
| No. A.39 | No. Id.344 | imazalil-sulfphate |
| No. A.40 | No. Id.667 | imazalil-sulfphate |
| No. A.41 | No. Ij.344 | imazalil-sulfphate |
| No. A.42 | No. Im.1010 | imazalil-sulfphate |

TABLE 4
Active compound combinations of compounds I
with active compounds II of group B):

| Mixture | Compound I | Compound II |
|---|---|---|
| No. B.1 | No. Ia.344 | 2-(2-(6-(3-chloro-2-methyl-phenoxy)-5-fluoro-pyrimidin-4-yloxy)- |
| | | phenyl)-2-methoxyimino-N-methyl-acetamide |
| No. B.2 | No. Ia.719 | 2-(2-(6-(3-chloro-2-methyl-phenoxy)-5-fluoro-pyrimidin-4- |
| | | yloxy)-phenyl)-2-methoxyimino-N-methyl-acetamide |
| No. B.3 | No. Id.344 | 2-(2-(6-(3-chloro-2-methyl-phenoxy)-5-fluoro-pyrimidin-4- |
| | | yloxy)-phenyl)-2-methoxyimino-N-methyl-acetamide |
| No. B.4 | No. Id.667 | 2-(2-(6-(3-chloro-2-methyl-phenoxy)-5-fluoro-pyrimidin-4- |
| | | yloxy)-phenyl)-2-methoxyimino-N-methyl-acetamide |
| No. B.5 | No. Ij.344 | 2-(2-(6-(3-chloro-2-methyl-phenoxy)-5-fluoro-pyrimidin-4- |
| | | yloxy)-phenyl)-2-methoxyimino-N-methyl-acetamide |
| No. B.6 | No. Im.1010 | 2-(2-(6-(3-chloro-2-methyl-phenoxy)-5-fluoro-pyrimidin-4- |
| | | yloxy)-phenyl)-2-methoxyimino-N-methyl-acetamide |
| No. B.7 | No. Ia.344 | 3-methoxy-2-(2-(N-(4-methoxy-phenyl)-cyclopropanecarb- |
| | | oximidoylsulfanylmethyl)-phenyl)-acrylic acid methyl ester |
| No. B.8 | No. Ia.719 | 3-methoxy-2-(2-(N-(4-methoxy-phenyl)-cyclopropanecarb- |
| | | oximidoylsulfanylmethyl)-phenyl)-acrylic acid methyl ester |
| No. B.9 | No. Id.344 | 3-methoxy-2-(2-(N-(4-methoxy-phenyl)-cyclopropanecarb- |
| | | oximidoylsulfanylmethyl)-phenyl)-acrylic acid methyl ester |
| No. B.10 | No. Id.667 | 3-methoxy-2-(2-(N-(4-methoxy-phenyl)-cyclopropanecarb- |
| | | oximidoylsulfanylmethyl)-phenyl)-acrylic acid methyl ester |
| No. B.11 | No. Ij.344 | 3-methoxy-2-(2-(N-(4-methoxy-phenyl)-cyclopropanecarb- |
| | | oximidoylsulfanylmethyl)-phenyl)-acrylic acid methyl ester |
| No. B.12 | No. Im.1010 | 3-methoxy-2-(2-(N-(4-methoxy-phenyl)-cyclopropanecarb- |
| | | oximidoylsulfanylmethyl)-phenyl)-acrylic acid methyl ester |

TABLE 5
Active compound combinations of compounds I
with active compounds II of group C):

| Mixture | Compounds I | Compound II |
|---|---|---|
| No. C.1 | No. Ia.344 | benalaxyl-M |
| No. C.2 | No. Ia.719 | benalaxyl-M |
| No. C.3 | No. Id.344 | benalaxyl-M |
| No. C.4 | No. Id.667 | benalaxyl-M |
| No. C.5 | No. Ij.344 | benalaxyl-M |
| No. C.6 | No. Im.1010 | benalaxyl-M |
| No. C.7 | No. Ia.344 | 2-amino-4-methyl-thiazole-5-carboxylic acid anilide |
| No. C.8 | No. Ia.719 | 2-amino-4-methyl-thiazole-5-carboxylic acid anilide |
| No. C.9 | No. Id.344 | 2-amino-4-methyl-thiazole-5-carboxylic acid anilide |
| No. C.10 | No. Id.667 | 2-amino-4-methyl-thiazole-5-carboxylic acid anilide |
| No. C.11 | No. Ij.344 | 2-amino-4-methyl-thiazole-5-carboxylic acid anilide |
| No. C.12 | No. Im.1010 | 2-amino-4-methyl-thiazole-5-carboxylic acid anilide |
| No. C.13 | No. Ia.344 | 2-chloro-N-(1,1,3-trimethyl-indan-4-yl)-nicotinamide |
| No. C.14 | No. Ia.719 | 2-chloro-N-(1,1,3-trimethyl-indan-4-yl)-nicotinamide |
| No. C.15 | No. Id.344 | 2-chloro-N-(1,1,3-trimethyl-indan-4-yl)-nicotinamide |
| No. C.16 | No. Id.667 | 2-chloro-N-(1,1,3-trimethyl-indan-4-yl)-nicotinamide |
| No. C.17 | No. Ij.344 | 2-chloro-N-(1,1,3-trimethyl-indan-4-yl)-nicotinamide |
| No. C.18 | No. Im.1010 | 2-chloro-N-(1,1,3-trimethyl-indan-4-yl)-nicotinamide |
| No. C.19 | No. Ia.344 | N-(2-(1,3-dimethylbutyl)-phenyl)-1,3-dimethyl-5-fluoro-1H- |
| | | pyrazole-4-carboxylic acid amide |
| No. C.20 | No. Ia.719 | N-(2-(1,3-dimethylbutyl)-phenyl)-1,3-dimethyl-5-fluoro-1H- |
| | | pyrazole-4-carboxylic acid amide |
| No. C.21 | No. Id.344 | N-(2-(1,3-dimethylbutyl)-phenyl)-1,3-dimethyl-5-fluoro-1H- |
| | | pyrazole-4-carboxylic acid amide |
| No. C.22 | No. Id.667 | N-(2-(1,3-dimethylbutyl)-phenyl)-1,3-dimethyl-5-fluoro-1H- |
| | | pyrazole-4-carboxylic acid amide |
| No. C.23 | No. Ij.344 | N-(2-(1,3-dimethylbutyl)-phenyl)-1,3-dimethyl-5-fluoro-1H- |
| | | pyrazole-4-carboxylic acid amide |
| No. C.24 | No. Im.1010 | N-(2-(1,3-dimethylbutyl)-phenyl)-1,3-dimethyl-5-fluoro-1H- |
| | | pyrazole-4-carboxylic acid amide |
| No. C.25 | No. Ia.344 | N-(4′-chloro-3′,5-difluoro-biphenyl-2-yl)-3-difluoromethyl-1- |
| | | methyl-1H-pyrazole-4-carboxylic acid amide |
| No. C.26 | No. Ia.719 | N-(4′-chloro-3′,5-difluoro-biphenyl-2-yl)-3-difluoromethyl-1- |
| | | methyl-1H-pyrazole-4-carboxylic acid amide |
| No. C.27 | No. Id.344 | N-(4′-chloro-3′,5-difluoro-biphenyl-2-yl)-3-difluoromethyl-1- |
| | | methyl-1H-pyrazole-4-carboxylic acid amide |
| No. C.28 | No. Id.667 | N-(4′-chloro-3′,5-difluoro-biphenyl-2-yl)-3-difluoromethyl-1- |
| | | methyl-1H-pyrazole-4-carboxylic acid amide |
| No. C.29 | No. Ij.344 | N-(4′-chloro-3′,5-difluoro-biphenyl-2-yl)-3-difluoromethyl-1- |
| | | methyl-1H-pyrazole-4-carboxylic acid amide |
| No. C.30 | No. Im.1010 | N-(4′-chloro-3′,5-difluoro-biphenyl-2-yl)-3-difluoromethyl-1- |
| | | methyl-1H-pyrazole-4-carboxylic acid amide |
| No. C.31 | No. Ia.344 | N-(4′-chloro-3′,5-difluoro-biphenyl-2-yl)-3-trifluoromethyl-1- |
| | | methyl-1H-pyrazole-4-carboxylic acid amide |
| No. C.32 | No. Ia.719 | N-(4′-chloro-3′,5-difluoro-biphenyl-2-yl)-3-trifluoromethyl-1- |
| | | methyl-1H-pyrazole-4-carboxylic acid amide |
| No. C.33 | No. Id.344 | N-(4′-chloro-3′,5-difluoro-biphenyl-2-yl)-3-trifluoromethyl-1- |
| | | methyl-1H-pyrazole-4-carboxylic acid amide |
| No. C.34 | No. Id.667 | N-(4′-chloro-3′,5-difluoro-biphenyl-2-yl)-3-trifluoromethyl-1- |
| | | methyl-1H-pyrazole-4-carboxylic acid amide |
| No. C.35 | No. Ij.344 | N-(4′-chloro-3′,5-difluoro-biphenyl-2-yl)-3-trifluoromethyl-1- |
| | | methyl-1H-pyrazole-4-carboxylic acid amide |
| No. C.36 | No. Im.1010 | N-(4′-chloro-3′,5-difluoro-biphenyl-2-yl)-3-trifluoromethyl-1- |
| | | methyl-1H-pyrazole-4-carboxylic acid amide |
| No. C.37 | No. Ia.344 | N-(3′,4′-dichloro-5-fluoro-biphenyl-2-yl)-3-trifluoromethyl-1- |
| | | methyl-1H-pyrazole-4-carboxylic acid amide |
| No. C.38 | No. Ia.719 | N-(3′,4′-dichloro-5-fluoro-biphenyl-2-yl)-3-trifluoromethyl-1- |
| | | methyl-1H-pyrazole-4-carboxylic acid amide |
| No. C.39 | No. Id.344 | N-(3′,4′-dichloro-5-fluoro-biphenyl-2-yl)-3-trifluoromethyl-1- |
| | | methyl-1H-pyrazole-4-carboxylic acid amide |
| No. C.40 | No. Id.667 | N-(3′,4′-dichloro-5-fluoro-biphenyl-2-yl)-3-trifluoromethyl-1- |
| | | methyl-1H-pyrazole-4-carboxylic acid amide |
| No. C.41 | No. Ij.344 | N-(3′,4′-dichloro-5-fluoro-biphenyl-2-yl)-3-trifluoromethyl-1- |
| | | methyl-1H-pyrazole-4-carboxylic acid amide |
| No. C.42 | No. Im.1010 | N-(3′,4′-dichloro-5-fluoro-biphenyl-2-yl)-3-trifluoromethyl-1- |
| | | methyl-1H-pyrazole-4-carboxylic acid amide |
| No. C.43 | No. Ia.344 | N-(3′,5-difluoro-4′-methyl-biphenyl-2-yl)-3-difluoromethyl-1- |
| | | methyl-1H-pyrazole-4-carboxylic acid amide |
| No. C.44 | No. Ia.719 | N-(3′,5-difluoro-4′-methyl-biphenyl-2-yl)-3-difluoromethyl-1- |
| | | methyl-1H-pyrazole-4-carboxylic acid amide |
| No. C.45 | No. Id.344 | N-(3′,5-difluoro-4′-methyl-biphenyl-2-yl)-3-difluoromethyl-1- |
| | | methyl-1H-pyrazole-4-carboxylic acid amide |
| No. C.46 | No. Id.667 | N-(3′,5-difluoro-4′-methyl-biphenyl-2-yl)-3-difluoromethyl-1- |
| | | methyl-1H-pyrazole-4-carboxylic acid amide |
| No. C.47 | No. Ij.344 | N-(3′,5-difluoro-4′-methyl-biphenyl-2-yl)-3-difluoromethyl-1- |
| | | methyl-1H-pyrazole-4-carboxylic acid amide |
| No. C.48 | No. Im.1010 | N-(3′,5-difluoro-4′-methyl-biphenyl-2-yl)-3-difluoromethyl-1- |
| | | methyl-1H-pyrazole-4-carboxylic acid amide |
| No. C.49 | No. Ia.344 | N-(3′,5-difluoro-4′-methyl-biphenyl-2-yl)-3-trifluoromethyl-1- |
| | | methyl-1H-pyrazole-4-carboxylic acid amide |
| No. C.50 | No. Ia.719 | N-(3′,5-difluoro-4′-methyl-biphenyl-2-yl)-3-trifluoromethyl-1- |
| | | methyl-1H-pyrazole-4-carboxylic acid amide |
| No. C.51 | No. Id.344 | N-(3′,5-difluoro-4′-methyl-biphenyl-2-yl)-3-trifluoromethyl-1- |
| | | methyl-1H-pyrazole-4-carboxylic acid amide |
| No. C.52 | No. Id.667 | N-(3′,5-difluoro-4′-methyl-biphenyl-2-yl)-3-trifluoromethyl-1- |
| | | methyl-1H-pyrazole-4-carboxylic acid amide |
| No. C.53 | No. Ij.344 | N-(3′,5-difluoro-4′-methyl-biphenyl-2-yl)-3-trifluoromethyl-1- |
| | | methyl-1H-pyrazole-4-carboxylic acid amide |
| No. C.54 | No. Im.1010 | N-(3′,5-difluoro-4′-methyl-biphenyl-2-yl)-3-trifluoromethyl-1- |
| | | methyl-1H-pyrazole-4-carboxylic acid amide |
| No. C.55 | No. Ia.344 | N-(cis-2-bicyclopropyl-2-yl-phenyl)-3-difluoromethyl-1- |
| | | methyl-1H-pyrazole-4-carboxylic acid amide |
| No. C.56 | No. Ia.719 | N-(cis-2-bicyclopropyl-2-yl-phenyl)-3-difluoromethyl-1- |
| | | methyl-1H-pyrazole-4-carboxylic acid amide |
| No. C.57 | No. Id.344 | N-(cis-2-bicyclopropyl-2-yl-phenyl)-3-difluoromethyl-1- |
| | | methyl-1H-pyrazole-4-carboxylic acid amide |
| No. C.58 | No. Id.667 | N-(cis-2-bicyclopropyl-2-yl-phenyl)-3-difluoromethyl-1- |
| | | methyl-1H-pyrazole-4-carboxylic acid amide |
| No. C.59 | No. Ij.344 | N-(cis-2-bicyclopropyl-2-yl-phenyl)-3-difluoromethyl-1- |
| | | methyl-1H-pyrazole-4-carboxylic acid amide |
| No. C.60 | No. Im.1010 | N-(cis-2-bicyclopropyl-2-yl-phenyl)-3-difluoromethyl-1- |
| | | methyl-1H-pyrazole-4-carboxylic acid amide |
| No. C.61 | No. Ia.344 | N-(trans-2-bicyclopropyl-2-yl-phenyl)-3-difluoromethyl-1- |
| | | methyl-1H-pyrazole-4-carboxylic acid amide |
| No. C.62 | No. Ia.719 | N-(trans-2-bicyclopropyl-2-yl-phenyl)-3-difluoromethyl-1- |
| | | methyl-1H-pyrazole-4-carboxylic acid amide |
| No. C.63 | No. Id.344 | N-(trans-2-bicyclopropyl-2-yl-phenyl)-3-difluoromethyl-1- |
| | | methyl-1H-pyrazole-4-carboxylic acid amide |
| No. C.64 | No. Id.667 | N-(trans-2-bicyclopropyl-2-yl-phenyl)-3-difluoromethyl-1- |
| | | methyl-1H-pyrazole-4-carboxylic acid amide |
| No. C.65 | No. Ij.344 | N-(trans-2-bicyclopropyl-2-yl-phenyl)-3-difluoromethyl-1- |
| | | methyl-1H-pyrazole-4-carboxylic acid amide |
| No. C.66 | No. Im.1010 | N-(trans-2-bicyclopropyl-2-yl-phenyl)-3-difluoromethyl-1- |
| | | methyl-1H-pyrazole-4-carboxylic acid amide |
| No. C.67 | No. Ia.344 | fluopyram |
| No. C.68 | No. Ia.719 | fluopyram |
| No. C.69 | No. Id.344 | fluopyram |
| No. C.70 | No. Id.667 | fluopyram |
| No. C.71 | No. Ij.344 | fluopyram |
| No. C.72 | No. Im.1010 | fluopyram |
| No. C.73 | No. Ia.344 | N-(3-ethyl-3,5-5-trimethyl-cyclohexyl)-3-formylamino-2- |
| | | hydroxy-benzamide |
| No. C.74 | No. Ia.719 | N-(3-ethyl-3,5-5-trimethyl-cyclohexyl)-3-formylamino-2- |
| | | hydroxy-benzamide |
| No. C.75 | No. Id.344 | N-(3-ethyl-3,5-5-trimethyl-cyclohexyl)-3-formylamino-2- |
| | | hydroxy-benzamide |
| No. C.76 | No. Id.667 | N-(3-ethyl-3,5-5-trimethyl-cyclohexyl)-3-formylamino-2- |
| | | hydroxy-benzamide |
| No. C.77 | No. Ij.344 | N-(3-ethyl-3,5-5-trimethyl-cyclohexyl)-3-formylamino-2- |
| | | hydroxy-benzamide |
| No. C.78 | No. Im.1010 | N-(3-ethyl-3,5-5-trimethyl-cyclohexyl)-3-formylamino-2- |
| | | hydroxy-benzamide |
| No. C.79 | No. Ia.344 | oxytetracyclin |
| No. C.80 | No. Ia.719 | oxytetracyclin |
| No. C.81 | No. Id.344 | oxytetracyclin |
| No. C.82 | No. Id.667 | oxytetracyclin |
| No. C.83 | No. Ij.344 | oxytetracyclin |
| No. C.84 | No. Im.1010 | oxytetracyclin |
| No. C.85 | No. Ia.344 | silthiofam |
| No. C.86 | No. Ia.719 | silthiofam |
| No. C.87 | No. Id.344 | silthiofam |
| No. C.88 | No. Id.667 | silthiofam |
| No. C.89 | No. Ij.344 | silthiofam |
| No. C.90 | No. Im.1010 | silthiofam |
| No. C.91 | No. Ia.344 | N-(6-methoxy-pyridin-3-yl) cyclopropanecarboxylic acid |
| | | amide |
| No. C.92 | No. Ia.719 | N-(6-methoxy-pyridin-3-yl) cyclopropanecarboxylic acid |
| | | amide |
| No. C.93 | No. Id.344 | N-(6-methoxy-pyridin-3-yl) cyclopropanecarboxylic acid |
| | | amide |
| No. C.94 | No. Id.667 | N-(6-methoxy-pyridin-3-yl) cyclopropanecarboxylic acid |
| | | amide |
| No. C.95 | No. Ij.344 | N-(6-methoxy-pyridin-3-yl) cyclopropanecarboxylic acid |
| | | amide |
| No. C.96 | No. Im.1010 | N-(6-methoxy-pyridin-3-yl) cyclopropanecarboxylic acid |
| | | amide |
| No. Ic.97 | Ia.344 | isotianil |
| No. Ic.98 | Ia.719 | isotianil |
| No. Ic.99 | Id.344 | isotianil |
| No. Ic.100 | Id.667 | isotianil |
| No. Ic.101 | Ij.344 | isotianil |
| No. Ic.102 | Im.1010 | isotianil |

TABLE 6
Active compound combinations of compounds I
with active compounds II of group D):

| Mixture | Compound I | Compound II |
|---|---|---|
| No. D.1 | No. Ia.344 | 2,3,5,6-tetrachloro-4-methanesulfonyl-pyridine |
| No. D.2 | No. Ia.719 | 2,3,5,6-tetrachloro-4-methanesulfonyl-pyridine |
| No. D.3 | No. Id.344 | 2,3,5,6-tetrachloro-4-methanesulfonyl-pyridine |
| No. D.4 | No. Id.667 | 2,3,5,6-tetrachloro-4-methanesulfonyl-pyridine |
| No. D.5 | No. Ij.344 | 2,3,5,6-tetrachloro-4-methanesulfonyl-pyridine |
| No. D.6 | No. Im.1010 | 2,3,5,6-tetrachloro-4-methanesulfonyl-pyridine |
| No. D.7 | No. Ia.344 | 3,4,5-trichloro-pyridine-2,6-di-carbonitrile |
| No. D.8 | No. Ia.719 | 3,4,5-trichloro-pyridine-2,6-di-carbonitrile |
| No. D.9 | No. Id.344 | 3,4,5-trichloro-pyridine-2,6-di-carbonitrile |
| No. D.10 | No. Id.667 | 3,4,5-trichloro-pyridine-2,6-di-carbonitrile |
| No. D.11 | No. Ij.344 | 3,4,5-trichloro-pyridine-2,6-di-carbonitrile |
| No. D.12 | No. Im.1010 | 3,4,5-trichloro-pyridine-2,6-di-carbonitrile |
| No. D.13 | No. Ia.344 | N-(1-(5-bromo-3-chloro-pyridin-2-yl)-ethyl)-2,4-dichloro- |
| | | nicotinamide |
| No. D.14 | No. Ia.719 | N-(1-(5-bromo-3-chloro-pyridin-2-yl)-ethyl)-2,4-dichloro- |
| | | nicotinamide |
| No. D.15 | No. Id.344 | N-(1-(5-bromo-3-chloro-pyridin-2-yl)-ethyl)-2,4-dichloro- |
| | | nicotinamide |
| No. D.16 | No. Id.667 | N-(1-(5-bromo-3-chloro-pyridin-2-yl)-ethyl)-2,4-dichloro- |
| | | nicotinamide |
| No. D.17 | No. Ij.344 | N-(1-(5-bromo-3-chloro-pyridin-2-yl)-ethyl)-2,4-dichloro- |
| | | nicotinamide |
| No. D.18 | No. Im.1010 | N-(1-(5-bromo-3-chloro-pyridin-2-yl)-ethyl)-2,4-dichloro- |
| | | nicotinamide |
| No. D.19 | No. Ia.344 | N-((5-bromo-3-chloro-pyridin-2-yl)-methyl)-2,4-dichloro- |
| | | nicotinamide |
| No. D.20 | No. Ia.719 | N-((5-bromo-3-chloro-pyridin-2-yl)-methyl)-2,4-dichloro- |
| | | nicotinamide |
| No. D.21 | No. Id.344 | N-((5-bromo-3-chloro-pyridin-2-yl)-methyl)-2,4-dichloro- |
| | | nicotinamide |
| No. D.22 | No. Id.667 | N-((5-bromo-3-chloro-pyridin-2-yl)-methyl)-2,4-dichloro- |
| | | nicotinamide |
| No. D.23 | No. Ij.344 | N-((5-bromo-3-chloro-pyridin-2-yl)-methyl)-2,4-dichloro- |
| | | nicotinamide |
| No. D.24 | No. Im.1010 | N-((5-bromo-3-chloro-pyridin-2-yl)-methyl)-2,4-dichloro- |
| | | nicotinamide |
| No. D.25 | No. Ia.344 | diflumetorim |
| No. D.26 | No. Ia.719 | diflumetorim |
| No. D.27 | No. Id.344 | diflumetorim |
| No. D.28 | No. Id.667 | diflumetorim |
| No. D.29 | No. Ij.344 | diflumetorim |
| No. D.30 | No. Im.1010 | diflumetorim |
| No. D.31 | No. Ia.344 | nitrapyrin |
| No. D.32 | No. Ia.719 | nitrapyrin |
| No. D.33 | No. Id.344 | nitrapyrin |
| No. D.34 | No. Id.667 | nitrapyrin |
| No. D.35 | No. Ij.344 | nitrapyrin |
| No. D.36 | No. Im.1010 | nitrapyrin |
| No. D.37 | No. Ia.344 | dodemorph-acetate |
| No. D.38 | No. Ia.719 | dodemorph-acetate |
| No. D.39 | No. Id.344 | dodemorph-acetate |
| No. D.40 | No. Id.667 | dodemorph-acetate |
| No. D.41 | No. Ij.344 | dodemorph-acetate |
| No. D.42 | No. Im.1010 | dodemorph-acetate |
| No. D.43 | No. Ia.344 | fluoroimid |
| No. D.44 | No. Ia.719 | fluoroimid |
| No. D.45 | No. Id.344 | fluoroimid |
| No. D.46 | No. Id.667 | fluoroimid |
| No. D.47 | No. Ij.344 | fluoroimid |
| No. D.48 | No. Im.1010 | fluoroimid |
| No. D.49 | No. Ia.344 | blasticidin-S |
| No. D.50 | No. Ia.719 | blasticidin-S |
| No. D.51 | No. Id.344 | blasticidin-S |
| No. D.52 | No. Id.667 | blasticidin-S |
| No. D.53 | No. Ij.344 | blasticidin-S |
| No. D.54 | No. Im.1010 | blasticidin-S |
| No. D.55 | No. Ia.344 | chinomethionat |
| No. D.56 | No. Ia.719 | chinomethionat |
| No. D.57 | No. Id.344 | chinomethionat |
| No. D.58 | No. Id.667 | chinomethionat |
| No. D.59 | No. Ij.344 | chinomethionat |
| No. D.60 | No. Im.1010 | chinomethionat |
| No. D.61 | No. Ia.344 | debacarb |
| No. D.62 | No. Ia.719 | debacarb |
| No. D.63 | No. Id.344 | debacarb |
| No. D.64 | No. Id.667 | debacarb |
| No. D.65 | No. Ij.344 | debacarb |
| No. D.66 | No. Im.1010 | debacarb |
| No. D.67 | No. Ia.344 | difenzoquat |
| No. D.68 | No. Ia.719 | difenzoquat |
| No. D.69 | No. Id.344 | difenzoquat |
| No. D.70 | No. Id.667 | difenzoquat |
| No. D.71 | No. Ij.344 | difenzoquat |
| No. D.72 | No. Im.1010 | difenzoquat |
| No. D.73 | No. Ia.344 | difenzoquat-methylsulphat |
| No. D.74 | No. Ia.719 | difenzoquat-methylsulphat |
| No. D.75 | No. Id.344 | difenzoquat-methylsulphat |
| No. D.76 | No. Id.667 | difenzoquat-methylsulphat |
| No. D.77 | No. Ij.344 | difenzoquat-methylsulphat |
| No. D.78 | No. Im.1010 | difenzoquat-methylsulphat |
| No. D.79 | No. Ia.344 | oxolinic acid |
| No. D.80 | No. Ia.719 | oxolinic acid |
| No. D.81 | No. Id.344 | oxolinic acid |
| No. D.82 | No. Id.667 | oxolinic acid |
| No. D.83 | No. Ij.344 | oxolinic acid |
| No. D.84 | No. Im.1010 | oxolinic acid |
| No. D.85 | No. Ia.344 | piperalin |
| No. D.86 | No. Ia.719 | piperalin |
| No. D.87 | No. Id.344 | piperalin |
| No. D.88 | No. Id.667 | piperalin |
| No. D.89 | No. Ij.344 | piperalin |
| No. D.90 | No. Im.1010 | piperalin |
| No. D.91 | No. Ia.344 | 3-[5-(4-chloro-phenyl)-2,3-dimethyl-isoxazolidin-3-yl]-pyridine |
| No. D.92 | No. Ia.719 | 3-[5-(4-chloro-phenyl)-2,3-dimethyl-isoxazolidin-3-yl]- |
| | | pyridine |
| No. D.93 | No. Id.344 | 3-[5-(4-chloro-phenyl)-2,3-dimethyl-isoxazolidin-3-yl]- |
| | | pyridine |
| No. D.94 | No. Id.667 | 3-[5-(4-chloro-phenyl)-2,3-dimethyl-isoxazolidin-3-yl]- |
| | | pyridine |
| No. D.95 | No. Ij.344 | 3-[5-(4-chloro-phenyl)-2,3-dimethyl-isoxazolidin-3-yl]- |
| | | pyridine |
| No. D.96 | No. Im.1010 | 3-[5-(4-chloro-phenyl)-2,3-dimethyl-isoxazolidin-3-yl]- |
| | | pyridine |
| No. D.97 | No. Ia.344 | 5-amino-2-iso-propyl-4-ortho-tolyl-pyrazol-3-on-1- |
| | | thiocarboxylic acid allyl ester |
| No. D.98 | No. Ia.719 | 5-amino-2-iso-propyl-4-ortho-tolyl-pyrazol-3-on-1- |
| | | thiocarboxylic acid allyl ester |
| No. D.99 | No. Id.344 | 5-amino-2-iso-propyl-4-ortho-tolyl-pyrazol-3-on-1- |
| | | thiocarboxylic acid allyl ester |
| No. D.100 | No. Id.667 | 5-amino-2-iso-propyl-4-ortho-tolyl-pyrazol-3-on-1- |
| | | thiocarboxylic acid allyl ester |
| No. D.101 | No. Ij.344 | 5-amino-2-iso-propyl-4-ortho-tolyl-pyrazol-3-on-1- |
| | | thiocarboxylic acid allyl ester |
| No. D.102 | No. Im.1010 | 5-amino-2-iso-propyl-4-ortho-tolyl-pyrazol-3-on-1- |
| | | thiocarboxylic acid allyl ester |

TABLE 7
Active compound combinations of
compounds I with active compounds II of group E):

| Mixture | Compound I | Compound II |
|---|---|---|
| No. E.1 | No. Ia.344 | methasulphocarb |
| No. E.2 | No. Ia.719 | methasulphocarb |
| No. E.3 | No. Id.344 | methasulphocarb |
| No. E.4 | No. Id.667 | methasulphocarb |
| No. E.5 | No. Ij.344 | methasulphocarb |
| No. E.6 | No. Im.1010 | methasulphocarb |
| No. E.7 | No. Ia.344 | pyribencarb |
| No. E.8 | No. Ia.719 | pyribencarb |
| No. E.9 | No. Id.344 | pyribencarb |
| No. E.10 | No. Id.667 | pyribencarb |
| No. E.11 | No. Ij.344 | pyribencarb |
| No. E.12 | No. Im.1010 | pyribencarb |
| No. E.13 | No. Ia.344 | propamocarb hydrochloride |
| No. E.14 | No. Ia.719 | propamocarb hydrochloride |
| No. E.15 | No. Id.344 | propamocarb hydrochloride |
| No. E.16 | No. Id.667 | propamocarb hydrochloride |
| No. E.17 | No. Ij.344 | propamocarb hydrochloride |
| No. E.18 | No. Im.1010 | propamocarb hydrochloride |

TABLE 8
Active compound combinations of compounds I with active compounds II of group F):

| Mixture | Compound I | Compound II |
|---|---|---|
| No. F.1 | No. Ia.344 | dodine free base |
| No. F.2 | No. Ia.719 | dodine free base |
| No. F.3 | No. Id.344 | dodine free base |
| No. F.4 | No. Id.667 | dodine free base |
| No. F.5 | No. Ij.344 | dodine free base |
| No. F.6 | No. Im.1010 | dodine free base |
| No. F.7 | No. Ia.344 | guazatine-acetate |
| No. F.8 | No. Ia.719 | guazatine-acetate |
| No. F.9 | No. Id.344 | guazatine-acetate |
| No. F.10 | No. Id.667 | guazatine-acetate |
| No. F.11 | No. Ij.344 | guazatine-acetate |
| No. F.12 | No. Im.1010 | guazatine-acetate |
| No. F.13 | No. Ia.344 | iminoctadine-triacetate |
| No. F.14 | No. Ia.719 | iminoctadine-triacetate |
| No. F.15 | No. Id.344 | iminoctadine-triacetate |
| No. F.16 | No. Id.667 | iminoctadine-triacetate |
| No. F.17 | No. Ij.344 | iminoctadine-triacetate |
| No. F.18 | No. Im.1010 | iminoctadine-triacetate |
| No. F.19 | No. Ia.344 | iminoctadine-tris(albesilate) |
| No. F.20 | No. Ia.719 | iminoctadine-tris(albesilate) |
| No. F.21 | No. Id.344 | iminoctadine-tris(albesilate) |
| No. F.22 | No. Id.667 | iminoctadine-tris(albesilate) |
| No. F.23 | No. Ij.344 | iminoctadine-tris(albesilate) |
| No. F.24 | No. Im.1010 | iminoctadine-tris(albesilate) |
| No. F.25 | No. Ia.344 | kasugamycin-hydrochlorid-hydrat |
| No. F.26 | No. Ia.719 | kasugamycin-hydrochlorid-hydrat |
| No. F.27 | No. Id.344 | kasugamycin-hydrochlorid-hydrat |
| No. F.28 | No. Id.667 | kasugamycin-hydrochlorid-hydrat |
| No. F.29 | No. Ij.344 | kasugamycin-hydrochlorid-hydrat |
| No. F.30 | No. Im.1010 | kasugamycin-hydrochlorid-hydrat |
| No. F.31 | No. Ia.344 | dichlorophen |
| No. F.32 | No. Ia.719 | dichlorophen |
| No. F.33 | No. Id.344 | dichlorophen |
| No. F.34 | No. Id.667 | dichlorophen |
| No. F.35 | No. Ij.344 | dichlorophen |
| No. F.36 | No. Im.1010 | dichlorophen |
| No. F.37 | No. Ia.344 | N-(4-chloro-2-nitro-phenyl)-N-ethyl-4-methyl- |
| | | benzenesulfonamide |
| No. F.38 | No. Ia.719 | N-(4-chloro-2-nitro-phenyl)-N-ethyl-4-methyl- |
| | | benzenesulfonamide |
| No. F.39 | No. Id.344 | N-(4-chloro-2-nitro-phenyl)-N-ethyl-4-methyl- |
| | | benzenesulfonamide |
| No. F.40 | No. Id.667 | N-(4-chloro-2-nitro-phenyl)-N-ethyl-4-methyl- |
| | | benzenesulfonamide |
| No. F.41 | No. Ij.344 | N-(4-chloro-2-nitro-phenyl)-N-ethyl-4-methyl- |
| | | benzenesulfonamide |
| No. F.42 | No. Im.1010 | N-(4-chloro-2-nitro-phenyl)-N-ethyl-4-methyl- |
| | | benzenesulfonamide |
| No. F.43 | No. Ia.344 | dicloran |
| No. F.44 | No. Ia.719 | dicloran |
| No. F.45 | No. Id.334 | dicloran |
| No. F.46 | No. Id.667 | dicloran |
| No. F.47 | No. Ij.344 | dicloran |
| No. F.48 | No. Im.1010 | dicloran |
| No. F.49 | No. Ia.344 | nitrothal-isopropyl |
| No. F.50 | No. Ia.719 | nitrothal-isopropyl |
| No. F.51 | No. Id.344 | nitrothal-isopropyl |
| No. F.52 | No. Id.667 | nitrothal-isopropyl |
| No. F.53 | No. Ij.344 | nitrothal-isopropyl |
| No. F.54 | No. Im.1010 | nitrothal-isopropyl |
| No. F.55 | No. Ia.344 | tecnazen |
| No. F.56 | No. Ia.719 | tecnazen |
| No. F.57 | No. Id.344 | tecnazen |
| No. F.58 | No. Id.667 | tecnazen |
| No. F.59 | No. Ij.344 | tecnazen |
| No. F.60 | No. Im.1010 | tecnazen |
| No. F.61 | No. Ia.344 | biphenyl |
| No. F.62 | No. Ia.719 | biphenyl |
| No. F.63 | No. Id.344 | biphenyl |
| No. F.64 | No. Id.667 | biphenyl |
| No. F.65 | No. Ij.344 | biphenyl |
| No. F.66 | No. Im.1010 | biphenyl |
| No. F.67 | No. Ia.344 | bronopol |
| No. F.68 | No. Ia.719 | bronopol |
| No. F.69 | No. Id.344 | bronopol |
| No. F.70 | No. Id.667 | bronopol |
| No. F.71 | No. Ij.344 | bronopol |
| No. F.72 | No. Im.1010 | bronopol |
| No. F.73 | No. Ia.344 | diphenylamine |
| No. F.74 | No. Ia.719 | diphenylamine |
| No. F.75 | No. Id.344 | diphenylamine |
| No. F.76 | No. Id.667 | diphenylamine |
| No. F.77 | No. Ij.344 | diphenylamine |
| No. F.78 | No. Im.1010 | diphenylamine |
| No. F.79 | No. Ia.344 | mildiomycin |
| No. F.80 | No. Ia.719 | mildiomycin |
| No. F.81 | No. Id.344 | mildiomycin |
| No. F.82 | No. Id.667 | mildiomycin |
| No. F.83 | No. Ij.344 | mildiomycin |
| No. F.84 | No. Im.1010 | mildiomycin |
| No. F.85 | No. Ia.344 | oxin-copper |
| No. F.86 | No. Ia.719 | oxin-copper |
| No. F.87 | No. Id.344 | oxin-copper |
| No. F.88 | No. Id.667 | oxin-copper |
| No. F.89 | No. Ij.344 | oxin-copper |
| No. F.90 | No. Im.1010 | oxin-copper |
| No. F.91 | No. Ia.344 | N-(cyclopropylmethoxyimino-(6-difluoromethoxy-2,3- |
| | | difluoro-phenyl)-methyl)-2-phenyl acetamide |
| No. F.92 | No. Ia.719 | N-(cyclopropylmethoxyimino-(6-difluoromethoxy-2,3- |
| | | difluoro-phenyl)-methyl)-2-phenyl acetamide |
| No. F.93 | No. Id.334 | N-(cyclopropylmethoxyimino-(6-difluoromethoxy-2,3- |
| | | difluoro-phenyl)-methyl)-2-phenyl acetamide |
| No. F.94 | No. Id.667 | N-(cyclopropylmethoxyimino-(6-difluoromethoxy-2,3- |
| | | difluoro-phenyl)-methyl)-2-phenyl acetamide |
| No. F.95 | No. Ij.344 | N-(cyclopropylmethoxyimino-(6-difluoromethoxy-2,3- |
| | | difluoro-phenyl)-methyl)-2-phenyl acetamide |
| No. F.96 | No. Im.1010 | N-(cyclopropylmethoxyimino-(6-difluoromethoxy-2,3- |
| | | difluoro-phenyl)-methyl)-2-phenyl acetamide |
| No. F.97 | No. Ia.344 | N′-(4-(4-chloro-3-trifluoromethyl-phenoxy)-2,5-dimethyl- |
| | | phenyl)-N-ethyl-N-methyl formamidine |
| No. F.98 | No. Ia.719 | N′-(4-(4-chloro-3-trifluoromethyl-phenoxy)-2,5-dimethyl- |
| | | phenyl)-N-ethyl-N-methyl formamidine |
| No. F.99 | No. Id.344 | N′-(4-(4-chloro-3-trifluoromethyl-phenoxy)-2,5-dimethyl- |
| | | phenyl)-N-ethyl-N-methyl formamidine |
| No. F.100 | No. Id.667 | N′-(4-(4-chloro-3-trifluoromethyl-phenoxy)-2,5-dimethyl- |
| | | phenyl)-N-ethyl-N-methyl formamidine |
| No. F.101 | No. Ij.344 | N′-(4-(4-chloro-3-trifluoromethyl-phenoxy)-2,5-dimethyl- |
| | | phenyl)-N-ethyl-N-methyl formamidine |
| No. F.102 | No. Im.1010 | N′-(4-(4-chloro-3-trifluoromethyl-phenoxy)-2,5-dimethyl- |
| | | phenyl)-N-ethyl-N-methyl formamidine |
| No. F.103 | No. Ia.344 | N′-(4-(4-fluoro-3-trifluoromethyl-phenoxy)-2,5-dimethyl- |
| | | phenyl)-N-ethyl-N-methyl formamidine |
| No. F.104 | No. Ia.719 | N′-(4-(4-fluoro-3-trifluoromethyl-phenoxy)-2,5-dimethyl- |
| | | phenyl)-N-ethyl-N-methyl formamidine |
| No. F.105 | No. Id.344 | N′-(4-(4-fluoro-3-trifluoromethyl-phenoxy)-2,5-dimethyl- |
| | | phenyl)-N-ethyl-N-methyl formamidine |
| No. F.106 | No. Id.667 | N′-(4-(4-fluoro-3-trifluoromethyl-phenoxy)-2,5-dimethyl- |
| | | phenyl)-N-ethyl-N-methyl formamidine |
| No. F.107 | No. Ij.344 | N′-(4-(4-fluoro-3-trifluoromethyl-phenoxy)-2,5-dimethyl- |
| | | phenyl)-N-ethyl-N-methyl formamidine |
| No. F.108 | No. Im.1010 | N′-(4-(4-fluoro-3-trifluoromethyl-phenoxy)-2,5-dimethyl- |
| | | phenyl)-N-ethyl-N-methyl formamidine |
| No. F.109 | No. Ia.344 | N′-(2-methyl-5-trifluormethyl-4-(3-trimethylsilanyl-propoxy)- |
| | | phenyl)-N-ethyl-N-methyl formamidine |
| No. F.110 | No. Ia.719 | N′-(2-methyl-5-trifluormethyl-4-(3-trimethylsilanyl-propoxy)- |
| | | phenyl)-N-ethyl-N-methyl formamidine |
| No. F.111 | No. Id.344 | N′-(2-methyl-5-trifluormethyl-4-(3-trimethylsilanyl-propoxy)- |
| | | phenyl)-N-ethyl-N-methyl formamidine |
| No. F.112 | No. Id.667 | N′-(2-methyl-5-trifluormethyl-4-(3-trimethylsilanyl-propoxy)- |
| | | phenyl)-N-ethyl-N-methyl formamidine |
| No. F.113 | No. Ij.344 | N′-(2-methyl-5-trifluormethyl-4-(3-trimethylsilanyl-propoxy)- |
| | | phenyl)-N-ethyl-N-methyl formamidine |
| No. F.114 | No. Im.1010 | N′-(2-methyl-5-trifluormethyl-4-(3-trimethylsilanyl-propoxy)- |
| | | phenyl)-N-ethyl-N-methyl formamidine |
| No. F.115 | No. Ia.344 | N′-(5-difluormethyl-2-methyl-4-(3-trimethylsilanyl-propoxy)- |
| | | phenyl)-N-ethyl-N-methyl formamidine |
| No. F.116 | No. Ia.719 | N′-(5-difluormethyl-2-methyl-4-(3-trimethylsilanyl-propoxy)- |
| | | phenyl)-N-ethyl-N-methyl formamidine |
| No. F.117 | No. Id.344 | N′-(5-difluormethyl-2-methyl-4-(3-trimethylsilanyl-propoxy)- |
| | | phenyl)-N-ethyl-N-methyl formamidine |
| No. F.118 | No. Id.667 | N′-(5-difluormethyl-2-methyl-4-(3-trimethylsilanyl-propoxy)- |
| | | phenyl)-N-ethyl-N-methyl formamidine |
| No. F.119 | No. Ij.344 | N′-(5-difluormethyl-2-methyl-4-(3-trimethylsilanyl-propoxy)- |
| | | phenyl)-N-ethyl-N-methyl formamidine |
| No. F.120 | No. Im.1010 | N′-(5-difluormethyl-2-methyl-4-(3-trimethylsilanyl-propoxy)- |
| | | phenyl)-N-ethyl-N-methyl formamidine |

TABLE 9
Active compound combinations of
compounds I with active compounds II of group G):

| Mixture | Compound I | Compound II |
|---|---|---|
| No. G.1 | No. Ia.344 | abscisic acid |
| No. G.2 | No. Ia.719 | abscisic acid |
| No. G.3 | No. Id.344 | abscisic acid |
| No. G.4 | No. Id.667 | abscisic acid |
| No. G.5 | No. Ij.344 | abscisic acid |
| No. G.6 | No. Im.1010 | abscisic acid |
| No. G.7 | No. Ia.344 | amidochlor |
| No. G.8 | No. Ia.719 | amidochlor |
| No. G.9 | No. Id.344 | amidochlor |
| No. G.10 | No. Id.667 | amidochlor |
| No. G.11 | No. Ij.344 | amidochlor |
| No. G.12 | No. Im.1010 | amidochlor |
| No. G.13 | No. Ia.344 | ancymidol |
| No. G.14 | No. Ia.719 | ancymidol |
| No. G.15 | No. Id.344 | ancymidol |
| No. G.16 | No. Id.667 | ancymidol |
| No. G.17 | No. Ij.344 | ancymidol |
| No. G.18 | No. Im.1010 | ancymidol |
| No. G.19 | No. Ia.344 | 6-benzylaminopurine |
| No. G.20 | No. Ia.719 | 6-benzylaminopurine |
| No. G.21 | No. Id.344 | 6-benzylaminopurine |
| No. G.22 | No. Id.667 | 6-benzylaminopurine |
| No. G.23 | No. Ij.344 | 6-benzylaminopurine |
| No. G.24 | No. Im.1010 | 6-benzylaminopurine |
| No. G.25 | No. Ia.344 | brassinolide |
| No. G.26 | No. Ia.719 | brassinolide |
| No. G.27 | No. Id.344 | brassinolide |
| No. G.28 | No. Id.667 | brassinolide |
| No. G.29 | No. Ij.344 | brassinolide |
| No. G.30 | No. Im.1010 | brassinolide |
| No. G.31 | No. Ia.344 | butralin |
| No. G.32 | No. Ia.719 | butralin |
| No. G.33 | No. Id.344 | butralin |
| No. G.34 | No. Id.667 | butralin |
| No. G.35 | No. Ij.344 | butralin |
| No. G.36 | No. Im.1010 | butralin |
| No. G.37 | No. Ia.344 | chlormequat chloride |
| No. G.38 | No. Ia.719 | chlormequat chloride |
| No. G.39 | No. Id.344 | chlormequat chloride |
| No. G.40 | No. Id.667 | chlormequat chloride |
| No. G.41 | No. Ij.344 | chlormequat chloride |
| No. G.42 | No. Im.1010 | chlormequat chloride |
| No. G.43 | No. Ia.344 | choline chloride |
| No. G.44 | No. Ia.719 | choline chloride |
| No. G.45 | No. Id.344 | choline chloride |
| No. G.46 | No. Id.667 | choline chloride |
| No. G.47 | No. Ij.344 | choline chloride |
| No. G.48 | No. Im.1010 | choline chloride |
| No. G.49 | No. Ia.344 | cyclanilide |
| No. G.50 | No. Ia.719 | cyclanilide |
| No. G.51 | No. Id.344 | cyclanilide |
| No. G.52 | No. Id.667 | cyclanilide |
| No. G.53 | No. Ij.344 | cyclanilide |
| No. G.54 | No. Im.1010 | cyclanilide |
| No. G.55 | No. Ia.344 | daminozide |
| No. G.56 | No. Ia.719 | daminozide |
| No. G.57 | No. Id.344 | daminozide |
| No. G.58 | No. Id.667 | daminozide |
| No. G.59 | No. Ij.344 | daminozide |
| No. G.60 | No. Im.1010 | daminozide |
| No. G.61 | No. Ia.344 | dikegulac |
| No. G.62 | No. Ia.719 | dikegulac |
| No. G.63 | No. Id.344 | dikegulac |
| No. G.64 | No. Id.667 | dikegulac |
| No. G.65 | No. Ij.344 | dikegulac |
| No. G.66 | No. Im.1010 | dikegulac |
| No. G.67 | No. Ia.344 | dimethipin |
| No. G.68 | No. Ia.719 | dimethipin |
| No. G.69 | No. Id.344 | dimethipin |
| No. G.70 | No. Id.667 | dimethipin |
| No. G.71 | No. Ij.344 | dimethipin |
| No. G.72 | No. Im.1010 | dimethipin |
| No. G.73 | No. Ia.344 | 2,6-dimethylpuridine |
| No. G.74 | No. Ia.719 | 2,6-dimethylpuridine |
| No. G.75 | No. Id.344 | 2,6-dimethylpuridine |
| No. G.76 | No. Id.667 | 2,6-dimethylpuridine |
| No. G.77 | No. Ij.344 | 2,6-dimethylpuridine |
| No. G.78 | No. Im.1010 | 2,6-dimethylpuridine |
| No. G.79 | No. Ia.344 | ethephon |
| No. G.80 | No. Ia.719 | ethephon |
| No. G.81 | No. Id.344 | ethephon |
| No. G.82 | No. Id.667 | ethephon |
| No. G.83 | No. Ij.344 | ethephon |
| No. G.84 | No. Im.1010 | ethephon |
| No. G.85 | No. Ia.344 | flumetralin |
| No. G.86 | No. Ia.719 | flumetralin |
| No. G.87 | No. Id.344 | flumetralin |
| No. G.88 | No. Id.667 | flumetralin |
| No. G.89 | No. Ij.344 | flumetralin |
| No. G.90 | No. Im.1010 | flumetralin |
| No. G.91 | No. Ia.344 | flurprimidol |
| No. G.92 | No. Ia.719 | flurprimidol |
| No. G.93 | No. Id.344 | flurprimidol |
| No. G.94 | No. Id.667 | flurprimidol |
| No. G.95 | No. Ij.344 | flurprimidol |
| No. G.96 | No. Im.1010 | flurprimidol |
| No. G.97 | No. Ia.344 | fluthiacet |
| No. G.98 | No. Ia.719 | fluthiacet |
| No. G.99 | No. Id.344 | fluthiacet |
| No. G.100 | No. Id.667 | fluthiacet |
| No. G.101 | No. Ij.344 | fluthiacet |
| No. G.102 | No. Im.1010 | fluthiacet |
| No. G.103 | No. Ia.344 | forchlorfenuron |
| No. G.104 | No. Ia.719 | forchlorfenuron |
| No. G.105 | No. Id.344 | forchlorfenuron |
| No. G.106 | No. Id.667 | forchlorfenuron |
| No. G.107 | No. Ij.344 | forchlorfenuron |
| No. G.108 | No. Im.1010 | forchlorfenuron |
| No. G.109 | No. Ia.344 | gibberellic acid |
| No. G.110 | No. Ia.719 | gibberellic acid |
| No. G.111 | No. Id.344 | gibberellic acid |
| No. G.112 | No. Id.667 | gibberellic acid |
| No. G.113 | No. Ij.344 | gibberellic acid |
| No. G.114 | No. Im.1010 | gibberellic acid |
| No. G.115 | No. Ia.344 | inabenfide |
| No. G.116 | No. Ia.719 | inabenfide |
| No. G.117 | No. Id.344 | inabenfide |
| No. G.118 | No. Id.667 | inabenfide |
| No. G.119 | No. Ij.344 | inabenfide |
| No. G.120 | No. Im.1010 | inabenfide |
| No. G.121 | No. Ia.344 | indole-3-acetic acid |
| No. G.122 | No. Ia.719 | indole-3-acetic acid |
| No. G.123 | No. Id.344 | indole-3-acetic acid |
| No. G.124 | No. Id.667 | indole-3-acetic acid |
| No. G.125 | No. Ij.344 | indole-3-acetic acid |
| No. G.126 | No. Im.1010 | indole-3-acetic acid |
| No. G.127 | No. Ia.344 | maleic hydrazide |
| No. G.128 | No. Ia.719 | maleic hydrazide |
| No. G.129 | No. Id.344 | maleic hydrazide |
| No. G.130 | No. Id.667 | maleic hydrazide |
| No. G.131 | No. Ij.344 | maleic hydrazide |
| No. G.132 | No. Im.1010 | maleic hydrazide |
| No. G.133 | No. Ia.344 | mefluidide |
| No. G.134 | No. Ia.719 | mefluidide |
| No. G.135 | No. Id.344 | mefluidide |
| No. G.136 | No. Id.667 | mefluidide |
| No. G.137 | No. Ij.344 | mefluidide |
| No. G.138 | No. Im.1010 | mefluidide |
| No. G.139 | No. Ia.344 | mepiquat chloride |
| No. G.140 | No. Ia.719 | mepiquat chloride |
| No. G.141 | No. Id.344 | mepiquat chloride |
| No. G.142 | No. Id.667 | mepiquat chloride |
| No. G.143 | No. Ij.344 | mepiquat chloride |
| No. G.144 | No. Im.1010 | mepiquat chloride |
| No. G.145 | No. Ia.344 | naphthaleneacetic acid |
| No. G.146 | No. Ia.719 | naphthaleneacetic acid |
| No. G.147 | No. Id.344 | naphthaleneacetic acid |
| No. G.148 | No. Id.667 | naphthaleneacetic acid |
| No. G.149 | No. Ij.344 | naphthaleneacetic acid |
| No. G.150 | No. Im.1010 | naphthaleneacetic acid |
| No. G.151 | No. Ia.344 | N-6 benzyladenine |
| No. G.152 | No. Ia.719 | N-6 benzyladenine |
| No. G.153 | No. Id.344 | N-6 benzyladenine |
| No. G.154 | No. Id.667 | N-6 benzyladenine |
| No. G.155 | No. Ij.344 | N-6 benzyladenine |
| No. G.156 | No. Im.1010 | N-6 benzyladenine |
| No. G.157 | No. Ia.344 | prohexadione calcium |
| No. G.158 | No. Ia.719 | prohexadione calcium |
| No. G.159 | No. Id.344 | prohexadione calcium |
| No. G.160 | No. Id.667 | prohexadione calcium |
| No. G.161 | No. Ij.344 | prohexadione calcium |
| No. G.162 | No. Im.1010 | prohexadione calcium |
| No. G.163 | No. Ia.344 | prohydrojasmon |
| No. G.164 | No. Ia.719 | prohydrojasmon |
| No. G.165 | No. Id.344 | prohydrojasmon |
| No. G.166 | No. Id.667 | prohydrojasmon |
| No. G.167 | No. Ij.344 | prohydrojasmon |
| No. G.168 | No. Im.1010 | prohydrojasmon |
| No. G.169 | No. Ia.344 | thidiazuron |
| No. G.170 | No. Ia.719 | thidiazuron |
| No. G.171 | No. Id.344 | thidiazuron |
| No. G.172 | No. Id.667 | thidiazuron |
| No. G.173 | No. Ij.344 | thidiazuron |
| No. G.174 | No. Im.1010 | thidiazuron |
| No. G.175 | No. Ia.344 | triapenthenol |
| No. G.176 | No. Ia.719 | triapenthenol |
| No. G.177 | No. Id.344 | triapenthenol |
| No. G.178 | No. Id.667 | triapenthenol |
| No. G.179 | No. Ij.344 | triapenthenol |
| No. G.180 | No. Im.1010 | triapenthenol |
| No. G.181 | No. Ia.344 | tributyl phosphorotrithioate |
| No. G.182 | No. Ia.719 | tributyl phosphorotrithioate |
| No. G.183 | No. Id.344 | tributyl phosphorotrithioate |
| No. G.184 | No. Id.667 | tributyl phosphorotrithioate |
| No. G.185 | No. Ij.344 | tributyl phosphorotrithioate |
| No. G.186 | No. Im.1010 | tributyl phosphorotrithioate |
| No. G.187 | No. Ia.344 | 2,3,5-tri-iodobenzoic acid |
| No. G.188 | No. Ia.719 | 2,3,5-tri-iodobenzoic acid |
| No. G.189 | No. Id.344 | 2,3,5-tri-iodobenzoic acid |
| No. G.190 | No. Id.667 | 2,3,5-tri-iodobenzoic acid |
| No. G.191 | No. Ij.344 | 2,3,5-tri-iodobenzoic acid |
| No. G.192 | No. Im.1010 | 2,3,5-tri-iodobenzoic acid |
| No. G.193 | No. Ia.344 | trinexapac-ethyl |
| No. G.194 | No. Ia.719 | trinexapac-ethyl |
| No. G.195 | No. Id.344 | trinexapac-ethyl |
| No. G.196 | No. Id.667 | trinexapac-ethyl |
| No. G.197 | No. Ij.344 | trinexapac-ethyl |
| No. G.198 | No. Im.1010 | trinexapac-ethyl |

The mixtures of the compound(s) I with at least one of the active compounds II, or the simultaneous, that is joint or separate, use of a compound I with at least one of the active compounds II, are/is distinguished by excellent activity against a broad spectrum of phytopathogenic fungi in particular from the classes of the Ascomycetes, Basidiomycetes, Deuteromycetes and Peronosporomycetes (syn. Oomycetes). Some of them are systemically active and can be used in crop protection as foliar fungicides, as soil fungicides and as fungicides for seed dressing.

They are particularly important in the control of a large number of fungi on various crop plants and their seed, such as wheat, rye, barley, oats, rice, corn, grass, bananas, cotton, soybeans, coffee, sugar cane, grapevines, fruit and ornamental plants and vegetables, such as cucumbers, beans, tomatoes, potatoes and cucurbits, and also the seeds of these plants.

The plants or seed treated with the combinations of compounds I and II may by wildlife types, plants or seed obtained by breeding and transgenic plants as well as their seed.

They are especially suitable for controlling the following phytopathogenic fungi:

Alternaria atrans tenuissima
Alternaria brassicae
Alternaria spp.
Ascochyta tritici
Blumeria graminis
Botrytis cinerea
Bremia lactucae
Bremia lucinae
Calonectria crotalariae
Cercospora canescens
Cercospora kikuchii
Cercospora sojina
Cercospora canescens
Choanephora infundibulifera
Cladosporium herbarum
Cochliobolus sativus
Cochliobolus sativus
Colletotrichum truncatum
Corynespora cassiicola
Dactuliophora glycines
Dematophora necatrix
Diaporthe phaseolorum
Diaporthe phaseolorum var. caulivora
Drechslera glycini
Epicoccum spp.
Erwinia amylovora
Erysiphe graminis
Frogeye sojina
Fusarium solani
Fusarium culmorum
Fusarium graminearum
Gaeumannomyces graminis
Leptosphaeria nodorum
Leptosphaerulina trifolii
Macrophomina phaseolina
Microdochium nivale
Microsphaera diffusa
Mycoleptodiscus terrestris
Neocosmospora vasinfecta
Pellicularia sasakii
Peronospora brassicae
Peronospora manshurica
Peronospora brassicae
Peronospora pisi
Phakopsora pachyrhizi
Phakopsora meibomiae
Phialophora gregata
Phomopsis phaseoli
Phyllostica sojaecola
Physiological leaf spots
Phythium ultimum
Phytophthora megasperma
Phytophthora infestans
Phytopthora megasperma
Plasmopara viticola
Podosphaera leucotricha
Podosphaera leucotricha
Pseudocercospora herpotrichoides
Pseudomonas lachrymans
Pseudomonas syringae
Pseudoperonospora cubensis
Pseudoperonospora humuli
Puccinia hordei
Puccinia recondita
Puccinia striiformis
Puccinia triticina
Pyrenochaeta glycines
Pyrenophora allosuri
Pyrenophora altermarina
Pyrenophora avenae
Pyrenophora bartramiae
Pyrenophora bondarzevii
Pyrenophora bromi
Pyrenophora bryophila
Pyrenophora buddleiae
Pyrenophora bupleuri
Pyrenophora calvertii
Pyrenophora calvescens var. moravica
Pyrenophora carthanie
Pyrenophora centranthi
Pyrenophora cerastii
Pyrenophora chengii
Pyrenophora chrysamthemi
Pyrenophora convohuli
Pyrenophora coppeyana
Pyrenophora cytisi
Pyrenophora dactylidis
Pyrenophora dictyoides
Pyrenophora echinopis
Pyrenophora ephemera
Pyrenophora eryngicola
Pyrenophora erythrospila
Pyrenophora euphorbiae
Pyrenophora freticola
Pyrenophora graminea
Pyrenophora graminea
Pyrenophora heraclei
Pyrenophora hordei
Pyrenophora horrida
Pyrenophora hyperici
Pyrenophora japonica
Pyrenophora kugitangi
Pyrenophora lithophila
Pyrenophora lolii
Pyrenophora macrospora
Pyrenophora metasequoiae
Pyrenophora minuertiae hirsutae
Pyrenophora moravica
Pyrenophora moroczkowskii
Pyrenophora muscorum
Pyrenophora osmanthi
Pyrenophora phlei
Pyrenophora pimpinellae
Pyrenophora pittospori
Pyrenophora polytricha
Pyrenophora pontresinerisis
Pyrenophora pulsatillae
Pyrenophora raetica
Pyrenophora rayssiae
Pyrenophora rugosa
Pyrenophora ryohicola
Pyrenophora saviczii
Pyrenophora schoeteri
Pyrenophora scholevskii
Pyrenophora scirpi
Pyrenophora scirpicola
Pyrenophora secalis
Pyrenophora semeniperda
Pyrenophora semiusta
Pyrenophora seseli
Pyrenophora seseli f. poterii
Pyrenophora subalpina
Pyrenophora sudetica
Pyrenophora suhantarctica
Pyrenophora syntrichiae
Pyrenophora szaferiana
Pyrenophora teres
Pyrenophora teres f. makulata
Pyrenophora teres subsp. graminea
Pyrenophora tetrahenae
Pyrenophora tranzschelii
Pyrenophora trifulii
Pyrenophora triticil-repentis
Pyrenophora ushuwaiensis
Pyrenophora villose
Pyrenophora graminea
Pyrenophora teres
Pyrenophora teres
Pyrenophora teres
Pyrenophora tritici repentis
Pyricularia oryzae
Pythium aphanidermatum
Pythium debaryanum
Pythium irregulare
Pythium myriotylum
Pythium ultimum
Ramularia collocygni
Rhizoctonia aerea
Rhizoctonia alba
Rhizoctonia alpina
Rhizoctonia anaticula
Rhizoctonia anomala
Rhizoctonia apocynacearum
Rhizoctonia arachnion
Rhizoctonia asclerotica
Rhizoctonia batalicola
Rhizoctonia borealis
Rhizoctonia callae
Rhizoctonia carorae
Rhizoctonia cerealis
Rhizoctonia choussii
Rhizoctonia coniothecioides
Rhizoctonia cundida
Rhizoctonia dichoroma
Rhizoctonia dimorpha
Rhizoctonia endophytica
Rhizoctonia endophytica vor. filicata
Rhizoctonia ferruginea
Rhizoctonia floccosa
Rhizoctonia fragariae
Rhizoctonia fraxini
Rhizoctonia fuliginea
Rhizoctonia fumigata
Rhizoctonia globularis
Rhizoctonia goodyerae-repentis
Rhizoctonia gossypii
Rhizoctonia gossypii vor. anatolica
Rhizoctonia gracilis
Rhizoctonia griseo
Rhizoctonia hiemalis
Rhizoctonia juniperi
Rhizoctonia lamallifera
Rhizoctonia leguminicola
Rhizoctonia lilacina
Rhizoctonia luoini
Rhizoctonia macrosclerotia
Rhizoctonia melongenae
Rhizoctonia microsclerotia
Rhizoctonia monilioides
Rhizoctonia monteithiana
Rhizoctonia muneratii
Rhizoctonia nandorii
Rhizoctonia oryzae
Rhizoctonia oryzae-sativae
Rhizoctonia pallida
Rhizoctonia pini-insignis
Rhizoctonia praticola
Rhizoctonia quercus
Rhizoctonia ramicola
Rhizoctonia robusta
Rhizoctonia rubi
Rhizoctonia ruhiginosa
Rhizoctonia sclerotica
Rhizoctonia solani
Rhizoctonia solani f. paroketea
Rhizoctonia solani forma specialis
Rhizoctonia solani var. cedri-deodorae
Rhizoctonia solani var. fuchsiae
Rhizoctonia solani var. hortensis
Rhizoctonia stahlii
Rhizoctonia subtilis var. nigra
Rhizoctonia subtlilis
Rhizoctonia tomato
Rhizoctonia tuliparum
Rhizoctonia veae
Rhizoctonia versicolor
Rhizoctonia cerealis
Rhynchosporium secalis
Sclerotina rolfsii
Sclerotinia rolfsii
Sclerotinia sclerotiorum
Septoria glycines
Septoria nodorum
Septoria tritici
Sphaerotheca fuliginea
Stagonospora nodorum
Stemphylium botryosum
Thielaviopsis basicola
Tilletia aegilopis
Tilletia aegopogonis
Tilletia ahamadiana
Tilletia airina
Tilletia ajrekari
Tilletia alopecuri
Tilletia anthaxanthi
Tilletia apludae
Tilletia armdinellae
Tilletia asperifolia
Tilletia asperitolioides
Tilletia atacamensis
Tilletia baldrati
Tilletia bambusae
Tilletia banarasae
Tilletia bangalorensis
Tilletia barclayana
Tilletia biharica
Tilletia boliviensis
Tilletia boutelouae
Tilletia brachypodii
Tilletia brachypodii-ramosi
Tilletia braomi-tectorum
Tilletia brevifaciens
Tilletia bromi
Tilletia bromina
Tilletia brunkii
Tilletia buchloeana
Tilletia bulayi
Tilletia caries
Tilletia cathcariae
Tilletia cerebrina
Tilletia chloridicola
Tilletia contaoversa
Tilletia contraversa var. prostrata
Tilletia contraversa var. elyni
Tilletia corona
Tilletia cynasuri
Tilletia damacarae
Tilletia deyeuxiae
Tilletia digitariicola
Tilletia durangensis
Tilletia earlei
Tilletia echinochlave
Tilletia echinochloae
Tilletia echinosperma
Tilletia ehrhartae
Tilletia eleusines
Tilletia elymandrae
Tilletia elymicola
Tilletia elyni
Tilletia elythrophori
Tilletia eragrostidis
Tilletia euphorbiae
Tilletia fahrendorfii
Tilletia festinca-octoflorana
Tilletia foelida
Tilletia foliicola
Tilletia fusca
Tilletia fusca var. bromi-tectorum
Tilletia fusca var. guyotiana
Tilletia fusca var. paragonica
Tilletia georfischeri
Tilletia gigaspora
Tilletia goloskokovii
Tilletia haynaldiae
Tilletia heterospora
Tilletia holci
Tilletia hordei var. spontanei
Tilletia horrida
Tilletia hyalospora var. cuzcoensis
Tilletia hyparrheniae
Tilletia indica
Tilletia iniermedia
Tilletia iovensis
Tilletia ixophari
Tilletia koeleriae
Tilletia kuznetzoviana
Tilletia laevis
Tilletia laguri
Tilletia leptochlase
Tilletia lepturi
Tilletia macrotuberculata
Tilletia madeirensis
Tilletia maglagonii
Tilletia makutensis
Tilletia milti
Tilletia milti-vernalis
Tilletia montana
Tilletia montemartinii
Tilletia nanifica
Tilletia narasimhanii
Tilletia narayanaoana
Tilletia narduri
Tilletia nigrifaciens
Tilletia obscura-reticulora
Tilletia oklahomae
Tilletia okudoirae
Tilletia oplistneni-cristati
Tilletia paae
Tilletia pachyderma
Tilletia pallida
Tilletia panici
Tilletia panici. humilis
Tilletia paonensis
Tilletia paraloxa
Tilletia paspali
Tilletia pennisetina
Tilletia peritidis
Tilletia phalaridis
Tilletia polypoganis
Tilletia prostrata
Tilletia pulcherrima var. brachiariae
Tilletia redfieldiae
Tilletia rhei
Tilletia rugispora
Tilletia sabaudiae
Tilletia salzmanii
Tilletia savilei
Tilletia scrobiculata
Tilletia setariae
Tilletia setariae-palmiflorarae
Tilletia setariicola
Tilletia sphaerococca
Tilletia sphenopie
Tilletia sphenopodis
Tilletia sterilis
Tilletia taiana
Tilletia texana
Tilletia themedae-anatherae
Tilletia themedicola
Tilletia toguateei
Tilletia trachypogonis
Tilletia transiliensis
Tilletia transvaalensis
Tilletia tritici f. monococci
Tilletia tritici var. controversa
Tilletia tritici var. nanifica
Tilletia tritici var. laevis
Tilletia tritici-repentis
Tilletia triticoides
Tilletia tuberculare
Tilletia vertiveriae
Tilletia viermotii
Tilletia vittara
Tilletia vittara var. burmahnii
Tilletia walkeri
Tilletia youngii
Tilletia zundelii
Typhula incarnata
Uromyces appendiculatus
Ustilago aaeluropodis
Ustilago abstrusa
Ustilago aegilopsidis
Ustilago affinis var. hilariae
Ustilago agrestis
Ustilago agropyrina
Ustilago agrostis-palustris
Ustilago airear-caespitosae
Ustilago alismatis
Ustilago almadina
Ustilago alopecurivara
Ustilago alsineae
Ustilago altilis
Ustilago amadelpha var. glabriuscula
Ustilago amphilophidis
Ustilago amplexa
Ustilago amthoxanthi
Ustilago andropogonis-tectorum
Ustilago aneilemae
Ustilago anhweiona
Ustilago anomala var. avicularis
Ustilago anomala var. carnea
Ustilago anomala var. cordai
Ustilago anomala var. microspora
Ustilago anomala var. muricata
Ustilago anomala var. tovarae
Ustilago apscheronica
Ustilago arabidia.alpinae
Ustilago arandinellae-hirtae
Ustilago arctica
Ustilago argentina
Ustilago aristidarius
Ustilago arotragostis
Ustilago asparagi-pygmaei
Ustilago asprellae
Ustilago avanae subsp. alba
Ustilago avenae
Ustilago avenae
Ustilago avenae f. sp. perennars
Ustilago avenariae-bryophyllae
Ustilago avicularis
Ustilago bahuichivoensis
Ustilago barbari
Ustilago beckeropsis
Ustilago belgiana
Ustilago bethelii
Ustilago bicolor
Ustilago bistortarum ustiloginea
Ustilago bistortarum var. pustulata
Ustilago boreatis
Ustilago bothriochloae
Ustilago bothriochloae-intermediae
Ustilago bouriqueti
Ustilago braziliensis
Ustilago brisae
Ustilago bromi-arvensis
Ustilago bromi-erecti
Ustilago bromi-mallis
Ustilago bromina
Ustilago bromivora f. brachypodii
Ustilago bromivora var. microspora
Ustilago bullata f. brachypodii-distachyi
Ustilago bullata var. bonariesis
Ustilago bullata var. macrospora
Ustilago bungeana
Ustilago calanagrostidis
Ustilago calanagrostidis var. scrobiculata
Ustilago calanagrostidis var. typica
Ustilago cardamines
Ustilago cariciphila
Ustilago caricis-wallichianae
Ustilago carnea
Ustilago catherimae
Ustilago caulicola
Ustilago cenrtodomis
Ustilago ceparum
Ustilago cephalariae
Ustilago chacoensis
Ustilago chloridii
Ustilago chloridionis
Ustilago chrysopoganis
Ustilago chubulensis
Ustilago cichorii
Ustilago cilmodis
Ustilago clelandii
Ustilago clintoniana
Ustilago coloradensis
Ustilago commelinae
Ustilago compacta
Ustilago concelata
Ustilago condigna
Ustilago consimilis
Ustilago constantineanui
Ustilago controversa
Ustilago conventere-sexualis
Ustilago cordai
Ustilago corlarderiae var. araucana
Ustilago coronariaw
Ustilago coronata
Ustilago courtoisii
Ustilago crus-galli var. minor
Ustilago cryptica
Ustilago curta
Ustilago custanaica
Ustilago cynodontis
Ustilago cynodontis
Ustilago cyperi-lucidi
Ustilago davisii
Ustilago deccanii
Ustilago decipiens
Ustilago deformitis
Ustilago dehiscens
Ustilago delicata
Ustilago deyeuxiae
Ustilago dianthorum
Ustilago distichlidis
Ustilago dubiosa
Ustilago dumosa
Ustilago earlei
Ustilago echinochloae
Ustilago ehrhartana
Ustilago eleocharidis
Ustilago eleusines
Ustilago elymicola
Ustilago elytrigiae
Ustilago enneapogonis
Ustilago epicampida
Ustilago eragrostidis-japanicana
Ustilago eriocauli
Ustilago eriochloae
Ustilago euphorbiae
Ustilago fagopyri
Ustilago festucae
Ustilago festucorum
Ustilago filamenticola
Ustilago fingerhuthiae
Ustilago flectens
Ustilago flonersii
Ustilago foliorum
Ustilago formosana
Ustilago fueguina
Ustilago gageae
Ustilago garcesi
Ustilago gardneri
Ustilago gausenii
Ustilago gayazana
Ustilago gigantispora
Ustilago glyceriae
Ustilago gregaria
Ustilago grossheimii
Ustilago gunnerae
Ustilago haesendocki var. chloraphorae
Ustilago haesendocki var. vargasii
Ustilago halophiloides
Ustilago haynalodiae
Ustilago heleochloae
Ustilago helictotrichi
Ustilago herteri var. Bicolor
Ustilago herteri var. vargasii
Ustilago hierochloae-adoratae
Ustilago hieronymi var. insularis
Ustilago hieronymi var. minor
Ustilago hilariicola
Ustilago hilubii
Ustilago himalensis
Ustilago histortarum var. marginalis
Ustilago hitchcockiana
Ustilago holci-avanacei
Ustilago hordei
Ustilago hordei f. sp. avenae
Ustilago hsuii
Ustilago hyalino-bipolaris
Ustilago hydropiperis
Ustilago hyparrheniae
Ustilago hypodyies f. congoensis
Ustilago hypodytes f. sporaboli
Ustilago hypodytes var. agrestis
Ustilago idonea
Ustilago imperatue
Ustilago induia
Ustilago inouyei
Ustilago intercedens
Ustilago iranica
Ustilago isachnes
Ustilago ischaemi-akoensis
Ustilago ischaemi-anthephoroides
Ustilago ixiolirii
Ustilago ixophori
Ustilago jacksonii
Ustilago jacksonii var. vintonesis
Ustilago jaczevskyana
Ustilago jaczevskyana van. typica
Ustilago jaczevskyana var. sibirica
Ustilago jagdishwari
Ustilago jamalainentii
Ustilago jehudana
Ustilago johnstonii
Ustilago kairamoi
Ustilago kasuchstemica
Ustilago kenjiana
Ustilago kweichowensis
Ustilago kylingae
Ustilago lacjrymae-jobi
Ustilago lepyrodiclidis
Ustilago lidii
Ustilago liebenbergii
Ustilago linderi
Ustilago linearis
Ustilago lirove
Ustilago loliicola
Ustilago longiflora
Ustilago longiseti
Ustilago longissima var. dubiosa
Ustilago longissima var. paludificans
Ustilago longissima var. typica
Ustilago lupini
Ustilago lychnidis-dioicae
Ustilago lycoperdiformis
Ustilago lyginiae
Ustilago machili
Ustilago machringiae
Ustilago magalaspora
Ustilago magellanica
Ustilago mariscana
Ustilago maydis
Ustilago melicae
Ustilago merxmuellerana
Ustilago mesatlantica
Ustilago michnoana
Ustilago microspora
Ustilago microspora var. paspalicola
Ustilago microstegii
Ustilago microthelis
Ustilago milli
Ustilago mobtagnei var. minor
Ustilago modesta
Ustilago moenchiae-manticae
Ustilago monermae
Ustilago morinae
Ustilago morobiana
Ustilago mrucata
Ustilago muda
Ustilago muehlenbergiae var. lucumanensis
Ustilago muscaribotryoidis
Ustilago nagarnyi
Ustilago nannfeldtii
Ustilago nauda var. hordei
Ustilago nelsoniana
Ustilago nepalensis
Ustilago neyraudiae
Ustilago nigra
Ustilago nivalis
Ustilago nuda
Ustilago nuda
Ustilago nuda var. tritici
Ustilago nyassae
Ustilago okudairae
Ustilago olida
Ustilago olivacea var. macrospora
Ustilago onopordi
Ustilago onumae
Ustilago opiziicola
Ustilago oplismeni
Ustilago orientalis
Ustilago otophora
Ustilago ovariicola
Ustilago overcemii
Ustilago pamirica
Ustilago panici-geminati
Ustilago panjabensis
Ustilago pappophori
Ustilago pappophori var. magdalensis
Ustilago parasnothii
Ustilago parodii
Ustilago parvula
Ustilago paspalidiicola
Ustilago patagonica
Ustilago penniseti var. verruculosa
Ustilago perrara
Ustilago persicariae
Ustilago petrakii
Ustilago phalaridis
Ustilago phlei
Ustilago phlei-protensis
Ustilago phragmites
Ustilago picacea
Ustilago pimprina
Ustilago piperi (var.) rosulata
Ustilago poae
Ustilago poae-bulbosae
Ustilago poae-nemoralis
Ustilago polygoni-alati
Ustilago polygoni-alpini
Ustilago polygoni-punctari
Ustilago polygoni-serrulati
Ustilago polytocae
Ustilago polytocae-harbatas
Ustilago pospelovii
Ustilago prostrata
Ustilago pseudohieronymi
Ustilago puehlaensis
Ustilago puellaris
Ustilago pulvertulensa
Ustilago raciborskiana
Ustilago radians
Ustilago ravida
Ustilago rechingeri
Ustilago reticulara
Ustilago reticulispora
Ustilago rhei
Ustilago rhynchelytri
Ustilago ruandenis
Ustilago ruberculata
Ustilago sabouriana
Ustilago salviae
Ustilago sanctae-catharinae
Ustilago scaura
Ustilago scillae
Ustilago scitaminea
Ustilago scitaminea var. sacchar-officinorum
Ustilago scleranthi
Ustilago scrobiculata
Ustilago scutulata
Ustilago secalis var. elymi
Ustilago seitaminea var. sacchari-barberi
Ustilago semenoviana
Ustilago serena
Ustilago serpens
Ustilago sesleriae
Ustilago setariae-mambassanae
Ustilago shastensis
Ustilago shimadae
Ustilago silenes-inflatae
Ustilago silenes-nutantis
Ustilago sinkiangensis
Ustilago sitanil
Ustilago sleuneri
Ustilago sonoriana
Ustilago sorghi-stipoidei
Ustilago spadicea
Ustilago sparoboli-indici
Ustilago sparti
Ustilago speculariae
Ustilago spegazzinii
Ustilago spegazzinii var. agrestis
Ustilago spermophora var. orientalis
Ustilago spermophoroides
Ustilago spinulosa
Ustilago sporoboli-trenuli
Ustilago stellariae
Ustilago sterilis
Ustilago stewartli
Ustilago stipae
Ustilago striaeformis f. phlei
Ustilago striaeformis f. poa . . .
Ustilago striaeformis f. poae-pratensis
Ustilago striiformis f. hierochloes-odoratae
Ustilago striiformis var. agrostidis
Ustilago striiformis var. dactylidis
Ustilago striiformis var. holci
Ustilago striiformis var. phlei
Ustilago striiformis var. poae
Ustilago sumnevicziana
Ustilago superha
Ustilago sydowiana
Ustilago symbiotica
Ustilago taenia
Ustilago taiana
Ustilago tanakue
Ustilago tenuispora
Ustilago thaxteri
Ustilago tinontiae
Ustilago togata
Ustilago tournenxii
Ustilago tovarae
Ustilago trachophora var. pacifica
Ustilago trachyniae
Ustilago trachypogonis
Ustilago tragana
Ustilago tragi
Ustilago tragica
Ustilago tragi-racemosi
Ustilago trichoneurana
Ustilago trichophora var. crus-galli
Ustilago trichophora var. panici-frumentacei
Ustilago triseti
Ustilago tritici forma specialis
Ustilago tucumariensis
Ustilago tumeformis
Ustilago turcomanica
Ustilago turcomanica var. prostrata
Ustilago turcomanica var. typica
Ustilago ugamica
Ustilago ugandensis var. macrospora
Ustilago underwoodii
Ustilago urginede
Ustilago urochloana
Ustilago ustilaginea
Ustilago ustriculosa var. cordai
Ustilago ustriculosa var. reticulata
Ustilago valentula
Ustilago vavilori
Ustilago verecunda
Ustilago verruculosa
Ustilago versatilis
Ustilago vetiveriae
Ustilago violaceo-irregularis
Ustilago violaceu var. stellariae
Ustilago violaceuverrucosa
Ustilago williamsii
Ustilago wynaadensis
Ustilago zambettakisii
Ustilago zernae
Venturia inaequalis
Xanthomonas campestris
Xanthomonas oryzae

The 1-methylpyrazol-4-ylcarboxanilides I and the combinations of compounds I and II and optionally III are particularly suitable for controlling phytopathogenic fungi in barley (e.g. Pyrenophora teres, Rhynchosporium secalis, Puccinia hordei, Puccinia striiformis, Blumeria graminis, Ramularia collo-cygni/Physiological leaf spots, Microdochium nivale, Typhula incarnata, Pseudocercosporella herpotrichoides, Fusarium culmorum, Rhizoctonia cerealis, Gaeumannomyces graminis) and soybeans (e.g. Phakopsora pachyrhizi, Microsphaera diffusa, Septoria glycines, Cercospora sojina, Cercospora kikuchii, Corynespora cassiicola, Colletotrichum truncatum, Peronospora manshurica, Alternaria spp., Phomopsis phaseoli, Diaporthe phaseolorum, Phialophora gregata, Fusarium solani, Sclerotinia sclerotiorum, Sclerotinia rolfsii, Phytopthora megasperma, Rhizoctonia solani, Dematophora necatrix, Macrophomina phaseolina).

The 1-methylpyrazol-4-ylcarboxanilides I where X is fluorine and their combinations with compounds II, are particularly suitable for controlling phytopathogenic fungi in barley as mentioned above. For example, N-(3′,4′-dichloro-5-fluorobiphenyl-2-yl)-1-methyl-3-difluoromethyl-1H-pyrazole-4-carboxamide, solo or in combination with an active compound II, exhibits an excellent activity against Ramularia collo-cygni/Physiological leaf spots.

The combinations according to the invention are furthermore suitable for controlling harmful fungi in the protection of materials (for example wood, paper, paint dispersions, fibers or fabrics) and in the protection of stored products. In the protection of wood, particular attention is paid to the following harmful fungi: Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp., additionally in the protection of materials the following yeasts: Candida spp. and Saccharomyces cerevisae.

Application of the inventive combinations to useful plants may also lead to an increase in the crop yield.

The compound(s) I and at least one of the active compounds II can be applied simultaneously, that is jointly or separately, or in succession, the sequence, in the case of separate application, generally not having any effect on the result of the control measures.

When preparing the mixtures, it is preferred to employ the pure active compounds I and II, to which further compounds active against harmful fungi or other pests, such as insects, arachnids or nematodes, or else herbicidal or growth-regulating active compounds or fertilizers can be added.

Usually, mixtures of a compound I and one active compound II are employed. However, in certain cases mixtures of at least one compound I with two or, if appropriate, more active components may be advantageous.

Suitable further active components in the above sense are in particular the active compounds II, mentioned at the outset, or fipronil, and in particular the preferred active compounds II mentioned above.

The compound(s) I and the active compound(s) II are usually employed in a weight ratio of from 100:1 to 1:100, preferably from 20:1 to 1:20, in particular from 10:1 to 1:10.

The further active components are, if desired, added in a ratio of from 20:1 to 1:20 to the compound I.

Depending on the type of compound and the desired effect, the application rates of the mixtures according to the invention, in particular in the case of agricultural crop areas, are from 5 g/ha to 2000 g/ha, preferably from 20 to 1500 g/ha, in particular from 50 to 1000 g/ha.

Correspondingly, the application rates for the compound I are generally from 1 to 1000 g/ha, preferably from 10 to 900 g/ha, in particular from 20 to 750 g/ha.

Correspondingly, the application rates for the active compound II are generally from 1 to 2000 g/ha, preferably from 10 to 1500 g/ha, in particular from 40 to 1000 g/ha.

In the treatment of seed, application rates of mixture are generally from 1 to 1000 g per 100 kg of seed, preferably from 1 to 750 g per 100 kg, in particular from 5 to 500 g per 100 kg of seed.

The method for controlling harmful fungi is carried out by the separate or joint application of a compound I or compounds I and active compound(s) II or a mixture of a compound I or compounds I and at least one active compound II by spraying or dusting the seeds, the plants or the soils before or after sowing of the plants or before or after emergence of the plants.

The mixtures according to the invention, or the compound(s) I and at least one active compound II, can be converted into the customary formulations, for example solutions, emulsions, suspensions, dusts, powders, pastes and granules. The use form depends on the particular intended purpose; in each case, it should ensure a fine and even distribution of the mixture according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso® products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water

A) Water-Soluble Concentrates (SL)

10 parts by weight of a mixture according to the invention are dissolved in 90 parts by weight of water or in a water-soluble solvent. As an alternative, wetting agents or other auxiliaries are added. The active compound dissolves upon dilution with water. In this way, a formulation having a content of 10% by weight of active compound is obtained.

B) Dispersible Concentrates (DC)

20 parts by weight of a mixture according to the invention are dissolved in 70 parts by weight of cyclohexanone with addition of 10 parts by weight of a dispersant, for example polyvinylpyrrolidone. Dilution with water gives a dispersion. The active compound content is 20% by weight.

C) Emulsifiable Concentrates (EC)

15 parts by weight of a mixture according to the invention are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D) Emulsions (EW, EO)

25 parts by weight of a mixture according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The formulation has an active compound content of 25% by weight.

E) Suspensions (SC, OD)

In an agitated ball mill, 20 parts by weight of a mixture according to the invention are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of a mixture according to the invention are ground finely with addition of 50 parts by weight of dispersants and wetting agents and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP)

75 parts by weight of a mixture according to the invention are ground in a rotor-stator mill with addition of 25 parts by weight of dispersants, wetting agents and silica gel. Dilution with water gives a stable dispersion or solution of the active compound. The active compound content of the formulation is 75% by weight.

2. Products to be Applied Undiluted

H) Dustable Powders (DP)

5 parts by weight of a mixture according to the invention are ground finely and mixed intimately with 95 parts by weight of finely divided kaolin. This gives a dustable product having an active compound content of 5% by weight.

J) Granules (GR, FG, GG, MG)

0.5 part by weight of a mixture according to the invention is ground finely and associated with 99.5 parts by weight of carriers. Current methods are extrusion, spray-drying or the fluidized bed. This gives granules to be applied undiluted having an active compound content of 0.5% by weight.

K) ULV Solutions (UL)

10 parts by weight of a mixture according to the invention are dissolved in 90 parts by weight of an organic solvent, for example xylene. This gives a product to be applied undiluted having an active compound content of 10% by weight.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetting agents or adjuvants may be added to the active compounds, even, if appropriate, not until immediately prior to use (tank mix). These agents are typically admixed with the compositions according to the invention in a weight ratio of from 1:100 to 100: 1, preferably from 1:10 to 10:1.

Suitable adjuvants in this sense are in particular: organically modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctylsulfosuccinate, for example Leophen RA®.

The compounds I and II or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be before or after the infection by harmful fungi.

The fungicidal action of the individual compounds and of the mixtures according to the invention was demonstrated by the tests below.

The active compounds, separately or jointly, were prepared as a stock solution comprising 25 mg of active compound which was made up to 10 ml using a mixture of acetone and/or DMSO and the emulsifier Uniperol® EL (wetting agent having an emulsifying and dispersing action based on ethoxylated alkylphenols) in a ratio by volume of solvent/emulsifier of 99:1. The mixture was then made up to 100 ml with water. This stock solution was diluted with the solvent/emulsifier/water mixture described to give the concentration of active compound stated below.

The visually determined percentages of infected leaf areas were converted into efficacies in % of the untreated control:

The efficacy (E) is calculated as follows using Abbot's formula:

E=(1−α/β)·100

α corresponds to the fungicidal infection of the treated plants in % and

β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of active compound combinations were determined using Colby's formula (Colby, S. R. “Calculating synergistic and antagonistic responses of herbicide combinations”, Weeds, 15, pp. 20-22, 1967) and compared with the observed efficacies.

Colby's formula: E=x+y−x·y/100
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

### USE EXAMPLE 1

### Preventative Fungicidal Contro; of Early Blight on Tomatoes (Alternaria solani)

Young seedlings of tomato plants were grown in pots. These plants were sprayed to run-off with an aqueous suspension, containing the concentration of active ingredient or mixture mentioned in the table below. The next day, the treated plants were inoculated with an aqueous suspension of Alternaria solani. Then the trial plants were immediately transferred to a humid chamber. After 5 days at 20 to 22° C. and a relative humidity close to 100%, the extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (90% infection) | — |
| No. Id.344 | 1 | — | 0 | — |
| No. Im.1010 | 1 | — | 56 | — |
| | 0.25 | — | 0 | — |
| N′-(4-(4-fluoro-3- | 0.25 | — | 0 | |
| trifluoromethyl-phenoxy)-2,5- | | | | |
| dimethyl-phenyl)-N-ethyl-N- | | | | |
| methyl formamidine | | | | |
| N′-(4-(4-chloro-3- | 0.25 | — | 22 | — |
| trifluoromethyl-phenoxy)-2,5- | 0.063 | — | 0 | — |
| dimethyl-phenyl)-N-ethyl-N- | | | | |
| methyl formamidine | | | | |
| azaconazole | 0.25 | — | 0 | — |
| | 0.063 | — | 0 | — |
| No. Id.344 + azaconazole | 1 + 0.25 | 4:1 | 44 | 0 |
| No. Im.1010 + N′-(4-(4-fluoro- | 0.25 + 0.25 | 1:1 | 56 | 0 |
| 3-trifluoromethyl-phenoxy)-2,5- | | | | |
| dimethyl-phenyl)-N-ethyl-N- | | | | |
| methyl formamidine | | | | |
| No. Im.1010 + N′-(4-(4- | 1 + 0.25 | 4:1 | 89 | 65 |
| chloro-3-trifluoromethyl- | 0.25 + 0.063 | 4:1 | 44 | 0 |
| phenoxy)-2,5-dimethyl-phenyl)- | | | | |
| N-ethyl-N-methyl formamidine | | | | |
| No. Im.1010 + azaconazole | 0.25 + 0.063 | 4:1 | 72 | 0 |

The test results show that, by virtue of the synergism, the mixtures according to the invention are considerably more active than had been predicted using Colby's formula.

### USE EXAMPLE 2

### Preventative Control of Grey Mold (Botrytis cinerea) on Leaves of Green Pepper

Young seedlings of green pepper were grown in pots to the 2 to 3 leaf stage. These plants were sprayed to run-off with an aqueous suspension, containing the concentration of active ingredient or their mixture mentioned in the table below. The next day the treated plants were inoculated with a spore suspension of Botrytis cinerea in a 2% aqueous biomalt solution. Then the trial plants were immediately transferred to a dark, humid chamber. After 5 days at 22 to 24° C. and a relative humidity close to 100% the extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (90% infection) | — |
| No. Id.344 | 16 | — | 72 | — |
| | 0.25 | — | 11 | — |
| No. Im.1010 | 16 | — | 33 | — |
| N-(2-(1,3-dimethylbutyl)- | 4 | — | 0 | — |
| phenyl)-1,3-dimethyl-5-fluoro- | | | | |
| 1H-pyrazole-4-carboxylic acid | | | | |
| amide | | | | |
| azaconazole | 4 | — | 0 | — |
| | 0.063 | — | 0 | — |
| No. Id.344 + N-(2-(1,3- | 16 + 4 | 4:1 | 92 | 72 |
| dimethylbutyl)-phenyl)-1,3- | | | | |
| dimethyl-5-fluoro-1H- | | | | |
| pyrazole-4-carboxylic acid | | | | |
| amide | | | | |
| No. Id.344 + azaconazole | 0.25 + 0.063 | 4:1 | 67 | 11 |
| No. Im.1010 + N-(2-(1,3- | 16 + 4 | 4:1 | 83 | 33 |
| dimethylbutyl)-phenyl)-1,3- | | | | |
| dimethyl-5-fluoro-1H- | | | | |
| pyrazole-4-carboxylic acid | | | | |
| amide | | | | |
| No. Im.1010 + azaconazole | 16 + 4 | 4:1 | 78 | 33 |

The test results show that, by virtue of the synergism, the mixtures according to the invention are considerably more active than had been predicted using Colby's formula.

### USE EXAMPLE 3

### Contro; of Late Blight on Tomatoes Caused by Phytophthora infestans

Young seedlings of tomato plants were grown in pots. These plants were sprayed to run-off with an aqueous suspension, containing the concentration of active ingredient or their mixture mentioned in the table below. The next day, the treated plants were inoculated with an aqueous suspension of sporangia of Phytophthora infestans. After inoculation, the trial plants were immediately transferred to a humid chamber. After 6 days at 18 to 20° C. and a relative humidity close to 100% the extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (90% infection) | — |
| No. Id.344 | 4 | — | 0 | — |
| | 1 | — | 0 | — |
| No. Im.1010 | 16 | — | 0 | — |
| | 4 | — | 0 | — |
| N′-(4-(4-fluoro-3- | 16 | — | 0 | — |
| trifluoromethyl-phenoxy)-2,5- | | | | |
| dimethyl-phenyl)-N-ethyl-N- | | | | |
| methyl formamidine | | | | |
| N′-(4-(4-chloro-3- | 1 | — | 0 | — |
| trifluoromethyl-phenoxy)-2,5- | | | | |
| dimethyl-phenyl)-N-ethyl-N- | | | | |
| methyl formamidine | | | | |
| N-(2-(1,3-dimethylbutyl)- | 4 | — | 0 | — |
| phenyl)-1,3-dimethyl-5-fluoro- | 1 | — | 0 | — |
| 1H-pyrazole-4-carboxylic acid | | | | |
| amide | | | | |
| azaconazole | 4 | — | 0 | — |
| | 0.063 | — | 0 | — |
| No. Id.344 + N-(2-(1,3- | 4 + 4 | 1:1 | 44 | 0 |
| dimethylbutyl)-phenyl)-1,3- | 1 + 1 | 1:1 | 22 | 0 |
| dimethyl-5-fluoro-1H-pyrazole- | | | | |
| 4-carboxylic acid amide | | | | |
| No. Im.1010 + N′-(4-(4-fluoro- | 16 + 16 | 1:1 | 44 | 11 |
| 3-trifluoromethyl-phenoxy)-2,5- | | | | |
| di-methyl-phenyl)-N-ethyl-N- | | | | |
| methyl formamidine | | | | |
| No. Im.1010 + N′-(4-(4- | 4 + 1 | 4:1 | 83 | 0 |
| chloro-3-trifluoromethyl- | | | | |
| phenoxy)-2,5-dimethyl-phenyl)- | | | | |
| N-ethyl-N-methyl formamidine | | | | |
| No. Im.1010 + N-(2-(1,3- | 16 + 4 | 4:1 | 33 | 0 |
| dimethylbutyl)-phenyl)-1,3- | | | | |
| dimethyl-5-fluoro-1H-pyrazole- | | | | |
| 4-carboxylic acid amide | | | | |

The test results show that, by virtue of the synergism, the mixtures according to the invention are considerably more active than had been predicted using Colby's formula.

### USE EXAMPLE 4

### Control of Powdery Mildew on Wheat Caused by Blumeria graminis f. sp. tritici

The first fully developed leaves of pot grown wheat were sprayed to run-off with an aqueous suspension, containing the concentration of active ingredient or their mixture mentioned in the table below. The next day the treated plants were inoculated with spores of Blumeria graminis f. sp. tritici (=syn. Erysiphe garminis f. sp. tritici) by shaking heavily infestated stock plants over the treated pots. After cultivation in the greenhouse for 7 days at 22-26° C. and a relative humidity between 60 to 90% the extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (80% infection) | — |
| No. Id.344 | 1 | — | 25 | — |
| | 0.25 | — | 0 | — |
| No. Im.1010 | 0.25 | — | 0 | — |
| N′-(4-(4-fluoro-3- | 0.25 | — | 38 | — |
| trifluoromethyl-phenoxy)-2,5- | | | | |
| dimethyl-phenyl)-N-ethyl-N- | | | | |
| methyl formamidine | | | | |
| N′-(4-(4-chloro-3- | 0.063 | — | 38 | — |
| trifluoromethyl-phenoxy)-2,5- | | | | |
| dimethyl-phenyl)-N-ethyl-N- | | | | |
| methyl formamidine | | | | |
| No. Id.344 + N′-(4-(4-fluoro- | 0.25 + 0.25 | 1:1 | 63 | 38 |
| 3-trifluoromethyl-phenoxy)-2,5- | 1 + 0.25 | 4:1 | 88 | 53 |
| dimethyl-phenyl)-N-ethyl-N- | | | | |
| methyl formamidine | | | | |
| No. Id.344 + N′-(4-(4-chloro- | 0.25 + 0.063 | 4:1 | 83 | 38 |
| 3-trifluoromethyl-phenoxy)-2,5- | | | | |
| dimethyl-phenyl)-N-ethyl-N- | | | | |
| methyl formamidine | | | | |
| No. Im.1010 + N′-(4-(4-fluoro- | 0.25 + 0.25 | 1:1 | 81 | 38 |
| 3-trifluoromethyl-phenoxy)-2,5- | | | | |
| dimethyl-phenyl)-N-ethyl-N- | | | | |
| methyl formamidine | | | | |

The test results show that, by virtue of the synergism, the mixtures according to the invention are considerably more active than had been predicted using Colby's formula.

### USE EXAMPLE 5

### Curative Control of Brown Rust on Wheat Caused by Puccinia recondita

The first two developed leaves of pot-grown wheat seedling were dusted with spores of Puccinia recondita. To ensure the success the artificial inoculation, the plants were transferred to a humid chamber without light and a relative humidity of 95 to 99% and 20 to 22° C. for 24 h. The next day the plants were sprayed to run-off with an aqueous suspension, containing the concentration of active ingredient or their mixture as described below. The plants were allowed to air-dry. Then the trial plants were cultivated for 8 days in a greenhouse chamber at 22-26° C. and a relative humidity between 65 and 70%. The extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (90% infection) | — |
| No. Id.344 | 1 | — | 56 | — |
| No. Im.1010 | 4 | — | 78 | — |
| | 1 | — | 33 | — |
| | 0.25 | — | 0 | — |
| N′-(4-(4-fluoro-3- | 0.25 | — | 67 | — |
| trifluoromethyl-phenoxy)-2,5- | | | | |
| dimethyl-phenyl)-N-ethyl-N- | | | | |
| methyl formamidine | | | | |
| N′-(4-(4-chloro-3- | 0.063 | — | 0 | — |
| trifluoromethyl-phenoxy)-2,5- | | | | |
| dimethyl-phenyl)-N-ethyl-N- | | | | |
| methyl formamidine | | | | |
| N-(2-(1,3-dimethylbutyl)- | 1 | — | 0 | — |
| phenyl)-1,3-dimethyl-5-fluoro- | 0.25 | — | 0 | — |
| 1H-pyrazole-4-carboxylic acid | | | | |
| amide | | | | |
| azaconazole | 0.25 | — | 0 | — |
| No. Id.344 + N-(2-(1,3- | 1 + 1 | 1:1 | 78 | 56 |
| dimethylbutyl)-phenyl)-1,3- | | | | |
| dimethyl-5-fluoro-1H-pyrazole- | | | | |
| 4-carboxylic acid amide | | | | |
| No. Im.1010 + N′-(4-(4-fluoro- | 0.25 + 0.25 | 1:1 | 92 | 67 |
| 3-trifluoromethyl-phenoxy)-2,5- | | | | |
| dimethyl-phenyl)-N-ethyl-N- | | | | |
| methyl formamidine | | | | |
| No. Im.1010 + N′-(4-(4- | 0.25 + 0.063 | 4:1 | 22 | 0 |
| chloro-3-trifluoromethyl- | | | | |
| phenoxy)-2,5-dimethyl-phenyl)- | | | | |
| N-ethyl-N-methyl formamidine | | | | |
| No. Im.1010 + N-(2-(1,3- | 4 + 1 | 4:1 | 100 | 78 |
| dimethylbutyl)-phenyl)-1,3- | 1 + 0.25 | 4:1 | 67 | 33 |
| dimethyl-5-fluoro-1H-pyrazole- | | | | |
| 4-carboxylic acid amide | | | | |
| No. Im.1010 + azaconazole | 1 + 0.25 | 4:1 | 78 | 33 |

The test results show that, by virtue of the synergism, the mixtures according to the invention are considerably more active than had been predicted using Colby's formula.

### USE EXAMPLE 6

### Preventative Control of Brown Rust on Wheat Caused by Puccinia recondita

The first two developed leaves of pot-grown wheat seedling were sprayed to run-off with an aqueous suspension, containing the concentration of active ingredient or their as described below. The next day the plants were inoculated with spores of Puccinia recondita. To ensure the success the artificial inoculation, the plants were transferred to a humid chamber without light and a relative humidity of 95 to 99% and 20 to 22° C. for 24 h. Then the trial plants were cultivated for 6 days in a greenhouse chamber at 22-26° C. and a relative humidity between 65 and 70%. The extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (80% infection) | — |
| No. Id.344 | 0.25 | — | 0 | — |
| N′-(4-(4-chloro-3- | 0.063 | — | 38 | — |
| trifluoromethyl-phenoxy)-2,5- | | | | |
| dimethyl-phenyl)-N-ethyl-N- | | | | |
| methyl formamidine | | | | |
| azaconazole | 0.25 | — | 0 | — |
| No. Id.344 + N′-(4-(4-chloro- | 0.25 + 0.063 | 4:1 | 63 | 38 |
| 3-trifluoromethyl-phenoxy)-2,5- | | | | |
| dimethyl-phenyl)-N-ethyl-N- | | | | |
| methyl formamidine | | | | |
| No. Id.344 + azaconazole | 0.25 + 0.25 | 1:1 | 25 | 0 |

The test results show that, by virtue of the synergism, the mixtures according to the invention are considerably more active than had been predicted using Colby's formula.

### USE EXAMPLE 7

### Control of Net Blotch on Barley Caused by Pyrenophora teres

The first fully developed leaves of pot grown barley plants were sprayed to run-off with an aqueous suspension, containing the concentration of active ingredient or their mentioned in the table below. The next day the treated plants were inoculated with an aqueous spore suspension of Pyrenophora (syn. Drechslera) teres. Then the trial plants were immediately transferred to a humid chamber in the greenhouse. After 6 days of cultivation at 20-24° C. and a relative humidity close to 70%, the extent of fungal attack on the leaves was visually assessed as % leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (80% infection) | — |
| No. Id.344 | 0.25 | — | 50 | — |
| N′-(4-(4-fluoro-3- | 1 | — | 13 | |
| trifluoromethyl-phenoxy)-2,5- | | | | |
| dimethyl-phenyl)-N-ethyl-N- | | | | |
| methyl formamidine | | | | |
| N′-(4-(4-chloro-3- | 0.25 | — | 25 | — |
| trifluoromethyl-phenoxy)-2,5- | | | | |
| dimethyl-phenyl)-N-ethyl-N- | | | | |
| methyl formamidine | | | | |
| No. Id.344 + N′-(4-(4-fluoro- | 0.25 + 1 | 1:4 | 88 | 56 |
| 3-trifluoromethyl-phenoxy)-2,5- | | | | |
| dimethyl-phenyl)-N-ethyl-N- | | | | |
| methyl formamidine | | | | |
| No. Id.344 + N′-(4-(4-chloro- | 0.25 + 0.25 | 1:1 | 99 | 63 |
| 3-trifluoromethyl-phenoxy)-2,5- | | | | |
| dimethyl-phenyl)-N-ethyl-N- | | | | |
| methyl formamidine | | | | |

The test results show that, by virtue of the synergism, the mixtures according to the invention are considerably more active than had been predicted using Colby's formula.

### USE EXAMPLE 8

### Curative Control of Soy Bean Rust On Soy Beans Caused by Phakopsora pachyrhizi

Leaves of pot-grown soy bean seedlings were inoculated with spores of Phakopsora pachyrhizi. To ensure the success the artificial inoculation, the plants were transferred to a humid chamber with a relative humidity of about 95% and 23 to 27° C. for 24 h. The next day the plants were sprayed to run-off with an aqueous suspension, containing the concentration of active ingredient or their mixture as described below. The plants were allowed to air-dry. Then the trial plants were cultivated for 14 days in a greenhouse chamber at 23-27° C. and a relative humidity between 60 and 80%. The extent of fungal attack on the leaves was visually assessed as % diseased leaf area.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| (Control) | — | — | 0 (70% infection) | — |
| No. Id.344 | 0.25 | — | 0 | — |
| No. Im.1010 | 1 | — | 0 | — |
| | 0.25 | — | 0 | — |
| N′-(4-(4-chloro-3- | 0.063 | — | 29 | — |
| trifluoromethyl-phenoxy)-2,5- | | | | |
| dimethyl-phenyl)-N-ethyl-N- | | | | |
| methyl formamidine | | | | |
| N-(2-(1,3-dimethylbutyl)- | 0.25 | — | 60 | — |
| phenyl)-1,3-dimethyl-5-fluoro- | | | | |
| 1H-pyrazole-4-carboxylic acid | | | | |
| amide | | | | |
| azaconazole | 0.063 | — | 57 | — |
| No. Id.344 + N′-(4-(4-chloro- | 0.25 + 0.063 | 4:1 | 93 | 29 |
| 3-trifluoromethyl-phenoxy)-2,5- | | | | |
| dimethyl-phenyl)-N-ethyl-N- | | | | |
| methyl formamidine | | | | |
| No. Id.344 + azaconazole | 0.25 + 0.063 | 4:1 | 79 | 57 |
| No. Im.1010 + N′-(4-(4- | 0.25 + 0.063 | 4:1 | 79 | 29 |
| chloro-3-trifluoromethyl- | | | | |
| phenoxy)-2,5-dimethyl-phenyl)- | | | | |
| N-ethyl-N-methyl formamidine | | | | |
| No. Im.1010 + N-(2-(1,3- | 1 + 0.25 | 4:1 | 57 | 14 |
| dimethylbutyl)-phenyl)-1,3- | | | | |
| dimethyl-5-fluoro-1H-pyrazole- | | | | |
| 4-carboxylic acid amide | | | | |
| No. Im.1010 + azaconazole | 0.25 + 0.063 | 4:1 | 100 | 57 |

The test results show that, by virtue of the synergism, the mixtures according to the invention are considerably more active than had been predicted using Colby's formula.

### USE EXAMPLE 9

### Microtest

The active compounds were formulated separately as a stock solution having a concentration of 10000 ppm in dimethyl sulfoxide.

Benalaxyl-M was used as commercial finished formulation and diluted with water to the stated concentration of the active compound.

The measured parameters were compared to the growth of the active compound-free control variant (100%) and the fungus-free and active compound-free blank value to determine the relative growth in % of the pathogens in the respective active compounds. These percentages were converted into efficacies.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

### 9.1: Activity Against the Late Blight Pathogen Phytophthora infestans in the Microtiter Test

The stock solutions were mixed according to the ratio, pipetted onto a micro titer plate (MTP) and diluted with water to the stated concentrations. A spore suspension of Phytophtora infestans containing a pea juice-based aqueous nutrient medium was then added. The plates were placed in a water vapor-saturated chamber at a temperature of 18° C. Using an absorption photometer, the MTPs were measured at 405 nm 7 days after the inoculation.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| No. Ia.719 | 16 | — | 4 | — |
| No. Id.344 | 16 | — | 5 | — |
| No. Im.1010 | 16 | — | 4 | — |
| benalaxyl-M | 16 | — | 18 | — |
| N′-(4-(4-chloro-3- | 4 | — | 33 | — |
| trifluoromethyl-phenoxy)-2,5- | | | | |
| dimethyl-phenyl)-N-ethyl-N- | | | | |
| methyl formamidine | | | | |
| No. Ia.719 + N′-(4-(4-chloro- | 16 + 4 | 4:1 | 68 | 36 |
| 3-trifluoromethyl-phenoxy)-2,5- | | | | |
| dimethyl-phenyl)-N-ethyl-N- | | | | |
| methyl formamidine | | | | |
| No. Id.344 + benalaxyl-M | 16 + 16 | 1:1 | 90 | 22 |
| No. Im.1010 + N′-(4-(4- | 16 + 4 | 4:1 | 85 | 28 |
| chloro-3-trifluoromethyl- | | | | |
| phenoxy)-2,5-dimethyl-phenyl)- | | | | |
| N-ethyl-N-methyl formamidine | | | | |

### 9.2: Activity Against the Grey Mold Botrytis cinerea in the Microtiterplate Test

The stock solutions were mixed according to the ratio, pipetted onto a micro titer plate (MTP) and diluted with water to the stated concentrations. A spore suspension of Botrytis cinerea in 2% aqueous biomalt solution was then added. The plates were placed in a water vapor-saturated chamber at a temperature of 18° C. Using an absorption photometer, the MTPs were measured at 405 nm 7 days after the inoculation.

| | | | | Activity calculated |
|---|---|---|---|---|
| | | | Observed | according |
| Active compounds/active | Concentration | | activity | to |
| compound mixture | [ppm] | Ratio | (% infection) | Colby (%) |
| No. Im.1010 | 0.063 | — | 46 | — |
| benalaxyl-M | 0.063 | — | 6 | — |
| fluopyram | 0.004 | — | 4 | — |
| piperalin | 0.016 | — | 12 | — |
| nitrapyrin | 0.016 | — | 10 | — |
| No. Im.1010 + benalaxyl-M | 0.063 + 0.063 | 1:1 | 74 | 49 |
| No. Im.1010 + fluopyram | 0.063 + 0.004 | 16:1 | 75 | 48 |
| No. Im.1010 + piperalin | 0.063 + 0.016 | 4:1 | 76 | 53 |
| No. Im.1010 + nitrapyrin | 0.063 + 0.016 | 4:1 | 79 | 52 |

### 9.3: Activity Against Rice Blast Pyricularia oryzae in the Microtiterplate Test

The stock solutions were mixed according to the ratio, pipetted onto a micro titer plate (MTP) and diluted with water to the stated concentrations. A spore suspension of Pyricularia oryzae in 2% aqueous biomalt solution was then added. The plates were placed in a water vapor-saturated chamber at a temperature of 18° C. Using an absorption photometer, the MTPs were measured at 405 nm 7 days after the inoculation.

| | | | | Activity |
|---|---|---|---|---|
| Active | | | | calculated |
| compounds/ | | | Observed | according |
| active | Concentration | | activity | to |
| compound mixture | [ppm] | Ratio | (% infection) | Colby (%) |
| No. Id.344 | 0.25 | — | 1 | — |
| benalaxyl-M | 0.25 | — | 0 | — |
| No. Id.344 + | 0.25 + 0.25 | 1:1 | 99 | 1 |
| benalaxyl-M | | | | |

### 9.4: Activity Against Leaf Blotch on Wheat Caused by Septoria tritici

The stock solutions were mixed according to the ratio, pipetted onto a micro titer plate (MTP) and diluted with water to the stated concentrations. A spore suspension of Septoria tritici in 2% aqueous biomalt solution was then added. The plates were placed in a water vapor-saturated chamber at a temperature of 18° C. Using an absorption photometer, the MTPs were measured at 405 nm 7 days after the inoculation.

| | | | Observed | Activity calculated |
|---|---|---|---|---|
| Active compounds/active | Concentration | | activity | according to |
| compound mixture | [ppm] | Ratio | (% infection) | Colby (%) |
| No. Ia.719 | 0.063 | — | 36 | — |
| No. Ia.344 | 0.063 | — | 65 | |
| No. Id.667 | 0.063 | — | 43 | |
| azaconazole | 0.016 | — | 19 | — |
| N-(2-(1,3-dimethylbutyl)- | 0.004 | — | 1 | — |
| phenyl)-1,3-dimethyl-5-fluoro- | | | | |
| 1H-pyrazole-4-carboxylic acid | | | | |
| amide | | | | |
| No. Ia.719 + N-(2-(1,3- | 0.063 + 0.004 | 16:1 | 69 | 36 |
| dimethylbutyl)-phenyl)-1,3- | | | | |
| dimethyl-5-fluoro-1H-pyrazole- | | | | |
| 4-carboxylic acid amide | | | | |
| No. Ia.344 + azaconazole | 0.063 + 0.016 | 4:1 | 95 | 72 |
| No. Id.667 + N-(2-(1,3- | 0.063 + 0.004 | 16:1 | 63 | 36 |
| dimethylbutyl)-phenyl)-1,3- | | | | |
| dimethyl-5-fluoro-1H-pyrazole- | | | | |
| 4-carboxylic acid amide | | | | |

All microtiter tests make it clear that, by virtue of the synergism, the mixtures according to the invention are considerably more active than had been predicted using Colby's formula.

### USE EXAMPLE 10

### Control of Phytophthora infestans

The stock solutions were mixed according to the ratio listed in the following table.

| | | | | Activity |
|---|---|---|---|---|
| | | | | calculated |
| | | | Observed | according |
| Active compounds/active | | | activity | to |
| compound mixture | Concentration [ppm] | Ratio | (% infection) | Colby (%) |
| No. Ia.719 + piperalin | 63 + 16 | — | 8 | — |
| | 16 + 4 | — | 0 | — |
| No. Ia.719 + N′-(4-(4-chloro- | 16 + 4 | — | 68 | — |
| 3-trifluoromethyl-phenoxy)- | | | | |
| 2,5-dimethyl-phenyl)-N-ethyl- | | | | |
| N-methyl formamidine | | | | |
| No. Id.344 + azaconazole | 63 + 16 | — | 27 | — |
| No. Id.344 + N-(2-(1,3- | 63 + 4 | — | 18 | — |
| dimethylbutyl)-phenyl)-1,3- | | | | |
| dimethyl-5-fluoro-1H-pyrazole- | | | | |
| 4-carboxylic acid amide | | | | |
| No. Id.344 + fluopyram | 63 + 4 | — | 19 | — |
| No. Id.344 + N′-(4-(4-chloro- | 16 + 4 | — | 48 | — |
| 3-trifluoromethyl-phenoxy)- | | | | |
| 2,5-dimethyl-phenyl)-N-ethyl- | | | | |
| N-methyl formamidine | | | | |
| No. Id.667 + fluopyram | 4 + 0.25 | — | 2 | — |
| No. Id.667 + N′-(4-(4-chloro- | 16 + 4 | — | 51 | — |
| 3-trifluoromethyl-phenoxy)- | | | | |
| 2,5-dimethyl-phenyl)-N-ethyl- | | | | |
| N-methyl formamidine | | | | |
| No. Im.1010 + 2-(2-(6-(3- | 0.25 + 0.063 | — | 37 | — |
| chloro-2-methyl-phenoxy)-5- | | | | |
| fluoro-pyrimidin-4-yloxy)- | | | | |
| phenyl)-2-methoxyimino-N- | | | | |
| methyl-acetamide | | | | |
| No. Im.1010 + benalaxyl-M | 63 + 63 | — | 49 | — |
| Prohexadione-Ca | 16 | — | 17 | — |
| Trinexapac-ethyl | 63 | — | 39 | — |
| Mepiquat-chloride | 63 | — | 14 | — |
| No. Ia.719 + piperalin + | 63 + 16 + 63 | 4:1:4 | 46 | 21 |
| mepiquat-chloride | | | | |
| No. Ia.719 + N′-(4-(4-chloro- | 16 + 4 + 16 | 4:1:4 | 93 | 74 |
| 3-trifluoromethyl-phenoxy)- | | | | |
| 2,5-dimethyl-phenyl)-N-ethyl- | | | | |
| N-methyl formamidine + | | | | |
| prohexadione-Ca | | | | |
| No. Id.667 + N′-(4-(4-chloro- | 16 + 4 + 16 | 4:1:4 | 79 | 59 |
| 3-trifluoromethyl-phenoxy)- | | | | |
| 2,5-dimethyl-phenyl)-N-ethyl- | | | | |
| N-methyl formamidine + | | | | |
| prohexadione-Ca | | | | |
| No. Im.1010 + benalaxyl-M + | 63 + 63 + 63 | 1:1:1 | 100 | 69 |
| trinexapac-ethyl | | | | |

The test results show that, by virtue of the synergism, the mixtures according to the invention are considerably more active than had been predicted using Colby's formula.

### USE EXAMPLE 11

### Control of Botrytis cinerea

The stock solutions were mixed according to the ratio listed in the following table.

| | | | | Activity |
|---|---|---|---|---|
| | | | | calculated |
| | | | Observed | according |
| Active compounds/active | Concentration | | activity | to |
| compound mixture | [ppm] | Ratio | (% infection) | Colby (%) |
| No. Ia.719 + benalaxyl-M | 0.063 + 0.063 | — | 42 | — |
| No. Im.1010 + N-(2-(1,3- | 0.063 + 0.004 | — | 47 | — |
| dimethylbutyl)-phenyl)-1,3- | | | | |
| dimethyl-5-fluoro-1H-pyrazole- | | | | |
| 4-carboxylic acid amide | | | | |
| Prohexadione-Ca | 0.063 | — | 4 | — |
| Mepiquat-chloride | 0.063 | — | 0 | — |
| No. Ia.719 + benalaxyl-M + | 0.063 + 0.063 + | 1:1:1 | 65 | 45 |
| prohexadione-Ca | 0.063 | | | |
| No. Im.1010 + N-(2-(1,3- | 0.063 + 0.004 + | 16:1:16 | 70 | 47 |
| dimethyl-butyl)-phenyl)-1,3- | 0.063 | | | |
| dimethyl-5-fluoro-1H-pyrazole- | | | | |
| 4-carboxylic acid amide + | | | | |
| mepiquat-chloride | | | | |

The test results show that, by virtue of the synergism, the mixtures according to the invention are considerably more active than had been predicted using Colby's formula.

### USE EXAMPLE 12

### Control of Pyricularia oryzae

The stock solutions were mixed according to the ratio listed in the following table.

| | | | | Activity |
|---|---|---|---|---|
| | | | | calculated |
| | | | Observed | according |
| Active compounds/active | Concentration | | activity | to |
| compound mixture | [ppm] | Ratio | (% infection) | Colby (%) |
| No. Ia.719 + piperalin | 0.25 + 0.063 | — | 0 | — |
| No. Id.667 + nitrapyrin | 4 + 1 | — | 33 | — |
| prohexadione-Ca | 0.25 | — | 0 | — |
| trinexapac-ethyl | 4 | — | 2 | — |
| No. Ia.719 + piperalin + | 0.25 + 0.063 + | 4:1:4 | 19 | 0 |
| prohexadione-Ca | 0.25 | | | |
| No. Id.667 + nitrapyrin + trinexapac- | 4 + 1 + 4 | 4:1:4 | 55 | 34 |
| ethyl | | | | |

The test results show that, by virtue of the synergism, the mixtures according to the invention are considerably more active than had been predicted using Colby's formula.

### USE EXAMPLE 13

### Control of Septoria tritici

The stock solutions were mixed according to the ratio listed in the following table.

| | | | | Activity |
|---|---|---|---|---|
| | | | | calculated |
| | | | Observed | according |
| Active compounds/active | Concentration | | activity | to |
| compound mixture | [ppm] | Ratio | (% infection) | Colby (%) |
| No. Ia.719 + piperalin | 0.25 + 0.063 | — | 0 | — |
| No. Ia.719 + nitrapyrin | 0.063 + 0.016 | — | 23 | — |
| No. Id.667 + nitrapyrin | 4 + 1 | — | 33 | — |
| No. Id.667 + azaconazole | 1 + 0.25 | — | 54 | — |
| No. Id.667 + benalaxyl-M | 0.25 + 0.25 | — | 36 | — |
| No. Im.1010 + N′-(4-(4- | 0.063 + 0.016 | — | 71 | — |
| chloro-3-trifluoromethyl- | | | | |
| phenoxy)-2,5-dimethyl- | | | | |
| phenyl)-N-ethyl-N-methyl | | | | |
| formamidine | | | | |
| prohexadione-Ca | 0.25 | — | 0 | — |
| trinexapac-ethyl | 4 | — | 2 | — |
| No. Ia.719 + piperalin + | 0.063 + 0.016 + | 4:1:4 | 61 | 40 |
| mepiquat-chloride | 0.063 | | | |
| No. Ia.719 + piperalin + | 0.063 + 0.016 + | 4:1:4 | 67 | 40 |
| trinexapac-ethyl | 0.063 | | | |
| No. Ia.719 + nitrapyrin + trinexapac- | 0.063 + 0.016 + | 4:1:4 | 44 | 23 |
| ethyl | 0.063 | | | |
| No. Ia.719 + nitrapyrin + pro- | 0.063 + 0.016 + | 4:1:4 | 44 | 24 |
| hexadione-Ca | 0.063 | | | |
| No. Id.667 + azaconazole + | 1 + 0.25 + 1 | 4:1:4 | 88 | 66 |
| prohexadione-Ca | | | | |
| No. Id.667 + benalaxyl-M + | 0.25 + 0.25 + | 1:1:1 | 75 | 50 |
| prohexadione-Ca | 0.25 | | | |
| No. Id.667 + benalaxyl-M + | 0.25 + 0.25 + | 1:1:1 | 89 | 44 |
| trinexapac-ethyl | 0.25 | | | |
| No. Id.667 + nitrapyrin + | 0.25 + 0.063 + | 4:1:4 | 90 | 54 |
| prohexadione-Ca | 0.25 | | | |
| No. Id.667 + nitrapyrin + trinexapac- | 0.063 + 0.016 + | 4:1:4 | 65 | 14 |
| ethyl | 0.063 | | | |
| No. Id.667 + N′-(4-(4-chloro- | 0.063 + 0.016 + | 4:1:4 | 71 | 26 |
| 3-trifluoromethyl-phenoxy)- | 0.063 | | | |
| 2,5-dimethyl-phenyl)-N-ethyl- | | | | |
| N-methyl formamidine + | | | | |
| prohexadione-Ca | | | | |
| No. Im.1010 + N′-(4-(4- | 0.063 + 0.016 + | 4:1:4 | 98 | 71 |
| chloro-3-trifluoromethyl- | 0.063 | | | |
| phenoxy)-2,5-dimethyl- | | | | |
| phenyl)-N-ethyl-N-methyl | | | | |
| formamidine + prohexadione- | | | | |
| Ca | | | | |
| No. Im.1010 + N′-(4-(4- | 0.063 + 0.016 + | 4:1:4 | 94 | 71 |
| chloro-3-trifluoromethyl- | 0.063 | | | |
| phenoxy)-2,5-dimethyl- | | | | |
| phenyl)-N-ethyl-N-methyl | | | | |
| formamidine + trinexapac- | | | | |
| ethyl | | | | |

The test results show that, by virtue of the synergism, the mixtures according to the invention are considerably more active than had been predicted using Colby's formula.

We claim:

1-17. (canceled)

18. A fungicidal mixture for controlling phytopathogenic harmful fungi, comprising
1) at least one 1-methylpyrazol-4-ylcarboxanilide compound of the formula I 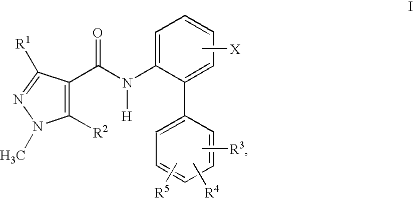
in which the substituents are as defined below:
X is hydrogen or fluorine;
R¹ is C₁-C₄-alkyl or C₁-C₄-haloalkyl;
R² is hydrogen or halogen;
R³ is hydrogen, cyano, nitro, halogen, C₁-C₄-alkyl, C₁-C₄-haloalkyl, Cl-C₄-alkoxy, C₁-C₄-haloalkoxy or C₁-C₄-alkylthio;
R⁴ and R⁵ independently of one another are hydrogen, cyano, nitro, halogen, C₁-C₄-alkyl, C₁-C₄-haloalkyl, C₁-C₄-alkoxy, C₁-C₄-haloalkoxy, C₁-C₄-alkylthio, —CH═N—OR⁶ or —C(CH₃)═N—OR⁶,
where R⁶ is hydrogen, methyl or ethyl;
and
2) at least one active compound II, selected from the active compound groups A) to
A) an azole selected from the group consisting of azaconazole, diniconazole-M, oxpoconazol, paclobutrazol, uniconazol, 1-(4-chloro-phenyl)-2-([1,2,4]triazol-1-yl)-cycloheptanol and imazalil-sulfphate;
B) a strobilurin selected from the group consisting of 2-(2-(6-(3-chloro-2-methyl-phenoxy)-5-fluoro-pyrim idin-4-yloxy)-phenyl)-2-methoxyimino-N-methyl-acetamide and 3-methoxy-2-(2-(N-(4-methoxy-phenyl)-cyclo-propanecarboximidoylsulfanylmethyl)-phenyl)-acrylic acid methyl ester;
C) a carboxamide selected from the group consisting of benalaxyl-M, 2-amino-4-methyl-thiazole-5-carboxylic acid anilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxylic acid amide, N-(4′-chloro-3′,5-difluoro-biphenyl-2-yl)-3-difluoromethyl-1-methyl-1H-pyrazole-4-carboxylic acid amide, N-(4′-chloro-3′,5-difluoro-biphenyl-2-yl)-3-trifluoromethyl-1-methyl-1H-pyrazole-4-carboxylic acid amide, N-(3′,4′-dichloro-5-fluoro-biphenyl-2-yl)-3-trifluoromethyl-1-methyl-1H-pyrazole-4-carboxylic acid amide, N-(3′,5-difluoro-4′-methyl-biphenyl-2-yl)-3-difluoromethyl-1-methyl-1H-pyrazole-4-carboxylic acid amide, N-(3′,5-difluoro-4′-methyl-biphenyl-2-yl)-3-trifluoromethyl-1-methyl-1H-pyrazole-4-carboxylic acid amide, N-(cis-2-bicyclopropyl-2-yl-phenyl)-3-difluoromethyl-1-methyl-1H-pyrazole-4-carboxylic acid amide, N-(trans-2-bicyclopropyl-2-yl-phenyl)-3-difluoromethyl-1-methyl-1H-pyrazole-4-carboxylic acid amide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxylic acid amide, isotianil and 3-(difluoromethyl)-1-methyl-N-[1,2,3,4-tetrahydro-9-(1-methylethyl)-1,4-methano-naphthalen-5-yl]-1H-pyrazole-4-carboxamide of the following formula: 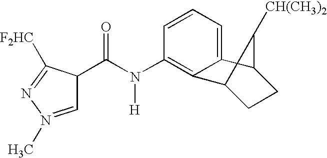
D) a heterocyclic compound selected from the group consisting of 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro-pyridin-2-yl)-methyl)-2,4-dichloro-nicotinamide, diflumetorim, nitrapyrin, dodemorph-acetate, fluoroimid, blasticidin-S, chinomethionat, debacarb, difenzoquat, difenzoquat-methylsulphat, oxolinic acid, piperalin, 3-[5-(4-chloro-phenyl)-2,3-dimethyl-isoxazolidin-3-yl]-pyridine 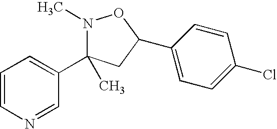
and 5-amino-2-iso-propyl-4-ortho-tolyl-pyrazol-3-on-1-thiocarboxylic acid allyl ester 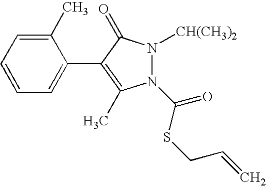
E) a carbamate selected from the group consisting of methasulphocarb, pyribencarb and propamocarb hydrochlorid,
F) an other fungicide selected from the group consisting of dodine free base, guazatine-acetate, iminoctadine-triacetate, iminoctadine-tris(albesilate), kasugamycin-hydrochlorid-hydrat, dichlorophen, N-(4-chloro-2-nitro-phenyl)-N-ethyl-4-methyl-benzenesulfon-amide, dicloran, nitrothal-isopropyl, tecnazen, biphenyl, bronopol, diphenylamine, mildiomycin, oxin-copper, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methyl formamidine and N′-(5-difluormethyl-2-methyl-4-(3-trimethylsilanyl-propoxy)-phenyl)-N-ethyl-N-methyl formamidine;
G) a plant growth regulator selected from the group consisting of clofibric acid, 4-CPA (4-chlorophenoxyacetic acid), 2,4-D, 2,4-DB, 2,4-DEP, dichlorprop, fenoprop, IAA (indole-3-acetic acid), IBA (4-indol-3-ylbutyric acid), naphthaleneacetamide, α-naphthaleneacetic acid, 1-naphthol, naphthoxyacetic acid, potassium naphthenate, sodium naphthenate, 2,4,5-T, 2iP (N-(3-methylbut-2-enyl)-1H-purin-6-amine), 6-benzylaminopurine (6-BA), 2,6-dimethylpuridine (N-oxide-2,6-lultidine), benzyladenine, kinetin, zeatin, calcium cyanamide, dimethipin, endothal, ethephon, merphos, metoxuron, pentachlorophenol and its salts, thidiazuron, tribufos, aviglycine, 1-methylcyclopropene, ACC (1-aminocyclopropanecarboxylic acid), etacelasil, ethephon, glyoxime, gibberellins, gibberellic acid, abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham, 2,3,5-tri-iodobenzoic acid, chlorfluren, chlorflurenol, dichlorflurenol, flurenol, chlormequat, daminozide, flurprimidol, mefluidide, paclobutrazol, tetcyclacis, uniconazole, brassinolide, forchlorfenuron, hymexazol, amidochlor, benzofluor, buminafos, carvone, ciobutide, clofencet, cloxyfonac, cyanamide, cyclanilide, cycloheximide, cyprosulfamide, epocholeone, ethychlozate, ethylene, fenridazon, fluprimidol, heptopargil, holosulf, inabenfide, karetazan, lead arsenate, methasulfocarb, prohexadione (prohexadione calcium), pydanon, sintofen, triapenthenol and trinexapac (trinexapac-ethyl)
in a synergistically effective amount.

19. The mixture of claim 18, comprising as component 1) a 1-methylpyrazol-4-ylcarboxanilide of the formula I where X is hydrogen and R³, R⁴ and R⁵ independently of one another are cyano, nitro, halogen, C₁-C₄-alkyl, Cl-C₄-haloalkyl, C₁-C₄-alkoxy, C₁-C₄-haloalkoxy, C₁-C₄-alkylthio, —CH═N—OR⁶ or —C(CH₃)═N—OR⁶, where R⁶ is hydrogen, methyl or ethyl.

20. The mixture of claim 19, comprising as component 1) a 1-methylpyrazol-4-ylcarboxanilide of the formula I where R¹ is methyl or halomethyl, R² is hydrogen, fluorine or chlorine and R³, R⁴ and R⁵ are each halogen.

21. The fungicidal mixture according to claim 19, comprising as component 1)
N-(3′,4′,5′-trifluorobiphenyl)-1,3-dimethylpyrazol-4-ylcarboxamide,
N-(3′,4′,5′-trifluorobiphenyl)-1,3-dimethyl-5-fluoropyrazol-4-ylcarboxamide,
N-(3′,4′,5′-trifluorobiphenyl)-5-chloro-1,3-dimethylpyrazol-4-ylcarboxamide,
N-(3′,4′,5′-trifluorobiphenyl)-3-fluoromethyl-1-methylpyrazol-4-ylcarboxamide,
N-(3′,4′,5′-trifluorobiphenyl)-3-(chlorofluoromethyl)-1-methylpyrazol-4-ylcarboxamide,
N-(3′,4′,5′-trifluorobiphenyl)-3-difluoromethyl-1-methylpyrazol-4-ylcarboxamide,
N-(3′,4′,5′-trifluorobiphenyl)-3-difluoromethyl-5-fluoro-1-methylpyrazol-4-ylcarboxamide,
N-(3′,4′,5′-trifluorobiphenyl)-5-chloro-3-difluoromethyl-1-methylpyrazol-4-ylcarboxamide,
N-(3′,4′,5′-trifluorobiphenyl)-3-(chlorodifluoromethyl)-1-methylpyrazol-4-ylcarboxamide,
N-(3′,4′,5′-trifluorobiphenyl)-1-methyl-3-trifluoromethylpyrazol-4-ylcarboxamide,
N-(3′,4′,5′-trifluorobiphenyl)-5-fluoro-1-methyl-3-trifluoromethylpyrazol-4-ylcarboxamide,
N-(3′,4′,5′-trifluorobiphenyl)-5-chloro-1-methyl-3-trifluoromethylpyrazol-4-ylcarboxamide,
N-(2′,4′,5′-trifluorobiphenyl)-1,3-dimethylpyrazol-4-ylcarboxamide,
N-(2′,4′,5′-trifluorobiphenyl)-1,3-dimethyl-5-fluoropyrazol-4-ylcarboxamide,
N-(2′,4′,5′-trifluorobiphenyl)-5-chloro-1,3-dimethylpyrazol-4-ylcarboxamide,
N-(2′,4′,5′-trifluorobiphenyl)-3-fluoromethyl-1-methylpyrazol-4-ylcarboxamide,
N-(2′,4′,5′-trifluorobiphenyl)-3-(chlorofluoromethyl)-1-methylpyrazol-4-ylcarboxamide,
N-(2′,4′,5′-trifluorobiphenyl)-3-difluoromethyl-1-methylpyrazol-4-ylcarboxamide,
N-(2′,4′,5′-trifluorobiphenyl)-3-difluoromethyl-5-fluoro-1-methylpyrazol-4-ylcarboxamide,
N-(2′,4′,5′-trifluorobiphenyl)-5-chloro-3-difluoromethyl-1-methylpyrazol-4-ylcarboxamide,
N-(2′,4′,5′-trifluorobiphenyl)-3-(chlorodifluoromethyl)-1-methylpyrazol-4-ylcarboxamide,
N-(2′,4′,5′-trifluorobiphenyl)-1-methyl-3-trifluoromethylpyrazol-4-ylcarboxamide,
N-(2′,4′,5′-trifluorobiphenyl)-5-fluoro-1-methyl-3-trifluoromethylpyrazol-4-ylcarboxamide or
N-(2′,4′,5′-trifluorobiphenyl)-5-chloro-1-methyl-3-trifluoromethylpyrazol-4-ylcarboxamide.

22. The mixture of claim 18, comprising as component 1) a 1-methylpyrazol-4-ylcarboxanilide of the formula I where X is fluorine and R³ is hydrogen.

23. The mixture of claim 22, comprising as component 1) a 1-methylpyrazol-4-ylcarboxanilide of the formula I where X is fluorine in 5-position, R¹ is methyl or halomethyl, R² is hydrogen, fluorine or chlorine, R³ is hydrogen and R⁴ and R⁵ are each halogen.

24. The mixture according to claim 22, comprising as component 1)
N-(3′,4′-dichloro-3-fluorobiphenyl-2-yl)-1-methyl-3-trifluoromethyl-1H-pyrazole-4-carboxamide,
N-(3′,4′-dichloro-3-fluorobiphenyl-2-yl)-1-methyl-3-difluoromethyl-1H-pyrazole-4-carboxamide,
N-(3′,4′-difluoro-3-fluorobiphenyl-2-yl)-1-methyl-3-trifluoromethyl-1H-pyrazole-4-carboxamide,
N-(3′,4′-difluoro-3-fluorobiphenyl-2-yl)-1-methyl-3-difluoromethyl-1H-pyrazole-4-carboxamide,
N-(3′-chloro-4′-fluoro-3-fluorobiphenyl-2-yl)-1-methyl-3-difluoromethyl-1H-pyrazole-4-carboxamide,
N-(3′,4′-dichloro-4-fluorobiphenyl-2-yl)-1-methyl-3-trifluoromethyl-1H-pyrazole-4-carboxamide,
N-(3′,4′-difluoro-4-fluorobiphenyl-2-yl)-1-methyl-3-trifluoromethyl-1H-pyrazole-4-carboxamide,
N-(3′,4′-dichloro-4-fluorobiphenyl-2-yl)-1-methyl-3-difluoromethyl-1H-pyrazole-4-carboxamide,
N-(3′,4′-difluoro-4-fluorobiphenyl-2-yl)-1-methyl-3-difluoromethyl-1H-pyrazole-4-carboxamide,
N-(3′-chloro-4′-fluoro-4-fluorobiphenyl-2-yl)-1-methyl-3-difluoromethyl-1H-pyrazole-4-carboxamide,
N-(3′,4′-dichloro-5-fluorobiphenyl-2-yl)-1-methyl-3-trifluoromethyl-1H-pyrazole-4-carboxamide,
N-(3′,4′-difluoro-5-fluorobiphenyl-2-yl)-1-methyl-3-trifluoromethyl-1H-pyrazole-4-carboxamide,
N-(3′,4′-dichloro-5-fluorobiphenyl-2-yl)-1-methyl-3-difluoromethyl-1H-pyrazole-4-carboxamide,
N-(3′,4′-difluoro-5-fluorobiphenyl-2-yl)-1-methyl-3-difluoromethyl-1H-pyrazole-4-carboxamide,
N-(3′,4′-dichloro-5-fluorobiphenyl-2-yl)-1,3-dimethyl-1H-pyrazole-4-carboxamide,
N-(3′-chloro-4′-fluoro-5-fluorobiphenyl-2-yl)-1-methyl-3-difluoromethyl-1H-pyrazole-4-carboxamide,
N-(4′-fluoro-4-fluorobiphenyl-2-yl)-1-methyl-3-trifluoromethyl-1H-pyrazole-4-carboxamide,
N-(4′-fluoro-5-fluorobiphenyl-2-yl)-1-methyl-3-trifluoromethyl-1H-pyrazole-4-carboxamide,
N-(4′-chloro-5-fluorobiphenyl-2-yl)-1-methyl-3-trifluoromethyl-1H-pyrazole-4-carboxamide,
N-(4′-methyl-5-fluorobiphenyl-2-yl)-1-methyl-3-trifluoromethyl-1H-pyrazole-4-carboxamide,
N-(4′-fluoro-5-fluorobiphenyl-2-yl)-1,3-dimethyl-1H-pyrazole-4-carboxamide,
N-(4′-chloro-5-fluorobiphenyl-2-yl)-1,3-dimethyl-1H-pyrazole-4-carboxamide,
N-(4′-methyl-5-fluorobiphenyl-2-yl)-1,3-dimethyl-1H-pyrazole-4-carboxamide,
N-(4′-fluoro-6-fluorobiphenyl-2-yl)-1-methyl-3-trifluoromethyl-1H-pyrazole-4-carboxamide or N-(4′-chloro-6-fluorobiphenyl-2-yl)-1-methyl-3-trifluoromethyl-1H-pyrazole-4-carboxamide.

25. The mixture of claim 18, comprising an additional active compound III, selected from the groups H) to N):
H) an azole selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thiabendazole, fuberidazole, ethaboxam, etridiazole and hymexazole;
J) a strobilurin selected from the group consisting of azoxystrobin, dimoxy-strobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)-carbamate and methyl 2-(ortho-(2,5-dimethylphenyloxymethylene)phenyl)-3-methoxyacrylate;
K) a carboxamide selected from the group consisting of carboxin, benalaxyl, boscalid, fenhexamid, flutolanil, furametpyr, mepronil, metalaxyl, mefenoxam, ofurace, oxadixyl, oxycarboxin, penthiopyrad, thifluzamide, tiadinil, 3,4-dichloro-N-(2-cyanophenyl)isothiazole-5-carboxamide, dimethomorph, flumorph, flumetover, fluopicolide (picobenzamid), zoxamide, carpropamid, diclocymet, mandipropamid, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide, methyl 3-(4-chlorophenyl)-3-(2-isopropoxycarbonylamino-3-methylbutyrylamino)propionate, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3′,4′-dichloro-4-fluorobiphenyl-2-yl)-3-difluoro-methyl-1-methylpyrazole-4-carboxamide, N-(3′,4′-dichloro-5-fluorobiphenyl-2-yl)-3-difluoromethyl-1-methylpyrazole-4-carboxamide and N-(2-cyano-phenyl)-3,4-dichloroisothiazole-5-carboxamide;
L) a heterocyclic compound selected from the group consisting of fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, probenazole, 5-chloro-7-(4-methyl-piperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen and N,N-dimethyl-3-(3-bromo-6-fluoro-2-methylindole-1-sulfonyl)-[1,2,4]triazole-1-sulfonamide;
M) a carbamate selected from the group consisting of mancozeb, maneb, metam, metiram, ferbam, propineb, thiram, zineb, ziram, diethofencarb, iprovalicarb, flubenthiavalicarb, propamocarb, 4-fluorophenyl N-(1-(1-(4-cyanophenyl)ethanesulfonyl)but-2-yl)carbamate, methyl 3)-(4-chlorophenyl)-3-(2-isopropoxycarbonylamino-3-methyl-butyrylamino)propanoate and carbamate oxime ethers of the formula IV 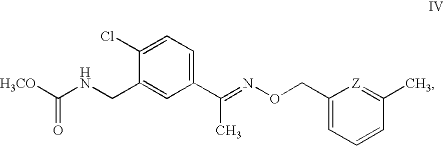
in which Z is N or CH;
N) an other fungicide selected from the group consisting of guanidine, dodine, iminoctadine, guazatine, antibiotics: kasugamycin, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts, organophosphorus compounds: edifenphos, iprobenfos, fosetyl, fosetyl-aluminum, phosphorous acid and its salts, pyrazophos, toldlofos-methyl, organochlorine compounds: chlorothalonil, dichlofluanid, flusulfamide, hexachlorobenzene, phthalide, pencycuron, quintozene, thiophanate-methyl, tolylfluanid, inorganic active compounds: Bordeaux mixture, copper acetate, copper hydroxide, copper oxychloride, basic copper sulfate, sulfur, others: cyflufenamid, cymoxanil, dimethirimol, ethirimol, furalaxyl, metrafenone and spiroxamine.

26. The mixture of claim 18, comprising the components 1) and 2) in a weight ratio of from 100:1 to 1:100.

27. A composition, comprising at least one liquid or solid carrier and the mixture of claim 18.

28. A method for controlling phytopathogenic harmful fungi, wherein the fungi, their habitat or the plants to be protected against fungal attack, the soil, seed, areas, materials or spaces are/is treated with an effective amount of the at least one compound I and the at least one compound II of claim 18.

29. The method of claim 28, wherein the compounds 1) and 2) are applied simultaneously, that is jointly or separately, or in succession.

30. The method of claim 28, wherein the compounds 1) and 2) are applied in an amount of from 5 g/ha to 2000 g/ha.

31. The method of claim 28, wherein the compounds 1) and 2) are applied in an amount of from 1 g to 1000 g per 100 kg of seed.

32. A seed, comprising the mixture of claim 18 in an amount of from 1 g to 1000 g per 100 kg of seed.
